(19) United States
(12) Patent Application Publication
(10) Pub. No.: US 2025/0093524 A1
(43) Pub. Date: Mar. 20, 2025

(54) GNSS RECEIVERS AND METHODS FOR OPERATING GNSS RECEIVERS

(71) Applicant: oneNav, Inc., Sunnyvale, CA (US)

(72) Inventors: Paul A. Conflitti, Ashland, OR (US); Stephen Rose, San Jose, CA (US)

(21) Appl. No.: 18/889,268

(22) Filed: Sep. 18, 2024

Related U.S. Application Data
(60) Provisional application No. 63/539,312, filed on Sep. 19, 2023.
(60) Provisional application No. 63/624,659, filed on Jan. 24, 2024.
(60) Provisional application No. 63/655,553, filed on Jun. 3, 2024.

(51) Int. Cl. G01S 19/25; G01S 19/01; G01S 19/20; G01S 19/37; G01S 19/42

(52) U.S. Cl. CPC G01S 19/252; G01S 19/20; G01S 19/37; G01S 19/42; G01S 19/015

(57) ABSTRACT

Systems and methods for GNSS receivers are described. A system for processing GNSS signals includes one or more GNSS antennas, one or more GNSS measurement engines, and one or more processing systems. The one or more GNSS measurement engines are coupled to the one or more GNSS antennas. The one or more GNSS measurement engines correlate and process received GNSS signals in an L5 radio frequency band. The one or more processing systems are coupled to a first memory which stores an application programming interface (API) which includes one or more of parameters or instructions for processing GNSS signals. The one or more processing systems use the API to control operation of the one or more GNSS measurement engines.

This application claims the benefit of and priority to U.S. Provisional patent application No. 63/539,312, which was filed on Sep. 19, 2023, and U.S. Provisional patent application No. 63/624,659, which was filed on Jan. 24, 2024, and U.S. Provisional patent application No. 63/655,553, which was filed on Jun. 3, 2024, and all of these U.S. Provisional patent applications are hereby incorporated herein by reference.

### BACKGROUND

This disclosure relates to the field of positioning systems and particularly to positioning systems that use radio signals to determine the position of a receiver such as a global navigation satellite system (GNSS) receiver.

GNSS satellites (GNSS SVs) transmit GNSS signals that include pseudorandom number (PRN) codes and a navigation message that allow a GNSS receiver to determine, from the information in the GNSS signals, a position of the GNSS receiver. The navigation message includes ephemeris data about the position of the GNSS SV that transmitted the GNSS signal and time message data that, in effect, time tags the data (e.g., PRN codes) transmitted from each GNSS SV, where the time tag indicates the time of transmission of a point in the GNSS signal from the GNSS SV. As is known in the art, a GNSS receiver determines pseudoranges to GNSS SVs based on the received PRN codes and uses the ephemeris data and the time message data to determine the position of the GNSS receiver. Currently, certain GNSS SVs transmit GNSS signals in at least two radiofrequency (RF) bands: the L1 band and more recently the L5 band. As of a few years ago, most consumer grade GNSS receivers (e.g., those included in smartphones) used only the GNSS signals in the L1 band to determine a position of the GNSS receiver. Recently, some consumer grade GNSS receivers have begun to use GNSS signals in both the L1 and L5 RF bands, and such GNSS receivers that use both bands can be referred to as hybrid L1/L5 GNSS receivers. These hybrid receivers operate by acquiring the GNSS signals in the L1 band and then using the time information (and other information) gained from the acquisition of GNSS signals in the L1 band to acquire one or more GNSS signals from the L5 band; this sequential acquisition process (first L1 acquisition and then L5 acquisition) is due to the recognized difficultly of directly acquiring the GNSS signals in the L5 band. In other words, these hybrid receivers are dependent on the successful acquisition of L1 signals before they can acquire GNSS signals in the L5 band because acquiring L5 signals without the aid from the acquisition of L1 signals is deemed too difficult.

Some of the reasons for this difficulty are explained in the application which resulted in U.S. Pat. No. 11,686,855 which is assigned to oneNav, Inc of Sunnyvale, California. This patent does describe techniques that can be used to directly acquire GNSS signals in the L5 band by using, for example, a set of discrete Fourier transforms (DFTs) to acquire the GNSS signals in a correlation process that can be described as a frequency domain correlation of the GNSS signals. This direct acquisition of the GNSS signals in the L5 band is done without the aid (e.g., fine time information) from the acquisition of L1 signals as described in U.S. Pat. No. 11,686,855.

Hybrid GNSS receivers may continue to be a popular choice for consumer grade GNSS receivers, but they will not, given their current architectures, be able to directly acquire L5 signals which can impact their performance, especially when L1 signals cannot be acquired (e.g., there is too much interference in the L1 band to acquire GNSS signals in the L1 band).

### SUMMARY OF THE DESCRIPTION

In one embodiment of one aspect of this disclosure, the methods and systems described herein can be used to augment a conventional hybrid L1/L5 GNSS receiver by including an L5 GNSS direct acquisition engine that can be coupled with the hybrid L1/L5 GNSS receiver through an interface such as, for example, an application programming interface (API) or other interfaces. The L5 GNSS direct acquisition engine can be used when, for example, the conventional hybrid L1/L5 GNSS receiver cannot acquire L1 GNSS signals (e.g., due to interference in the L1 band which does not affect GNSS signals in the L5 band). A method of operating a global navigation satellite system (GNSS) receiver (that includes a first acquisition engine that is a hybrid L1 and L5 GNSS acquisition engine and a second acquisition engine that is an L5 only GNSS acquisition engine) can include the following operations: acquiring, with the first acquisition engine during a first time period, GNSS signals in the L1 radio frequency (RF) band and then acquiring, using data acquired from the acquisition of GNSS signals in the L1 band, GNSS signals in the L5 band; computing one or more positions of the GNSS receiver based on measurements from the first acquisition engine when GNSS signals in the L1 band are available; and determining, during a second time period, that GNSS signals in the L1 band cannot be acquired by the first acquisition engine and in response to this determination, requesting the second acquisition engine to directly acquire GNSS signals in the L5 band. In one embodiment, the requesting operation can be performed through an application programming interface (API), and the second acquisition engine provides, in response to the request, GNSS measurements to the GNSS receiver through the API, and the second acquisition engine directly acquires GNSS signals in the L5 band by acquiring them without an aid from acquisition of GNSS signals in the L1 band. The GNSS measurements can be one or more of: (1) pseudoranges to GNSS SVs that transmit GNSS signals in the L5 band; (2) code phase measurements from acquired GNSS signals in the L5 band; or (3) range rate measurements. In one embodiment, the GNSS receiver computes a position of the GNSS receiver based on the GNSS measurements received from the second acquisition engine. Once an acquisition engine (either the first or the second) has acquired a GNSS signal from a GNSS SV, a separate tracking engine (e.g., a delay lock loop) that is not part of the acquisition engine can be used to track the acquired GNSS signal.

In one embodiment, the second acquisition engine uses frequency domain correlation (FDC) through a set of discrete Fourier transforms (DFTs) to acquire the GNSS signals in the L5 band. U.S. Pat. No. 11,686,855 describes an example of a set of such DFTs (see, for example, FIGS. 5A and 5B and related description), and this US patent is hereby incorporated herein by reference. In one embodiment, the first acquisition engine uses a set of time domain correlators (TDC) to acquire GNSS signals in the L1 band and to acquire GNSS signals in the L5 band. In one embodiment, the second acquisition engine may also include a set of time domain correlators which are used in place of the FDC in certain situations (e.g., based on the state of the assistance data available to the GNSS receiver); in this case, the second acquisition engine uses, in a first mode, frequency domain correlation through a set of discrete Fourier transforms to acquire the GNSS signals in the L5 band and the second acquisition engine uses, in a second mode, a first set of time domain correlators to acquire GNSS signals in the L5 band, and wherein the first acquisition engine can use a second set of time domain correlators to acquire GNSS signals in the L1 band and to acquire GNSS signals in the L5 band.

In one embodiment, the first acquisition engine is coupled to a first antenna to receive GNSS signals in the L1 band and is coupled to a second antenna to receive GNSS signals in the L5 band, and the second acquisition engine is coupled to the second antenna. In one embodiment, the second acquisition engine acquires GNSS signals in the L5 band but does not contain a position solution engine and does not compute positions of the GNSS receiver. In one embodiment, the second acquisition engine accumulates code phase hypotheses for two components of GNSS signals in a single sideband of GNSS signals from a single GNSS SV in a single hypothesis memory such that for a particular code phase hypothesis, the correlation results over successive 1 millisecond intervals of sampled GNSS signal data from the two components are accumulated together in a single memory location for the particular code hypothesis. In another embodiment, the second acquisition engine accumulates code phase hypotheses for two components of GNSS signals in a first sideband (e.g., sideband A) of GNSS signals from a single GNSS SV and accumulates code phase hypotheses for two other components of GNSS signals in a second sideband (e.g., sideband B) of GNSS signals from the same single GNSS SV in a single hypothesis memory such that for a particular code phase hypothesis, the correlation results over successive 1 millisecond intervals of sampled GNSS signal data from the four components are accumulated together in a single memory location for the particular code hypothesis. In one embodiment, when the interface between the second acquisition engine and the GNSS receiver is an API, the API comprises one or more of the following: (1) a parameter to set a receiver processing interval; (2) one or more parameters that specify detection of interference and a classification of the detected interference; (3) a parameter that specifies a selection of a sideband; (4) a parameter that specifies combining of sideband signals; (5) a parameter that specifies a correlation peak detection threshold; (6) a parameter that indicates a correlation peak has been detected; (7) a parameter that indicates a value of a detected correlation peak; or (8) a parameter that indicates a detected correlation peak to noise ratio.

A GNSS receiver that can perform the operations of this embodiment can include: a first acquisition engine that is a hybrid L1 and L5 acquisition engine that is configured to acquire GNSS signals in an L1 radiofrequency (RF) band and acquire GNSS signals in an L5 RF band, the first acquisition engine to acquire, during a first time period, GNSS signals in the L1 RF band and then acquire, using data acquired from the acquisition of GNSS signals in the L1 band, GNSS signals in the L5 band, the GNSS receiver to determine one or more positions of the GNSS receiver using measurements from the first acquisition engine when GNSS signals in the L1 band are available; and a second acquisition engine that directly acquires GNSS signals in the L5 band during a second time period when the GNSS receiver determines that GNSS signals in the L1 band cannot be acquired by the first acquisition engine and in response to this determination, the second acquisition engine is requested to directly acquire GNSS signals in the L5 band. The GNSS receiver can compute a position of the GNSS receiver based on the GNSS measurements received from the second acquisition engine. In one embodiment in which an API is used as an interface between the second acquisition engine and the rest of the GNSS receiver, the GNSS receiver further includes a first memory storing an application programming interface (API) between the GNSS receiver and the second acquisition engine, the second acquisition engine to provide GNSS measurements (e.g., primary PRN code phase measurements) to the GNSS receiver through the API in response to the request to directly acquire GNSS signals in the L5 band. In one embodiment, the second acquisition engine directly acquires GNSS signals in the L5 band by acquiring them without an aid from acquisition of GNSS signals in the L1 band, and wherein the second acquisition engine uses frequency domain correlation through a set of discrete Fourier transforms (DFTs) to acquire the GNSS signals in the L5 band; the first acquisition engine uses a set of time domain correlators to acquire GNSS signals in the L1 band and to acquire GNSS signals in the L5 band. In one embodiment, the second acquisition engine uses, in a first mode, frequency domain correlation through a set of discrete Fourier transforms to acquire the GNSS signals in the L5 band and the second acquisition engine uses, in a second mode, a first set of time domain correlators to acquire GNSS signals in the L5 band, and wherein the first acquisition engine uses a second set of time domain correlators to acquire GNSS signals in the L1 band and to acquire GNSS signals in the L5 band; the selection of the mode can be based upon the state of the assistance data available to the GNSS receiver as described further below. In one embodiment, the second acquisition engine acquires GNSS signals in the L5 band but does not contain a position solution engine and does not compute positions of the GNSS receiver. In one embodiment, the second acquisition engine accumulates code phase hypotheses for two components of GNSS signals in a single sideband of GNSS signals in a single hypothesis memory such that for a particular code phase hypothesis, the correlation results over a plurality of successive 1 millisecond intervals of sampled GNSS signal data from the two components are accumulated together in a single memory location for the particular code phase hypothesis.

According to another aspect of this disclosure, one embodiment of a GNSS receiver includes two acquisition engines (a first acquisition engine and a second acquisition engine) and processing logic to select when to use the first acquisition engine, which uses FDC, instead of a second acquisition engine, which uses TDC, that is used when the first acquisition engine is not used. In one embodiment, the second acquisition engine can be considered a default acquisition engine that is used when L1 GNSS signals can be acquired or when assistance data allows a reduced search space for L5 GNSS signals (making the use of TDC practical for direct acquisition of L5 GNSS signals using the second acquisition engine). For example, a “hot start” state (for the assistance data) can allow the use of TDC in the second acquisition engine to directly acquire GNSS signals in the L5 band as well as acquiring L1 signals using the second acquisition engine. Such acquisition in a hot start state (or other states with sufficient assistance data) can use the second acquisition engine (which uses TDC) to concurrently and simultaneously acquire L1 and L5 GNSS signals (rather than a serial process of acquiring L1 GNSS signals first followed by acquiring L5 GNSS signals). A GNSS receiver according to this one embodiment can include: one or more antennas to receive GNSS signals from a set of GNSS SVs; one or more radio frequency (RF) front ends coupled to the one or more antennas to amplify the GNSS signals; one or more analog to digital converters (ADC) coupled to the one or more RF front ends to generate a digital representation of received GNSS signals; a memory coupled to the one or more ADCs to store the digital representation; and a GNSS processing system coupled to the memory to process the received GNSS signals, the GNSS processing system coupled to a first acquisition engine and a second acquisition engine and processing logic to select when to use the first acquisition engine; and wherein the first acquisition engine, when used, directly acquires GNSS signals in the L5 band by computing discrete Fourier transforms (DFTs) of received samples of GNSS signals and computing DFTs of local replica code of pseudorandom number (PRN) primary code in the GNSS signals to generate code phase measurements for a plurality of code phase hypotheses; and wherein the second acquisition engine acquires GNSS signals in the L1 band using time domain correlators that determine code phase measurements by correlating received samples of GNSS signals against local replica code of the PRN primary code in the GNSS signals; and wherein the second acquisition engine, when the first acquisition engine is not used, acquires GNSS signals in the L5 band using time domain correlators that determine code phase measurements by correlating received samples of GNSS signals against local replica code of the PRN primary code in the GNSS signals. In one embodiment, when assistance data is available to sufficiently reduce time and position uncertainties in the GNSS processing system, then the first acquisition engine is not used to acquire GNSS signals in the L5 band and the second acquisition engine is used to directly acquire GNSS signals in the L5 band; in one embodiment, the second acquisition engine (when such assistance data is available) can concurrently and simultaneously acquire GNSS signals in the L1 and L5 bands (rather than a sequential process of acquiring L1 signals and then acquiring L5 signals). Once the GNSS signals in both L1 and L5 bands have been acquired, a separate tracking engine (e.g., a delay locking loop or other techniques known in the art to implement a GNSS tracking function or other techniques such as an improved signal energy grid (e.g., signal energy estimation array techniques) that accounts for time domain code phase and frequency domain shifts) can be used to track the acquired GNSS signals. In one embodiment, when the second acquisition engine is unable to acquire L1 signals and L5 signals, then the first acquisition engine is selected to acquire L5 GNSS signals.

Another aspect of this disclosure relates to a GNSS receiver that has two acquisition engines for use in acquiring GNSS signals in the L5 band: a first acquisition engine that uses FDC to directly acquire GNSS signals in the L5 band when the receiver operates in a first acquisition mode and a second acquisition engine that uses TDC to directly acquire GNSS signals in the L5 band when the receiver operates in a second acquisition mode. The GNSS receiver can include processing logic that selects between the acquisition modes based upon the state of assistance data currently available to the GNSS receiver. A method of operating such a GNSS receiver can include the following operations: determining, based on availability of assistance data, whether to operate in (1) a first acquisition mode (e.g., a first set of one or more operations which can be concurrent) to directly acquire GNSS signals in an L5 band using the first GNSS acquisition engine or (2) a second acquisition mode (e.g., a second set of one or more operations which can be concurrent) to directly acquire GNSS signals in the L5 band using the second acquisition engine; acquiring, by the first acquisition engine when in the first acquisition mode, GNSS signals in the L5 band, the first acquisition engine computing discrete Fourier transforms (DFTs) of received samples of GNSS signals and computing DFTs of local replica code of pseudorandom number (PRN) primary code in the GNSS signals to generate code phase measurements for a plurality of code phase hypotheses; and acquiring, by the second acquisition engine when in the second acquisition mode, GNSS signals in the L5 band using time domain correlators that determine code phase measurements by correlating received samples of GNSS signals against local replica code of the PRN primary code in the GNSS signals. In one embodiment, the GNSS receiver directly acquires GNSS signals in the L5 band by acquiring them without an aid from acquisition of GNSS signals in the L1 band, and the time domain correlators in the second acquisition mode do not use DFTs to correlate the received sample against the local replica code and the time domain correlators can search for both code phase hypotheses and frequency shift hypotheses (using DFTs on the TDC results as described below in connection with SEA techniques). In one embodiment, when the assistance data includes time assistance data that reduces time uncertainty, in a clock in the GNSS receiver, to less than 1 millisecond, then the GNSS receiver can use the second acquisition mode to acquire GNSS signals and the first acquisition engine is placed in a low power mode and does not acquire GNSS signals while in the low power mode. In one embodiment, when the assistance data includes data derived from an acquisition of a secondary PRN code phase, then the GNSS receiver uses the second acquisition mode to acquire GNSS signals and the first acquisition engine is placed in a low power mode and does not acquire GNSS signals while in the low power mode. In one embodiment, when the GNSS receiver is in a cold start mode, the GNSS receiver uses the first acquisition mode to acquire GNSS signals and the second acquisition engine is placed in a low power mode and does not acquire GNSS signals while in the low power mode. In one embodiment, the first acquisition engine and the second acquisition engine may share a same allocated memory space such that during the first acquisition mode, the first acquisition engine uses the same allocated memory space and the second acquisition engine does not use the same allocated memory space and during the second acquisition mode, the second acquisition engine uses the same allocated memory space and the first acquisition engine does not use the same allocated memory space, and wherein code phase hypotheses are stored in the same allocated memory space during acquisition of GNSS signals. In one embodiment, the GNSS receiver, in both the first acquisition mode and the second acquisition mode, accumulates code phase hypotheses for two components of GNSS signals in a single sideband of GNSS signals from a single GNSS SV in a single hypothesis memory such that for a particular code phase hypothesis, the correlation results over a plurality of successive 1 millisecond intervals of sampled GNSS signal data from the two components are accumulated together in a single memory location for the particular code hypothesis; and wherein the first acquisition engine computes a first set of DFTs in parallel and concurrently on the received samples to produce a first set of results and then computes a second set of DFTs using the first set of results as an input to the second set of DFTs, and wherein the first set of DFTs is N1 DFTs and the second set of DFTs is N2 DFTs and N1 is greater than N2.

Another aspect of this disclosure relates to a GNSS receiver that is programmable through an API that allows software to make calls to firmware that controls an IP core. In one embodiment of a programmable receiver, a GNSS receiver comprises: one or more antennas to receive GNSS signals; a memory coupled to the one or more antennas, the memory to store a digital representation of received GNSS signals; one or more portions of the GNSS receiver containing first circuitry from an intellectual property (IP) core licensed to a developer of the GNSS receiver; and software stored in memory in the GNSS receiver, the software to set one or more programmable parameters through an application programming interface (API) stored in the first circuitry, the parameters, once set, specifying a configuration of the GNSS receiver. In one embodiment, the software is developed by or for the developer and executes on a processing system in the GNSS receiver; the software makes calls to the API for processing by firmware that executes in the first circuitry. In one embodiment, the IP core specifies the first circuitry in an HDL (hardware description language) or netlist format or a schematic format. In one embodiment, the API and IP core are developed by a licensor that created and licensed the IP core and API. In one embodiment, the IP core includes data that represents a frequency domain correlation acquisition engine, a time domain correlation acquisition engine, and a measurement engine. In one embodiment, the API and IP core allow the developer to select a hardware configuration of the GNSS receiver from three or more possible configurations. In one embodiment, the API includes one or more settable parameters, including one or more of: (a) dwell time; (b) criteria for selecting between FDC and TDC acquisition engines; (c) one or more thresholds used for detecting correlation peaks; (d) parameters for selecting one or both A and B sidebands in the Galileo L5 GNSS signals; I a parameter for selecting whether to combine or not combine, during acquisition, the A and B sidebands in the Galileo L5 GNSS signals; (f) an integration time period for FDC acquisition; (g) an integration time period for TDC acquisition; (h) parameters for the number of signal energy estimation array (SEA) frequency bins and correlator bins; (i) parameters for the SEA DFT length, frequency step size and range; or (j) parameters for the secondary-primary code array (SPC-SEA), including number of secondary code indices by number of correlator indices, coherent integration length and non-coherent integration length. In one embodiment, the API is used to change a search strategy during acquisition of GNSS signals after detecting a first correlation peak in measurements from the first circuitry. In one embodiment, the API includes (a) one or more call interfaces for resource configuration of the first circuitry; and (b) one or more call interfaces to specify parameters for acquisition search operations; and (c) one or more call interfaces to specify parameters for tracking operations. In one embodiment, the first circuitry comprises an array processor that performs vector operations on an array of data contained in the digital representation of the received GNSS signals, and the array of data being at baseband for a 1 millisecond sample of received GNSS signals, and wherein an input of the memory is coupled to an output of a digital signal processing system in the first circuitry that is coupled to the one or more antennas. In one embodiment, the memory comprises a first portion, a second portion, a third portion, and a fourth portion, wherein the first portion stores a 1 millisecond sample of data from a GNSS A sideband for frequency domain correlation operations, the second portion stores a 1 millisecond sample of data from the GNSS A sideband for time domain correlation operations, the third portion stores a 1 millisecond sample of data from a GNSS B sideband for frequency domain correlation operations, and the fourth portion stores a 1 millisecond sample of data from the GNSS B sideband for time domain correlation operations.

Another aspect of this disclosure relates to a GNSS receiver that selects, through an API (or alternatively without using an API), a path through a set of possible processing operations in the GNSS receiver. An example of this aspect is shown in FIGS. 7A and 7B which show a plurality of possible paths that include processing operations in the GNSS receiver. The set of possible processing operations can include, in one embodiment, (a) one or more frequency domain correlation operations, (b) one or more time domain correlation operations at a first frequency bin spacing (such as a wideband search/acquisition bin spacing), and (c) one or more time domain correlation operations at a second frequency bin spacing (such as a tracking bin spacing). The API (if used in an embodiment) allows a host system or other processing system, which may be executing one or more position solution algorithms (e.g., a position engine using a weighted least squares algorithm along with a Kalman filter or extended Kalman filter or other filter algorithms known in the art), to select a particular path from a set of possible paths based on, for example, the state of assistance data or the desired power consumption level of the GNSS receiver, the detection of jamming, etc. In one embodiment, the host system can select different paths for different GNSS SVs, and the processing in each selected path can be independent and concurrent (e.g., the processing in a first selected path for a first SV occurs concurrently in time with the processing in a second selected path for a second SV, and the processing in the first selected path is independent of the processing in the second selected path). The first selected path can include operations that are different than the operations in the second selected path (e.g., the first selected path includes one or more frequency domain correlation operations while the second selected path includes time domain correlation operations but does not include any frequency domain correlation operations). A method (in an embodiment which uses an API) for operating such a GNSS receiver can include the following one or more operations: receiving, through an application programming interface (API), one or more of parameters or instructions for processing GNSS signals for a first GNSS satellite (SV), the one or more parameters or instructions (for processing GNSS signals from the first GNSS SV) used, in the GNSS receiver, to select a first GNSS signal processing flow through a set of possible operations in logic or memory in the GNSS receiver, wherein the first GNSS signal processing flow comprises GNSS signal acquisition and GNSS signal tracking, and wherein the set of possible operations comprises: (a) frequency domain correlation to acquire a GNSS signal, (b) time domain correlation at a first frequency bin spacing, and (c) time domain correlation at a second frequency bin spacing. In one embodiment, the first frequency bin spacing defines a first difference in frequency between center points in adjacent frequency bins, and the second frequency bin spacing defines a second difference in frequency between center points in adjacent frequency bins. This method can further include the following one or more operations: receiving, through the API, one or more parameters or instructions for processing GNSS signals for a second GNSS SV, the one or more parameters or instructions (for processing the GNSS signals for the second GNSS SV) being used in the GNSS receiver to select a second GNSS signal processing flow through the set of possible operations in logic or memory in the GNSS receiver, wherein the second GNSS signal processing flow comprises GNSS signal acquisition and GNSS signal tracking, and wherein the second GNSS signal processing flow is independent of and concurrent in time with the first GNSS signal processing flow. In one embodiment, the time domain correlation at the first frequency bin spacing is a correlation to acquire GNSS signals, and the time domain correlation at the second frequency bin spacing is a correlation to acquire GNSS signals, and the second frequency bin spacing is smaller than the first frequency bin spacing. In one embodiment, the set of possible operations further comprises: one or more time domain correlations to track GNSS signals using a third frequency bin spacing (which can be smaller than the second frequency bin spacing). In one embodiment, the set of possible operations further comprises one or more secondary code acquisition operations to acquire one or more secondary codes of one or more GNSS signals. The API used in this GNSS receiver and in this method can use all or portions of the API described herein. In one embodiment, the API can be used to change a search strategy during acquisition of GNSS signals after detecting a first correlation peak in measurements from the GNSS receiver. In one embodiment, the API includes (a) one or more call interfaces for resource configuration of the GNSS receiver; and (b) one or more call interfaces to specify parameters for acquisition search operations in the GNSS receiver; and (c) one or more call interfaces to specify parameters for tracking operations in the GNSS receiver. In one embodiment, the GNSS receiver comprises an array processor that performs vector operations on an array of data contained in digitized representations of received GNSS signals, and the array of data being at baseband for a 1 millisecond sample of received GNSS signals. In an embodiment which does not use an API to select the different paths, a processing system (e.g., a GNSS processing system that includes and executes measurement engine software and position engine software) can select the different paths (and set the parameters used in the paths such as different frequency bin spacings, etc.) without using an API to communicate between software components in a software stack.

Another aspect of this disclosure relates to a GNSS receiver that uses a sequence of time domain correlations followed by a set of discrete Fourier transforms to acquire one or more GNSS signals from GNSS SVs. In one embodiment, the GNSS receiver can perform the following operations in a method for processing received GNSS signals: receiving GNSS signals and storing first digitized GNSS samples of the received GNSS signals; frequency shifting, in a frequency shifter, one or more of the first digitized GNSS samples; performing, after the frequency shifting, a first time domain correlation on the first digitized GNSS samples which include frequency shifted GNSS samples, the first time domain correlation performed at a first frequency bin spacing; determining, from results of the first time domain correlation, an estimated frequency of received GNSS signals; receiving further GNSS signals and storing second digitized GNSS samples of the further GNSS signals after performing the first time domain correlation; performing a second time domain correlation at a second frequency bin spacing on the second digitized GNSS samples, the second frequency bin spacing being smaller than the first frequency bin spacing; and computing a set of discrete Fourier transformations (DFT) on results of the second time domain correlation to derive a data array having a frequency dimension and a code phase dimension. In one embodiment, the method can further include the additional operation of: searching for one or more maxima in the data array to determine a code phase for the received GNSS signals, the determined code phase being used to compute a pseudorange to a GNSS SV that transmitted the received GNSS signals. In one embodiment, the data in the data array represents a signal energy of the received GNSS signals in different frequency bins and at different code phase hypotheses. In one embodiment, the first frequency bin spacing defines a first difference in frequency between center points in adjacent frequency bins, and the second frequency bin spacing defines a second difference in frequency between center points in adjacent frequency bins. In one embodiment, the method can further include the additional operation of: initiating tracking of received GNSS signals based on the determined code phase. In one embodiment, the method can further include the additional operation of: storing a selected set of data from the data array, the selected set of data comprising a correlation vector containing the one or more maxima in a particular frequency bin, the correlation vector being used as an input to a trained machine learning model to derive one or more excess path length corrections of the pseudorange, and wherein the selected set of data is a row or column of data in the data array (or a portion of a row or column). In one embodiment, the method can further include the additional operation of: performing a frequency domain correlation before performing the first time domain correlation on the first digitized GNSS samples. In one embodiment, the GNSS receiver includes an array processor that performs operations on vectors of data in digitized representations of received GNSS signals, and the array processor performs at least portions of the frequency domain correlation operation. In one embodiment, the array processor computes values, based on inputs from a plurality of vectors in the digitized representations of received GNSS signals, concurrently in an atomic operation in response to a single instruction to the array processor. In one embodiment, the computing of the set of DFTs comprises computing a first plurality of DFTs for a first frequency bin in a range of frequencies and computing a second plurality of DFTs for a second frequency bin (which is different the first frequency bin) in the range of frequencies, wherein the set of DFTs are computed in hardware in parallel and concurrently in time (rather than serially over time).

In another embodiment, a positioning system can include a first GNSS receiver and a second GNSS receiver which can work together through one or more position solution engines that can compute position, velocity and time information from pseudorange and range rate measurements from the first and second GNSS receivers. In this embodiment, the first and second GNSS receivers can work with an inertial navigation system (e.g., an inertial navigation system, a dead reckoning system or similar systems used in, for example, unmanned vehicles such as a drone that moves in the air or on water or on land); the first and second GNSS receivers can supply position, velocity and time information (when available) to the inertial navigation system to calibrate or re-calibrate position and velocity outputs from the inertial navigation system. The first GNSS receiver can be configured to receive and process M code signals (either in the L1 frequency band or the L2 frequency band or both bands) to provide measurements from the received M code signals or the first GNSS receiver can be a GNSS receiver that processes civilian GNSS signals in the L1 band or L2 band or both, such as the civilian L1 (or L1 and L2) signals from the US GPS constellation and the Galileo constellation (e.g., E1 signals from the Galileo constellation). The first GNSS receiver can include a first GNSS measurement engine to measure pseudoranges from received GNSS signals in the L1 and/or L2 band. These measurements, from the M code signals (or other GNSS signals) received by the first receiver, can then be used by one or more position solution engines to determine position, time and velocity information. The M code signals are those GPS signals used by the Department of Defense of the United States of America (USA) that are encrypted and transmitted by GNSS SVs deployed by the USA. The second GNSS receiver can be a direct L5 GNSS receiver that receives and processes L5 GNSS signals directly without using L1 signals to aid in the acquisition of the L5 GNSS signals; in other words, the second GNSS receiver directly acquires L5 GNSS signals without needing any assistance from acquired L1 GNSS signals. The second GNSS receiver can include a second GNSS measurement engine to measure pseudoranges from received GNSS signals in the L5 band. The second GNSS receiver can be any one of the GNSS receivers described herein that can directly acquire and track L5 GNSS signals (without aiding from L1 GNSS signals), such as the GNSS receiver shown in FIGS. 8A, 8B, 8C, 9A and 9B. Examples of such direct L5 GNSS receivers are also described in U.S. Pat. Nos. 11,821,993 and 11,686,855, and both of these US patents are hereby incorporated herein by reference. The second GNSS receiver can be instantiated in the IP core 129 in FIG. 3B, and the first GNSS receiver can also be instantiated in this IP core 129 or be separately instantiated. The host system can include an inertial navigation system as described herein. This system can provide a robust positioning system that is more resistant to jamming and spoofing because the L5 direct GNSS receiver can be harder to jam due to various factors. For example, it is often the case that adversaries (who create the jamming signals) do not create jamming signals in the L5 band; moreover, jamming of L5 signals requires more power to achieve the same amount of jamming noise signals over a particular geographic area than the power required to jam L1 signals over the same particular geographic area. In effect, the L5 direct receiver can augment the first GNSS receiver when jamming or spoofing occurs. The L5 direct receiver can use lower power than an M code GPS receiver, so the augmentation of the M code receiver (or an L1 civilian code receiver) with an L5 direct GNSS receiver can be achieved without adding too much additional power resources (such as additional batteries or other power supplies). Such a system that includes both the first GNSS and the second GNSS receiver can be used to support military, defense and security operations. For example, a drone (e.g., an unmanned aviation vehicle or other vehicle) can be equipped with such a system so it can fly or otherwise move into or near a territory and be resistant to jamming signals (originating from or near the territory) in the L1 and/or L2 frequency bands because of the ability to receive and process GNSS signals in the L5 frequency band. The measurement engines of the first and the second GNSS receivers can be operated independently and concurrently so that they both provide pseudorange measurements, range rate measurements and time information to the one or more position solution engines. The one or more position solution engines can process measurements from each measurement engine separately to determine position and velocity information. For example, measurements from the M code measurement engine or civilian measurement engine for L1 and/or L2 signals (in the first GNSS receiver) can be used separately and independently to compute position solutions based on the M code measurements (from the M code measurement engine) or civilian code measurements, and measurements from the L5 measurement engine (in the second GNSS receiver) can be used to compute position solutions based on only the received L5 GNSS signals. The independently computed position solutions can be compared to provide an integrity check for the system; one position solution engine may compute both solutions or each GNSS receiver may use its own position solution engine. If the M code measurement engine (and/or civilian code measurement engine in the first receiver) fails to produce valid measurements (e.g., because of jamming or spoofing), then the system can fall back to the position solutions derived from the L5 measurement engine in the second GNSS receiver. The first GNSS receiver can be configured to receive and process M code GPS signals from the United States of America constellation of GNSS receivers and/or other GNSS signals in the L1 band, while the second GNSS receiver can be configured to receive and process GNSS signals from all or a subset of all of the GNSS constellations of SVs that broadcast GNSS signals in the L5 frequency band (including, for example, the US GPS constellation and the Galileo GNSS constellation). In one implementation of this positioning system, one or both of the first GNSS receiver and the second GNSS receiver can use a controlled reception pattern antenna (CRPA) system; such an antenna system can be used to detect the direction of a jammer or source of a GNSS jamming signal and then spatially “null out” or mitigate jamming signals from that direction to make the receiver more resistant to the jamming. The reception pattern of the CRPA system is adapted to the RF environment surrounding the receiver to control the direction of reception of GNSS signals based upon detected jamming so that jamming sources are spatially nulled out while legitimate GNSS sources are not. A processing system can be connected to the CRPA system to control the reception pattern of the CRPA system to reject or mitigate jamming or spoofing signals. This use of one or more CRPA systems can improve the jamming and/or spoofing resistance of the positioning system that includes both the first and second GNSS receivers. In one embodiment, the system containing both of the first and second receivers can use an embodiment of the API described herein to tune the operation of the system in response to detected jamming and/or spoofing; for example, if the E5A signals (from SVs in the Galileo constellation) are being jammed but the E5B signals are not being jammed, then the system can use the API to selectively use the E5B signals and not use the E5A signals. In this example, the system can make one or more calls through the API to a GNSS receiver core to instruct the GNSS receiver core to correlate the E5B signals and determine pseudoranges and position from the E5B signals (while ignoring the E5A signals for the computation of position, velocity and timing). The API can also be used to control a CRPA system (to spatially null jamming signals) if an embodiment includes such an antenna system. The API can be between an inertial navigation system and/or a position engine (which uses a first set of software) and the first and second GNSS receivers (which use a second set of software). Having the API as an interface between the inertial navigation system (and/or a position engine) and the first and second GNSS receivers can provide flexibility in the use of the system, and there are at least two levels of this flexibility. For example, without any updates to firmware in the first and second GNSS receivers (e.g., the firmware in IP core 129 in FIG. 3B), the API can provide a user of the API of the first and second receivers with a flexible way to alter the operation of the first and second GNSS receivers by using the API to configure how the receivers operate in different environments (e.g., jamming environments, etc.) with existing firmware; moreover, the API provides another level of flexibility when the firmware in the first and second GNSS receivers can be updated (e.g., the firmware is stored in flash memory and can be updated with changes to the API to deal with new changes required to new approaches used by jammers and spooners). The updated firmware can work with updates to software in a position or measurement engine through the updated API provided by an update firmware. Such firmware updates can be incorporated into existing hardware designs so no hardware changes are needed with the use of such firmware updates. The inertial navigation system can include one or more sensors such as accelerometers, gyroscopes, magnetometers (e.g., compass), thermometers and inclinometers to detect changes to translation, rotation and orientation (e.g., in x, y, and z as well as pitch, roll, and yaw); such inertial navigation systems are also referred to as inertial measurement units (IMU) and can often be implemented with devices that are integrated to include many such sensors (e.g., accelerometers, gyroscopes, magnetometers, inclinometers, temperature sensors, barometric pressure sensors, etc.) and provide outputs (after processing the data from the one or more sensors) to indicate one or more of position, orientation and velocity and such inertial navigation systems can include inputs to receive initial or updated position and velocity values from a GNSS receiver in order to initialize or calibrate or re-calibrate the one or more outputs from such inertial navigation systems. These one or more sensors can be implemented with miniature microelectromechanical systems (MEMS) as is known in the art. Integrating such inertial navigation systems with a first and second GNSS receiver (e.g., one GNSS receiver receiving civilian or military L1 GNSS signals and another GNSS receiver directly receiving civilian L5 GNSS signals without using L1 signals to aid in the acquisition of L5 signals) with an API interface between the inertial navigation systems, position solution engine(s) and the GNSS receivers allows for increased flexibility and resilience in environments that include jamming or spoofing of GNSS signals so that a drone with such inertial navigation systems and the pair of GNSS receivers (interfaced through an API) can successfully navigate in jamming and/or spoofing environments to desired/intended destinations or at least navigate better than a drone that uses only L1 signals which are jammed or spoofed more easily than L5 signals.

The aspects and embodiments described herein can include non-transitory machine readable media that can store executable computer program instructions that when executed cause one or more data processing systems (e.g., one or more GNSS processing systems or processing logic in a GNSS receiver) to perform the methods described herein when the computer program instructions are executed by the one or more data processing systems. The instructions can be stored in non-transitory machine readable media such as in dynamic random access memory (DRAM) which is volatile memory or in nonvolatile memory, such as flash memory or other forms of memory. The aspects and embodiments described herein can also be in the form of data processing systems, such as GNSS receivers or portions of GNSS receivers, that are built or programmed to perform these methods. For example, a data processing system can be built with hardware logic to perform these methods or can be programmed with a computer program to perform these methods and such a data processing system can be considered a GNSS processing system or GNSS processing logic. For example, a GNSS processing system or GNSS processing logic can be a microprocessor or a microcontroller. Further, the embodiments described herein can use one or more GNSS receiver architectures (or components, methods or portions of such architectures) described in U.S. Pat. No. 11,686,855, filed Oct. 12, 2020 by Paul Conflitti, et. al., with oneNav, Inc. as the Applicant, and this patent is hereby incorporated herein by reference.

The above summary does not include an exhaustive list of all embodiments and aspects in this disclosure. All systems, media, apparatuses, and methods can be practiced from all suitable combinations of the various aspects and embodiments summarized above and also those disclosed in the detailed description below.

### BRIEF DESCRIPTION OF THE DRAWINGS

The present invention is illustrated by way of example and not limitation in the figures of the accompanying drawings in which like references indicate similar elements.

FIG. 1 is a block diagram that shows a GNSS receiver according to one or more embodiments described herein.

FIG. 2A is a flow chart that shows a method according to one or more embodiments for operating a GNSS receiver which includes an L1/L5 hybrid acquisition engine.

FIG. 2B is a flow chart that shows a method according to one or more embodiments for operating a GNSS receiver which includes an L1/L5 hybrid acquisition engine.

FIG. 3A is a block diagram of a GNSS receiver that includes two acquisition engines and a tracking engine.

FIG. 3B is a block diagram of a GNSS receiver that includes an IP core that exposes an API for use by a host GNSS processing system.

FIG. 4A is a flow chart that shows a method according to one or more embodiments for using two different acquisition engines in a GNSS receiver.

FIG. 4B is a flow chart that shows a method according to one or more embodiments for selecting between acquisition engines based on the state of assistance data.

FIG. 5 is a block diagram of a system that includes a GNSS receiver according to one or more embodiments.

FIG. 6 shows an example of one or more networks that can provide GNSS assistance data to one or more GNSS receivers.

FIGS. 7A and 7B show a flowchart that illustrates a method for acquiring and tracking GNSS receivers using some of the embodiments described herein.

FIGS. 8A, 8B and 8C show an example of time domain correlation with an enhanced frequency dimension aspect which can be used in acquisition or acquisition and tracking and can be used after a frequency domain correlation.

FIGS. 9A and 9B show an example of the components of a GNSS receiver according to one or more embodiments.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment. The processes depicted in the figures that follow are performed by processing logic that comprises hardware (e.g., circuitry, dedicated logic, etc.), software (e.g., microcode, firmware and other types of software), or a combination of both. Although the processes are described below in terms of some sequential operations, it should be appreciated that some of the operations described may be performed in a different order. Moreover, some operations may be performed in parallel rather than sequentially.

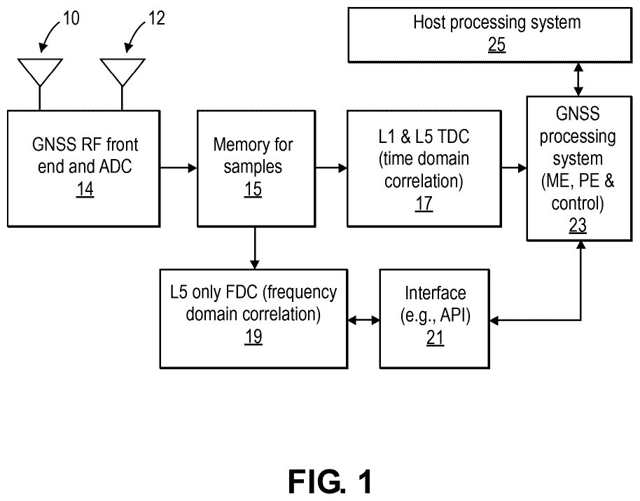

One aspect of this disclosure relates to systems and methods that augment a conventional L1/L5 hybrid GNSS receiver with an additional acquisition engine that can acquire GNSS signals in the L5 band; this additional acquisition engine can be configured to process only GNSS signals in the L5 band by using frequency domain correlation (FDC) which uses discrete Fourier transforms (DFTs) to perform the correlation operations in the frequency domain. In one embodiment, these systems and methods can use an interface between the additional acquisition engine and the rest of the GNSS receiver so that the GNSS measurements (e.g., code phase measurements) generated by the additional acquisition engine (when used) are provided, through the interface, to the rest of the GNSS receiver system for use in position solutions performed by the rest of the GNSS system. An acquisition engine in one embodiment is a component in a GNSS receiver that performs an acquisition of one or more GNSS signals using some form of correlation that attempts to match a PRN code in a received GNSS signal to a local replica of the PRN code to acquire a code phase measurement based on a difference in time between the PRN code in the received GNSS signal and a code phase hypothesis of the local replica PRN code. The acquisition engine determines, in one embodiment, the primary code phases of acquired primary PRN codes and their frequencies (often referred to as frequency offsets due to Doppler effects and/or local oscillator frequency variations or errors). The PRN codes are acquired when a correlation operation indicates a match between a local replica code and a received PRN code. The acquisition engine also identifies the GNSS SV by virtue of finding the matching code corresponding to that GNSS SV. Thus, an acquisition engine can conduct a search in three different dimensions: a code phase or code offset dimension, a frequency dimension, and a PRN code dimension (that depends on the signal and the SV). FIG. 1 shows an embodiment of a system according to this aspect. An acquisition engine can be processing logic or a processing system or an array processor that is designed to perform these searches to acquire a GNSS signal, and once a signal is acquired (which means there is an estimated code phase measurement for an identified GNSS SV and an estimated frequency of the received GNSS signal), then the GNSS receiver uses a tracking engine to track the acquired signal. The acquisition engine can include both hardware and software/firmware.

The GNSS receiver in FIG. 1 includes, in this example, two antennas 10 and 12; antenna 10 can be tuned to the L1 frequency band and antenna 12 can be tuned to the L5 frequency band. In another embodiment, the GNSS receiver may have a single antenna that is designed to receive GNSS signals from both the L1 and L5 bands. In one embodiment that uses a shared antenna, several RF systems (e.g., two or more of: a GNSS receiver that receive and process GNSS signals in the L1 and L5 bands, WiFi transceivers, Bluetooth transceivers, and even cellular telephone transceivers) may share the same antenna. The sharing of an antenna can reduce the cost of a device, although the different RF systems may require the use of filtering to reject out of band transmissions which may be received in any one of the different RF systems. The GNSS signals received through the one or more antennas are processed by the GNSS RF front end 14. The GNSS RF front end 14 includes one or more amplifiers, such as one or more low noise amplifiers, that amplify the received signals and GNSS front end 14 may include filters that filter the received signals using techniques known in the art to capture the GNSS signals in both the L1 and L5 bands; in one embodiment, two RF circuits are used—one for the L1 signals and one for the L5 signals. The GNSS RF front end 14 includes an output that is coupled to one or more analog to digital converters (ADCs) that create digitized representations of the received GNSS signals (from both the L1 and L5 bands) for processing by the digital portion of the GNSS receiver, such as the correlators 17 and 19. The digitized representations of the received GNSS signals are stored in memory 15 as digital samples of the received GNSS signals, and these samples are used in the acquisition engines in the GNSS receiver, including the L1 & L5 time domain correlator 17 and the L5 only frequency domain correlator 19. In one embodiment, the GNSS receiver shown in FIG. 1 can acquire the GNSS signals in both L1 and L5 bands in parallel (e.g., at the same time as described further below) or in series as directed by interference detection in the two frequency bands (L1 and L5). The processed signals from the band with the faster acquisition can be used to assist in the acquisition of the lagging band even when GNSS signals from both bands are correlated in parallel; for example, if GNSS signals in the L5 band are acquired first, then time and frequency information from the acquired L5 signals can be used to aid the acquisition of GNSS signals in the L1 band.

The L1 & L5 time domain correlator 17 performs correlation, in the time domain, of the received GNSS samples from memory 15 against local replicas of the PRN codes in the GNSS signals (at various different hypothesized code phases) in order to find a correlation peak that specifies a code phase measurement that is used in deriving pseudoranges to GNSS satellites (SVs). The L1 & L5 TDC 17 can be a conventional set of time domain correlators used in conventional hybrid L1/L5 GNSS receivers. The correlation process in the time domain is well known in the art. In practice, the L1 & L5 TDC 17 acquires L1 GNSS signals first before attempting to acquire L5 GNSS signals because of the difficulty in directly acquiring the L5 GNSS signals. In one embodiment, the L1 & L5 TDC correlator 17 can be considered the default acquisition engine (e.g., used whenever possible to acquire both L1 and L5 GNSS signals), while the L5 only FDC correlator 19 is the additional acquisition engine that augments the receiver's capabilities and is used when the L1 & L5 TDC correlator 17 cannot acquire L1 GNSS signals. In one embodiment, the L5 only FDC correlator can also include a time domain correlator which may be extended with a frequency dimension component (e.g., using the SEA techniques described below) that allows time domain searching with TDC follow by DFTs to derive frequency domain information to search over both time and frequency domains (generating a signal energy estimation array that covers both time and frequency).

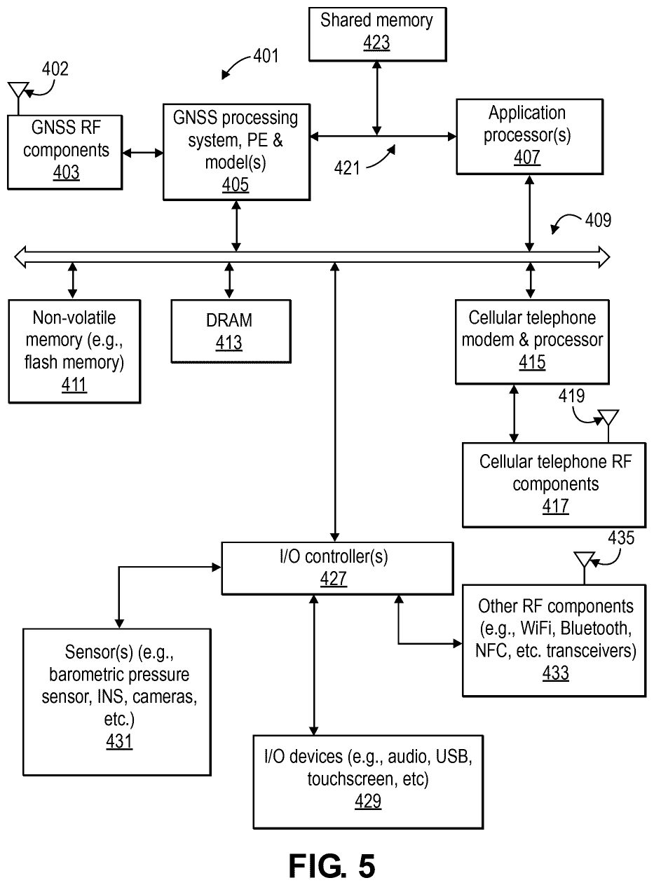

The L5 only FDC correlator 19 can be a frequency domain correlator that performs correlation operations in the frequency domain through, for example, DFTs that transform the time domain samples stored in memory 15 into the frequency domain. Correlation in the frequency domain involves transforming the time domain received GNSS signals into the frequency domain using, for example, DFTs and then performing the matching or correlation of local replica PRN code with the received signal in the frequency domain. The L5 only FDC correlator 19 can be configured to compute a set of DFTs to acquire only L5 GNSS signals when requested by GNSS processing system 23 through interface 21, which may be an application programming interface (API) in one embodiment. The API can be an embodiment of an API described below and be used by software executing on GNSS processing system 23 to configure and control the L5 only FDC correlator 19. The L5 only FDC correlator 19 can be implemented as described in U.S. Pat. No. 11,686,855 (see, for example FIGS. 5A-8C and related descriptions in the patent) to compute DFTs of the samples stored in memory 15 and also compute the other DFTs described in that patent (e.g., DFTs of the local replica code and inverse DFTs of the product of the result of DFT of the received GNSS samples and result of DFT of the replica code) to produce correlation outputs that indicate correlation peaks for the received L5 GNSS signals. The correlation outputs from L5 only correlator 19 can be provided through interface 21 to the GNSS processing system 23 which can include hypothesis memory to accumulate correlation results. The L5 only correlator 19 can, in one implementation, compute the following set of DFTs to produce a correlation output from 1 millisecond of received GNSS sample data (and the L5 only correlator 19 repeats these operations for each 1 millisecond of received GNSS signal data): (1) compute a DFT of the received sample; (2) compute a DFT of the local replica primary PRN code for each expected GNSS signal, where the local replica primary PRN code can be shifted in time and frequency prior to computing the DFT of each local replica primary PRN code; multiple the result of the DFT of the received GNSS sample data by the DFT of the local replica code to produce a product array of results; (3) compute an inverse DFT of the product array of results to produce a correlation output; (4) add the latest correlation result to the accumulated non-coherent integration in the hypothesis memory for the corresponding code phase hypothesis.

The L5 only FDC correlator 19 in one embodiment can quickly search over the entire possible set of code phases at a one-half chip resolution and also at a set of different possible frequencies (due to Doppler effect) while also searching over a set of possible different primary PRN codes for different SVs. The L5 only correlator 19 does not depend on the prior acquisition of L1 GNSS signals and therefore can be used when the L1 & L5 TDC correlator 17 cannot acquire L1 GNSS signals (e.g., L1 GNSS signals are jammed). Thus, the GNSS processing system 23 can detect, from data from L1 & L5 correlator 17, that the correlator 17 is unable to acquire L1 GNSS signals (and hence cannot acquire L5 GNSS signals), and in response to this detection the GNSS processing system 23 can request the L5 only FDC correlator 19 to directly acquire L5 GNSS signals. In this situation, the GNSS processing system 23 switches from using a first acquisition engine (the L1 & L5 TDC correlator 17) to a second acquisition engine (the L5 only FDC correlator 19); at some point in time, the GNSS processing system 23 may switch back to using the first acquisition engine when possible (e.g., later in time the L1 & L5 TDC correlator 17 can acquire L1 signals). In this case, the GNSS processing system 23 can use the first acquisition engine as the default acquisition engine and may use the second acquisition engine when necessary (e.g., there is too much interference in the L1 band to acquire L1 GNSS signals) by requesting use of the second acquisition engine through the interface 21.

The GNSS processing system 23 in one embodiment can include processing logic (e.g., a microcontroller or similar logic) to provide control functions such as controls in a GNSS receiver (e.g., controls for maintaining state information, controlling the operation of the RF front end 14, memory 15, and the correlators 17 and 19, etc.). Furthermore, the GNSS processing system can provide the control logic for switching between the two acquisition engines as described herein. In addition, the GNSS processing system 23 can include conventional GNSS tracking engines to track acquired GNSS signals (e.g., a delay lock loop, or other types of tracking engines to track the acquired primary PRN code and a phase lock loop to track the acquired carrier signal in the GNSS signals). The GNSS processing system 23 can also include a conventional measurement engine that computes pseudoranges to acquired GNSS SVs and range rate/Doppler measurements to acquired GNSS SVs. The GNSS processing system 23 can also include a conventional position engine that uses a position algorithm (e.g, a weighted least squares algorithm with or without a Kalman filter implementation) to compute the position (e.g., one or more position solutions from a weighted least squares algorithm with or without a Kalman filter algorithm) of the GNSS receiver using the computed pseudoranges and the ephemeris data for the GNSS SVs (e.g., the ephemeris data contained in the navigation message received from the GNSS SVs). The GNSS processing system 23 can also be coupled to a host processing system 25 to receive commands (e.g., provide position and time) and data (e.g., assistance data) from the host processing system 25 and to provide responses and data (e.g., a position information in the form of a latitude and longitude, etc.) to the host processing system 25. The host processing system 25 may be coupled to one or more sensors, such as accelerometers and/or inertial navigation systems and a barometric sensor, which can be used by the host processing system 25 to generate assistance data to the GNSS processing system; for example, the host processing system 25 may generate an approximate location and approximate time that can be used by the GNSS processing system to acquire GNSS signals.

In the example shown in FIG. 1, the GNSS processing system 23 is coupled to the L5 only FDC correlator by interface 21. This interface 21 can be an application programming interface (API) in one embodiment or, in another embodiment, a hardware bus or other hardware communication mechanism that can communicate commands and parameters to the correlator 19 from the GNSS processing system and receive data and responses from the correlator 19. In an embodiment which uses an API for the interface 21, the L5 only FDC correlator 19 may be developed by a first company that licenses the design of the L5 only FDC correlator 19 to a second company that develops the design of at least a portion of the GNSS processing system or the host processing system and the software operating on either or both of the GNSS processing system and the host processing system. In this case, the API serves as a communication conduit between the designs of the two different companies (and in particular, the software components of the different designs by the different companies), allowing the two software components to operate together through the API. An example of a specific API is provided further below. All or portions of this example of a specific API may be used in one or more embodiments.

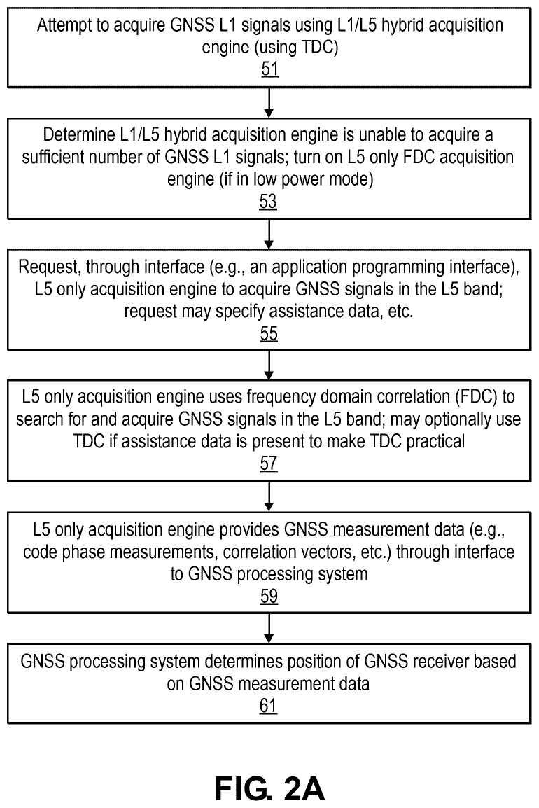

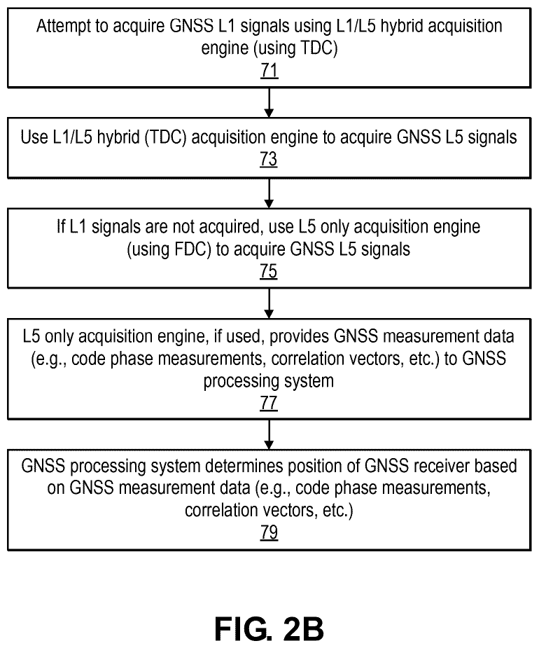

A method according to one embodiment for operating a GNSS receiver shown in FIG. 1 will now be described while referring to FIG. 2A. In operation 51 in FIG. 2A, the GNSS receiver attempts to acquire GNSS L1 signals using time domain correlation in a hybrid L1/L5 acquisition engine; this hybrid L1/L5 acquisition engine can be the L1 & L5 TDC correlator 17 in FIG. 1. If the hybrid L1/L5 acquisition engine can acquire L1 signals, it will continue to operate and acquire L5 signals also and the GNSS receiver can continue to operate using the hybrid L1/L5 acquisition engine as long as L1 GNSS signals can be acquired. The hybrid L1/L5 acquisition engine operates as described above by first attempting to acquire L1 GNSS signals and only after acquiring L1 GNSS signals does it attempt to acquire L5 GNSS signals. In this situation, the GNSS receiver can compute pseudoranges from the code phases determined by the correlator 17 and compute position solutions from these pseudoranges. However, if the GNSS processing system 23 determines at some point in time, in operation 53 in FIG. 2A, that the hybrid L1/L5 acquisition engine is unable to acquire a sufficient number of L1 GNSS signals (e.g., there is too much interference in the L1 band or the L1 GNSS signals are being jammed or spoofed, etc.), then the GNSS processing system 23 switches to using the L5 only acquisition engine (e.g., the L5 only FDC correlator 19 in FIG. 1). If the L5 only acquisition engine was off or in a low power consumption state (e.g., a hardware sleep state), then the GNSS receiver causes the L5 only acquisition engine to be placed in an operational state (e.g., fully powered on). In response to determining the GNSS receiver cannot acquire a sufficient number of L1 GNSS signals, the GNSS processing system in the GNSS receiver requests, in operation 55 in FIG. 2A, the L5 only acquisition engine to directly acquire GNSS signals in the L5 band. In one embodiment, the request may be through an API and the request may specify any available assistance data (e.g., approximate position or coarse time or almanac, etc.) which is provided to the L5 only acquisition engine and the request may specify parameters relating to the acquisition process (e.g., whether both sidebands are to be acquired, etc.—see API tables below). In operation 57, the L5 only acquisition engine can use frequency domain correlation as described herein to search for and acquire GNSS signals in the L5 band. In one embodiment, the L5 only acquisition engine may include a time domain correlator as described further below; if sufficient assistance data is provided to the L5 only acquisition engine, it will be possible to use TDC within the L5 only acquisition engine (instead of FDC) to acquire L5 GNSS signals in operation 57. The use of TDC within the L5 only acquisition engine may reduce power consumption (relative to using FDC to acquire L5 GNSS signals) in the GNSS receiver and it may also improve receiver sensitivity (allowing the receiver to acquire weaker GNSS signals) and may also provide a faster time to first fix (TTFF). In operation 59, the L5 only acquisition engine can provide GNSS measurement data from the results of a successful acquisition of L5 GNSS signals. These GNSS measurement data can include code phase measurements for each acquired L5 GNSS signal, the acquired frequency for each acquired L5 GNSS signal, Doppler measurements for each acquired L5 GNSS signal, and other parameters. These GNSS measurement data can be provided to the GNSS processing system 23 through interface 21 which may be an API in one embodiment. The GNSS processing system 23 can then, in operation 61, compute one or more position solutions using pseudoranges derived from the code phase measurements and ephemeris data for the acquired GNSS SVs (e.g., a conventional weighted least squares algorithm can be used to compute a position solution). The method in FIG. 2A can repeat over time with the GNSS receiver attempting to use the L1/L5 hybrid acquisition engine (using TDC) when it can acquire L1 GNSS signals and switching when necessary to use of the L5 only FDC acquisition when needed (e.g., because of interference in the L1 band that jams L1 GNSS signals).

The following description relates to those embodiments which use an API as an interface, such as the interface 21, between the GNSS receiver and the L5 only acquisition engine. An API allows two different software programs to interact so they can make requests and get responses from each other; for example, software executing on the GNSS processing system 23 (or host processing system 25) can request, through an API, software executing on the L5 only acquisition engine 19 to acquire L5 GNSS signals using the L5 only acquisition engine 19 as described herein. An API can be defined as a set of rules that define how the two different software programs interact, where the set of rules are known by each of the two different software programs. The two different software programs can be developed by two different entities that do not share their source code and the API can still allow for the interaction, and this interaction may be through a portion of memory that can be shared between the two different software programs or through interprocess communication mechanisms that are known in the art or through other mechanisms used to implement an API between two different software programs or processes. The following tables (tables W-Z) show an example of a specific API used in one embodiment.

### API Introduction

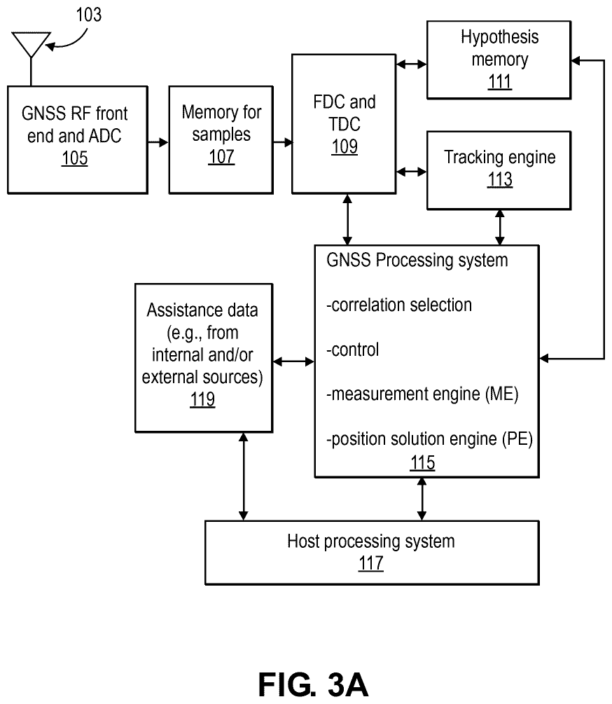

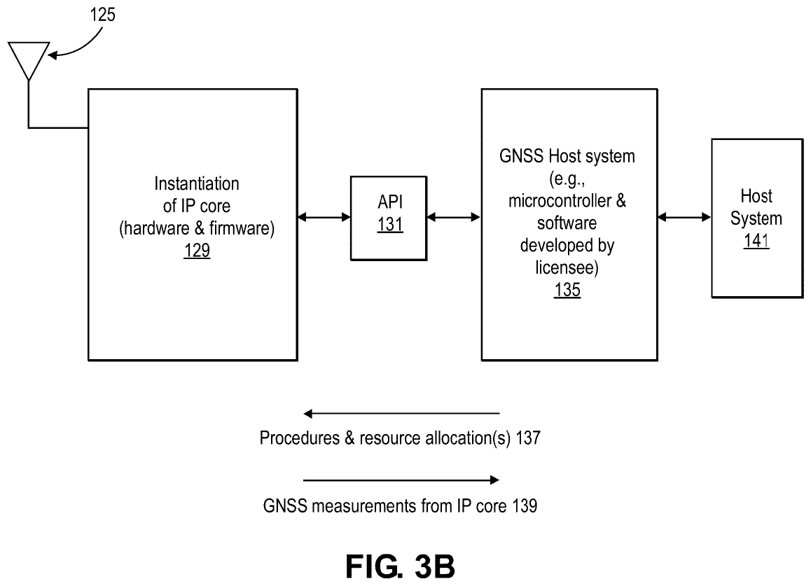

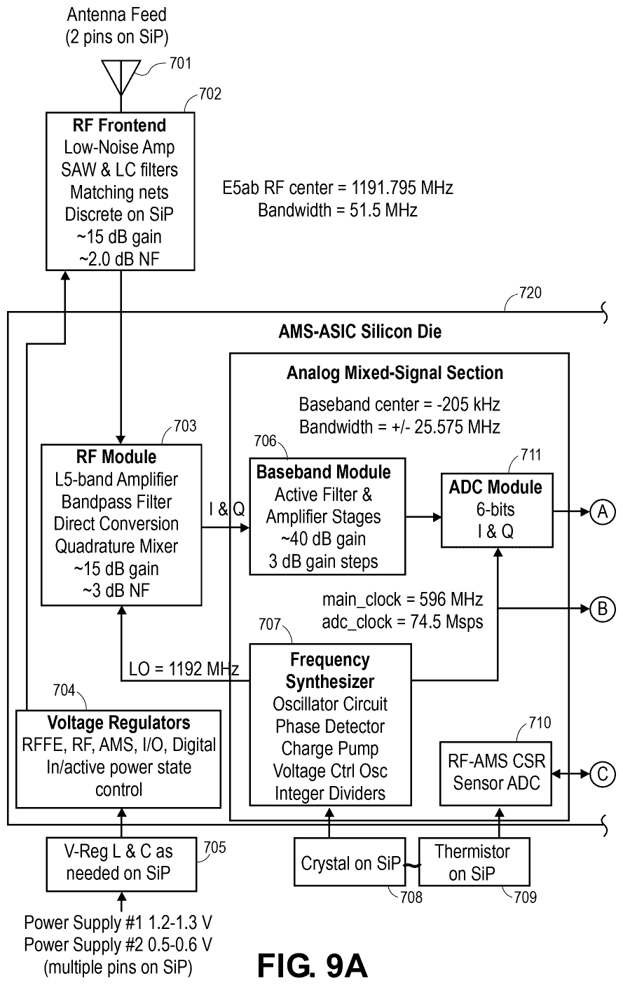

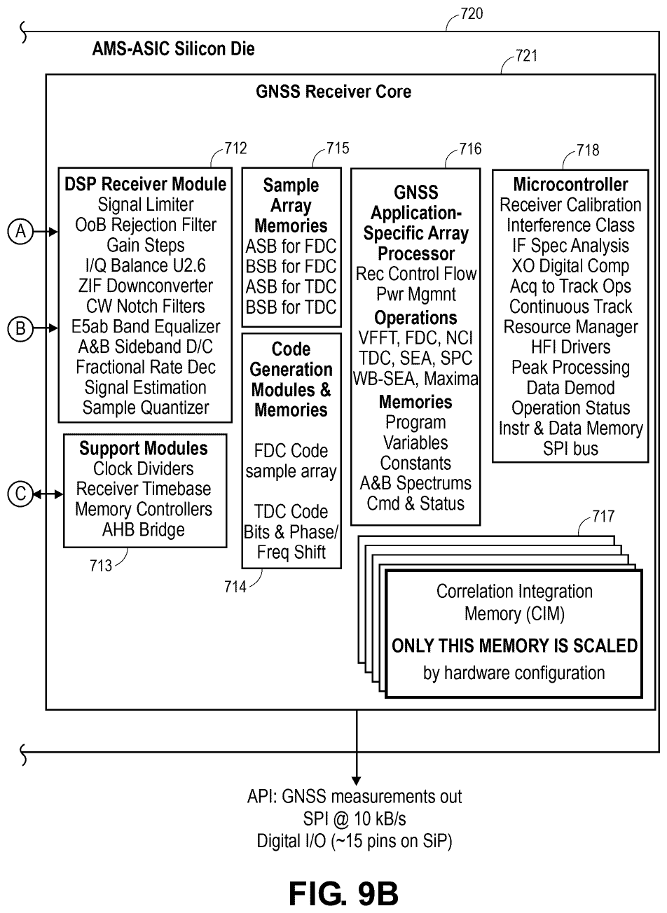

The GNSS Receiver in one embodiment (e.g., see the GNSS receiver shown in FIGS. 9A & 9B or the GNSS receiver in FIG. 3B) has an application program interface (API) for configuring and programming several types of operations and monitoring the status of the operations and resulting GNSS measurements. The API, in one embodiment, includes sections for (1) general receiver control and configuration, (2) acquisition and tracking resource allocation, (3) acquisition procedure, (4) continuous tracking procedure, and (5) automatic acquisition-to-tracking procedure. The operations and monitoring functions within the GNSS Receiver are performed, in one embodiment, by firmware that runs on the Application Specific Array Processor 716 (ASAP) and the Microcontroller Module 718 (MCM). The API Programming Software 510, which can be outside of the GNSS Receiver Core and developed by the user of the GNSS Receiver (e.g., a licensee of an IP core and the API), can be a custom software program (executing on, for example, a host processing system such as host processing system 25 or GNSS host system 135) to configure, program, and monitor the GNSS Receiver through the API, based on the GNSS assistance information (e.g, estimated time and position, SV ephemeris data, Doppler assistance data, SV clock bias, almanac, etc.) and current receiver operating conditions. This API provides a common interface for any GNSS positioning and navigation application software (which can include one or more position solution algorithms). Furthermore, the communication through the API is relatively low bandwidth (e.g., 1k-10k bytes per second), so the application software may be located on a remote device from the GNSS Receiver device.

### Receiver Contro API

The API, in one embodiment, has a section for general receiver control functions, such as interference mitigation and receiver alignment, as listed in the table below. These functions can be performed by ASAP 716 and MCM 718 and include power-up configuration and real-time control of other modules, such as the DSP Receiver 712, Frequency Synthesizer 707, RF Frontend 702, and RF Module 703. The signal processing functions are common and generally transparent to all acquisition and tracking operations performed downstream.

TABLE W
Receiver Control API Parameters & Status

| | Value |
|---|---|
| Receiver Control Parameters | |
| Receiver processing interval (RPI) | Multiple of 20 ms |
| Adaptive Power Management (APM) activity | 1, 2, . . . 10 |
| factor | |
| Option to perform receiver antenna | yes \| no |
| calibration | |
| Option for automatic DC compensation | yes \| no |
| Option for automatic frequency alignment | yes \| no |
| Oscillator frequency nominal | Hz units |
| Oscillator frequency offset | ppb units |
| Approximate antenna gain/quality | dB units |
| Device transmitter co-existence | BT, WiFi, and/or Cellular |
| Receiver Control Status Result | |
| TDC saturation rate | probability per correlation |
| | result |
| A sideband signal quality | e.g., good, moderate, bad, |
| B sideband signal quality | or interference level above |
| | normal receiver noise level |
| Interference detection, classification, | information |
| mitigation method | |
| Detection information for 4 highest CW | information |
| spurs | |
| Relative time transfer delta | {second, ms, cycle} |

### Acquisition and Tracking Resource Allocation API

The GNSS Receiver hardware configuration for the Channel Integration Memory 717 allows scaling the amount of physical memory that is instantiated into the GNSS Receiver chip layout (e.g., a lite hardware instantiation with the least amount of memory, a medium hardware instantiation with more memory than the lite instantiation, and a pro hardware instantiation with more memory than the medium instantiation). Also, the ASAP 716 clock rate constraint is configured for hardware logic synthesis. These two hardware configuration aspects become fixed during the GNSS Receiver synthesis and layout process, thereby defining the total resource capacity for the device, such as the number of available FDC channels and TDC channel groups, as shown in Table X. After fabrication, the acquisition and tracking resource allocation API may modify the configuration of the resources built into the GNSS Receiver device. For example, the software 510 can use less than the total resource capacity in order to reduce power consumption (e.g., allocate N FDC acquisition channels to acquire GNSS signals when the total resource capacity in the fabricated IC is 2N FDC acquisition channels, where N is a number such as 8).

The API section for the acquisition and tracking resource allocation may be used to adjust how the CIM 717 is utilized for the various acquisition and tracking operations (see parameter table below). In addition, ASAP 716 instruction-cycle resources must be allocated to the acquisition and tracking operations, such that the total number of instruction cycles utilized does not exceed the amount available based on the synthesized ASAP 716 clock rate constraint. During an acquisition search procedure or continuous tracking procedure, the API Programming Software 510 may dynamically allocate CIM 717 memory resources and ASAP instruction-cycle resources to perform the operations specified in the acquisition or tracking procedure. For example, more resources may be applied to satellite acquisition operations at the beginning of the search, and the resources may be smoothly transitioned to continuous tracking operations as satellite signal peaks are found.

The user has the freedom to define fewer acquisition operations than are available with the total hardware resource capacity, thereby reducing the peak processing and power consumption demands for different applications of one fabricated device or dynamically under changing conditions, such as a low battery energy level in the device during operation. After an acquisition search is completed, the API Programming Software 510 may allocate a smaller portion of the available resources to a small number of continuous tracking operations to conserve power consumption on the device.

TABLE X
Resource Allocation API Parameters

| Resource Allocation Parameters | Value |
|---|---|
| FDC/CIM Resource Allocation | |
| For 1 to number of FDC channels | |
| Assigned to which operation list | list name/number |
| Current state | active or inactive |
| Sideband combine or not | A\|B or A&B |
| TDC/SEA/CIM Resource Allocation | |
| For 1 to number of TDC channel groups | |
| Assigned to which operation list | list name/number |
| Current state | active or inactive |
| Sideband select | A or B |
| Number of correlators per operation | 20, 40, 80, 160, 320 |
| Number of frequency bins per operation | 1, 2, . . . 100 |
| DFT length (ms) | 20, 40 . . . 100 |

### Acquisition Procedure API

The API Programming Software 510 can define the acquisition resource allocation through the resource API section, and it may program an acquisition procedure, with multiple lists of operations as described in Table Y, through the acquisition procedure API section. The resource manager (RM) within the GNSS Receiver Core parses the operation lists and assigns operations to the available resources allocated for the list.

### Acquisition Procedure Sequence Outline for One Embodiment

1. The API Programming Software 510 can specify the processing cycles and memory resource allocation for the different types of operations used in an acquisition procedure.
2. The API Programming Software 510 may program one or multiple operation lists of different operation types for an acquisition procedure of interest.
3. A list may be for FDC operations or SEA operations of a predefined correlation by frequency array dimension. All operations on a list should be the same type and thus require the same amount of resources.
4. The RM reads the operation lists in order (as a queue) and assigns operations to the processing resources inside the Receiver Core as the resources are available.
5. The operation status information is updated when an operation is started and completed. This status is maintained for all operations over the duration of the acquisition procedure.
6. After an operation is completed, the RM assigns a new operation to the processing resource inside the Receiver Core.
7. There are three cases, in one embodiment, for operation completion: (a) the requested integration time was completed, (b) an unconditional termination request was made, or (c) the option for conditional termination was selected, and a peak was detected above the specified SNR threshold.
8. If useful information is obtained during the acquisition procedure, the API Programming Software 510 may modify or extend the later entries of the operation lists while the procedure is in progress.

TABLE Y
Acquisition and Tracking API Operation Parameters

| Acquisition/Tracking Parameters | FDC + NCI | TDC + SEA |
|---|---|---|
| Per Operation | Operation | Operation |
| Satellite Constellation | GPS, Galileo, Beidou, QZSS | |
| Satellite Number | 1-63 \| 1-50 \| 1-63 \| 1-5 | |
| Range rate (m/s) | Less than 900 m/s in practice | |
| Nominal frequency shift (Hz) | −10 kHz to +10 kHz | |
| Sideband selection or combining | A only, B only, or sum A + B | |
| Initial code advance at integration start | 0, 1 . . . 10229 | |
| Secondary code index | 1 . . . 100 | |
| Number of correlation bins (Nₖ) | 20480 | 20, 40, 80, 160, 320 |
| FDC Number of frequency bins (N_{b}) | 1 | NA |
| SPC\|NB-SEA Number of frequency bins (N_{b}) | NA | 1, 2, . . . 64 |
| WB-SEA Number of frequency bins (N_{b}) | | 2, 4, 8, 16 |
| FDC non-coherent integration length (ms) | 20, 40 . . . 4000 | NA |
| NB-SEA DFT or SPC + SEA coh intg length (ms) | NA | 20, 40, . . . 100 |
| WB-SEA correlation-coh intg length (ms) | | 1 |
| NB-SEA number of iterations in non-coh intg | NA | 1, 2, . . . 100 |
| WB-SEA number of iterations in non-coh intg | | 20, 40, . . . 400 |
| NB-SEA first bin frequency (Hz) | NA | −500 Hz to +500 Hz |
| WB-SEA first bin frequency (Hz) | | −4 kHz to +4 kHz |
| NB-SEA step frequency between bins (Hz) | NA | −50 Hz to +50 Hz |
| WB-SEA step frequency between bins (Hz) | | −500 Hz to +500 Hz |
| Request for early termination (peak detected) | No \| conditional \| unconditional | |
| Peak detection threshold (SNR value) | dB magnitude scale | dB mag-square scale |
| Acq-to-Track Procedure next operation | None \| WB-SEA \| | None \| SPC + SEA \| |
| | SPC + SEA | Acq-SEA \| Track-SEA |

### Notes:

NB-SEA (normal band SEA) or SEA (with no prefix) is for the normal bandwidth search or track, while WB-SEA (wide band SEA) is for wide bandwidth search.
Only the pilot subchannels of the A and B sidebands may be combined in the SEA operation. In the FDC operation, the pilot and data subchannels for each sideband are combined, or all four subchannels may be combined.
The sideband selection, SEA number of correlators and frequency bins, and DFT length are shown here for information only. These are defined for each list by the resource allocation parameters in Table X.

TABLE Z
Acquisition and Tracking API Operation Status

| Acquisition Status Result Per | FDC + NCI | TDC + SEA |
|---|---|---|
| Operation | Operation | Operation |
| Integration in-progress flag | True or False | |
| Integration completed flag | True or False | |
| Peak detection flag | True or False | |
| Completed integration length (ms) | initial parameter or | |
| | after early termination | |
| Configuration error status | Error/warning code | |
| Detected peak code phase relative | 0, 1, . . . 10229 | |
| to ms start | | |
| SEA detected peak frequency (Hz) | NA | Hz value |
| SPC + SEA detected secondary | NA | 0, 1, . . . 99 |
| code index | | |
| Detected peak value | mag estimate | mag-square est |
| Noise mean value | mean estimate | mean estimate |
| Noise deviation value | standard deviation | — |
| Detected signal peak-to-noise ratio | dB magnitude scale | dB mag-square |
| (SNR in dB) | | |

### Snr Calculations:

$$For FDC + NCI , SNR 1 = ( peak\_magnitude - noise\_mean ) / noise\_standard \_deviation \\ For TDC + SEA , SNR 2 = ( peak\_magnitude \_squared - noise\_mean ) / noise\_mean$$

### Continuous Tracking Procedure API

The continuous tracking procedure API is similar to the acquisition procedure API. The main difference, in one embodiment, is that the continuous tracking procedure is more of a static, relatively fixed list of operations for a set of satellites, and it's updated at the tracking rate (e.g., 1 Hz). In contrast, an acquisition procedure is a dynamic queue list of operations for the multiple satellite searching process. Both procedures, in one embodiment, use API tables Y and Z for programming the operations, however, in a slightly different way.

The API Programming Software 510 can define the tracking resource allocation through the resource API section, and it may program a tracking procedure, with multiple lists of operations, through the tracking procedure API section as described in Table Y. In one embodiment, the resource manager (RM) within the GNSS Receiver Core 721 parses the operation lists and assigns operations to the available resources for the list.

### Continuous Tracking Procedure Sequence Outline

1. The API Programming Software 510 should, in one embodiment, specify the processing cycles and memory resource allocation for the different types of operations used in a tracking procedure. It may also allocate resources dedicated to an acquisition procedure when performed concurrently.
2. The API Programming Software 510 may program one or multiple operation lists of different operation types for the tracking procedure of interest.
3. An operation list may include SEA (Signal Energy Estimation Array) operations of a predefined correlation by frequency array dimension. All operations on a list should be, in one embodiment, the same type and thus require the same amount of resources.
4. The RM can read the operation lists at the tracking rate (e.g., 1 Hz) and can assign operations to the processing resources inside the Receiver Core.
5. The RM in one embodiment can periodically update the operation parameters or assign a new operation to the processing resource inside the Receiver Core.
6. The operation status information, in one embodiment, is maintained for all operations, and it is updated at the NCI rate (e.g., 10 Hz) as the operation progresses.

### Automatic Acquisition to Tracking Procedure API

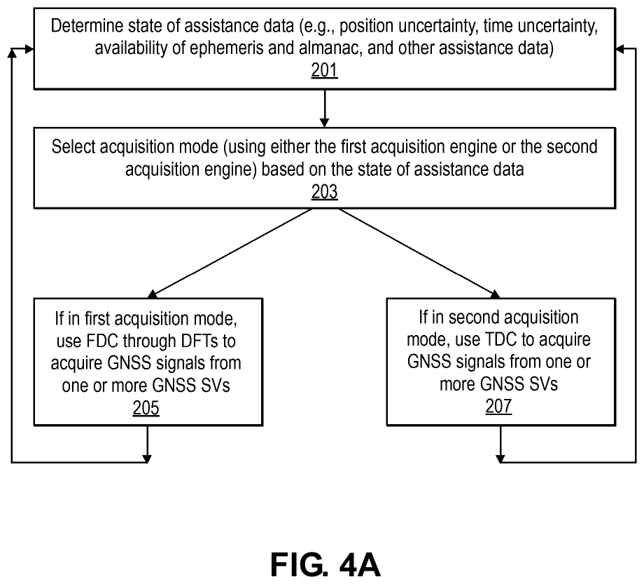

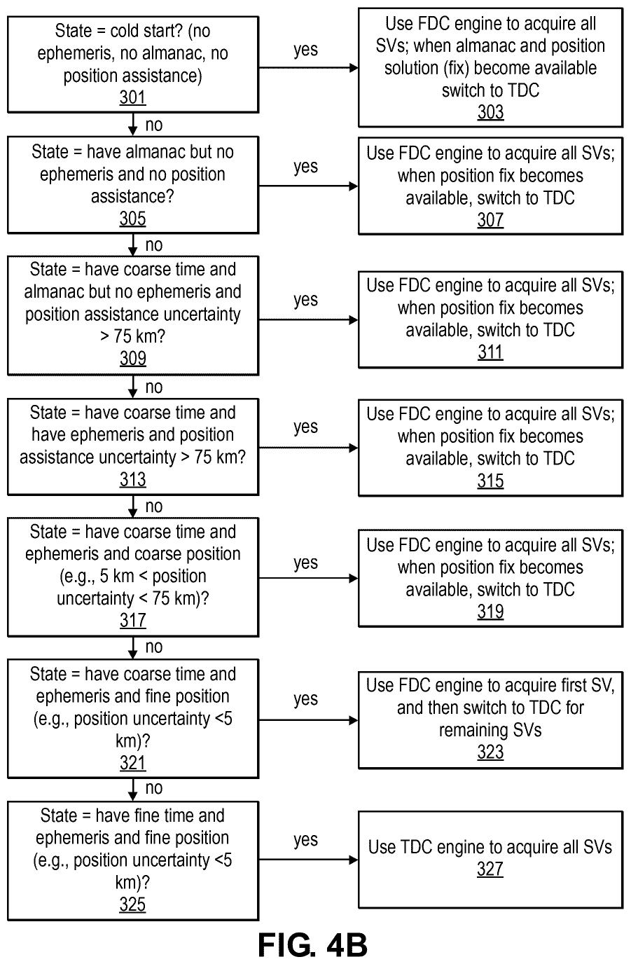

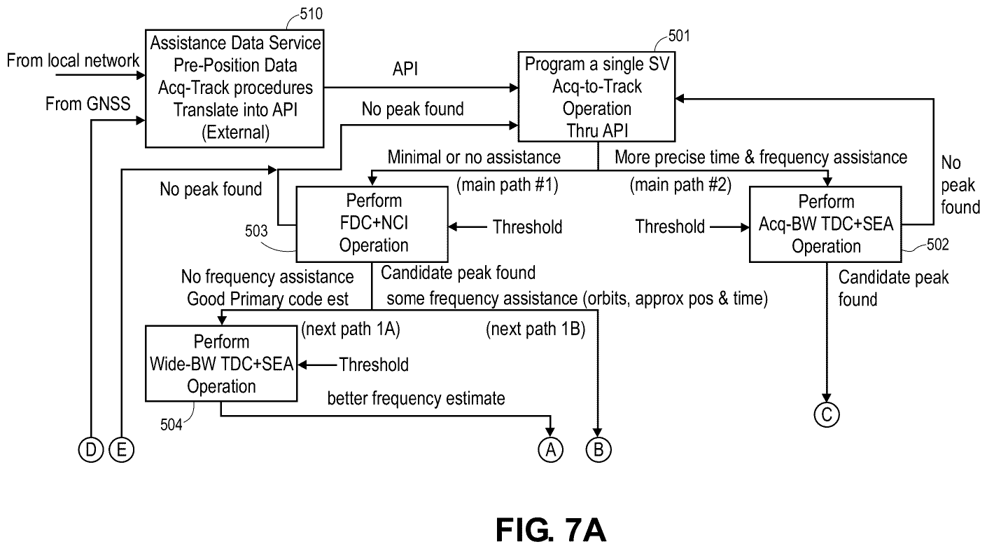

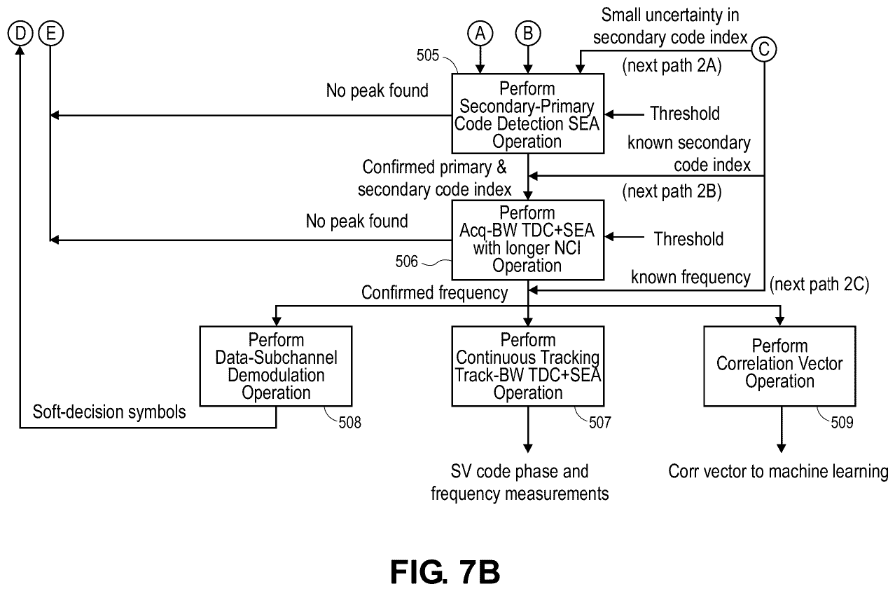

In one embodiment, the API Programming Software {510} may select 1 of 5 automatic procedures for the single-satellite acquisition-to-tracking procedure, which are defined as paths 1A, 1B, 2A, 2B, and 2C, as shown in the operation flow diagram in FIGS. 7A & 7B. An automatic procedure may link together multiple predefined operations with associated parameter sets from separate operation type lists. These automatic procedures are performed, in one embodiment, by microcontroller 718 firmware within the GNSS Receiver under the direction of API Programming Software {510} which can be executing on a processing system in the GNSS receiver or in a host device (for example, host processing system 25 or GNSS processing system 23 or GNSS processing system 115 or host processing system 117 or GNSS processing system 135 or host processing system 141). In one embodiment, the method or procedure shown in FIGS. 7A and 7B is performed separately for each SV, so different SVs may have different paths through the flow and the path for each SV is programmed by the software 510 through API 501 which can be an embodiment of the API described herein. In one embodiment, the different paths can be performed concurrently in time and in parallel. In one embodiment, the method in FIGS. 7A and 7B can begin when the API Programming software 510 receives acquisition assistance data, if available, and pre-position data, if available. The acquisition assistance data can be the assistance data 119 in FIG. 3A or other assistance data described herein and can include one or more of: approximate position data, time data (e.g., fine time or approximate time, doppler data (expected doppler values for one or more SVs in view of an approximate position of the GNSS receiver), SV correction data, altitude data, SV ephemeris data, SV almanac data or other assistance data known in the art. The pre-position data for an SV can include predicted observables (e.g., one or more predicted pseudoranges) that are calculated from data about other SVs; for example, if the GNSS receiver has already acquired and is already tracking an SV (e.g. an SV with a strong received signal), a GNSS processing system, using methods known in the art, can compute a set of predicted observables (e.g. predicted pseudoranges and predicted range rates) for other SVs based on data available to the GNSS processing system including, e.g., SV ephemeris data for the other SVs and approximate position data indicating an approximate position of the GNSS receiver. The API Programing software 510 uses, in one embodiment, the received acquisition assistance data and pre-position data (if available) to select a path through the flow in FIGS. 7A & 7B. While FIGS. 7A & 7B show an example of a set of possible paths, alternative embodiments can use a different set of alternative paths (e.g., the set of alternative paths inherent in the method shown in FIG. 4B). The selected path can then be translated by the API Programming software 510 into an appropriate call, or set of calls, to the API 501 to cause execution of the operations in the selected path; this translation is based on the API 501 used in the embodiment. While the embodiment shown in FIGS. 7A & 7B uses an API, in an alternative embodiment, the method in FIGS. 7A & 7B can be used on a receiver that does not have such API (and hence a set of software can control both high level operations (done by API Programming software 510) and the software controlling lower level operations in the GNSS receiver (e.g. firmware executing in microcontroller 718).

The five paths are described as follows:
Based on the acquisition assistance information from a variety of sources (as described herein), including data messages {508} from other GNSS satellites, the API Programming Software {510} selects the beginning of the main path of the primary code acquisition (PCA) search as either (#1) first perform the FDC+NCI (non-coherent integration) operation {503}, or (#2) first perform the TDC+SEA operation {502}.
If the beginning of the main path is #1 (FDC+NCI operation 503), the API Programming Software {510} defines the next path as either: (1A) first perform the Wide-BW (wide bandwidth) TDC+SEA operation {504} and then perform SPC and SEA operation 505, or (1B) directly go to performing the SPC (secondary primary code)+SEA detection operation {505}. Next as shown in FIGS. 7A & 7B, perform the Acq-BW (acquisition bandwidth) TDC+SEA operation {506} and then go to performing continuous tracking with TDC+SEA {507}.
If the beginning of the main path is #2 (TDC+SEA operation 502), the API Programming Software {510}defines the next path (after operation 502) as either: (2A) first perform the SPC+SEA detection operation {505}followed by operation 506, or (2B) first perform the Acq-BW TDC+SEA operation {506} with longer integration, or (2C) directly go to performing continuous tracking with Track-BW (track bandwidth) TDC+SEA {507}.

### Acquisition to Tracking Path 1A

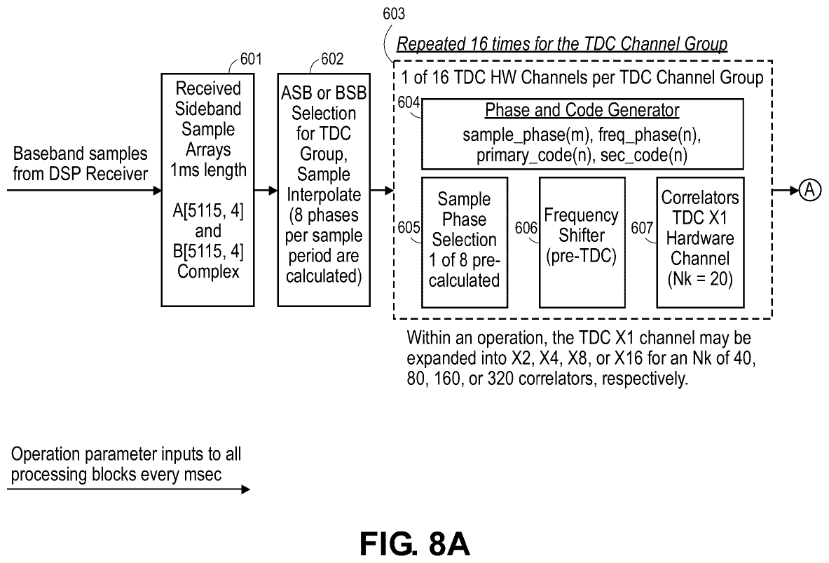

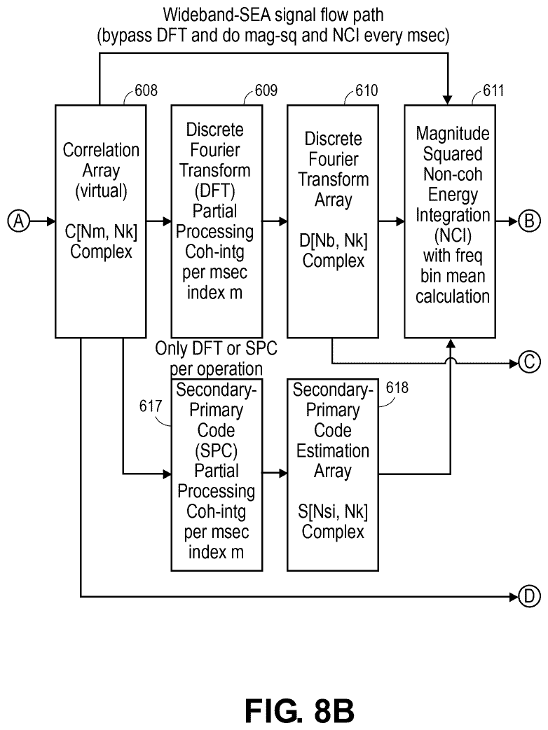

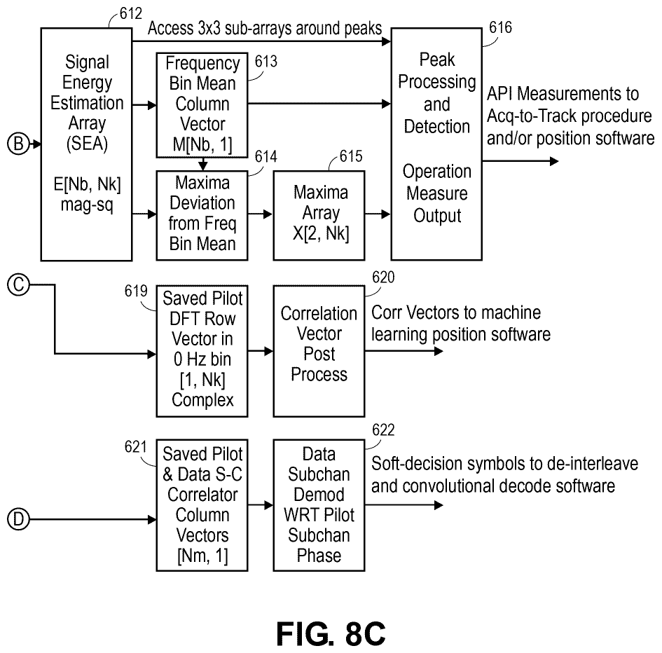

The conditions for Path 1A of the single-satellite acquisition-to-tracking procedure are minimal or no frequency and time assistance. For example, in the case where SV orbits are unknown, the position is unknown, and the time of day is unknown (often referred to as a “cold start”). The automatic procedure operations, in one embodiment, are:
1. The API Programming Software {510}programs the parameters for all the planned operations in the procedure through the API {501}; the operations in path 1A (in the order shown in FIGS. 7A & 7B) are FDC+NCI {503}, Wide-BW TDC+SEA {504}, SPC+SEA detection {505}, Acq-BW TDC+SEA {506}, and continuous tracking TDC+SEA {507}.
2. Perform the satellite PCA search with the FDC+NCI operation {503} and find the code phase of a candidate peak. If a peak is not found above the threshold parameter, return to {501} for the next procedure on the list. The operation 503 can use a combination of FDC operations and non-coherent integration (NCI) operations (e.g. as described herein and in U.S. Pat. No. 11,686,855) to generate correlation results from which correlation peaks may be found. If no candidate correlation peaks are found in operation 503, processing reverts to the software (e.g. firmware executing on microcontroller 718) that receives calls through API 501 to, for example, search and acquire another SV. In one embodiment, operation 503 can use a comparison of a parameter derived from a measured correlation peak (e.g. signal to noise ratio (SNR) of the measured correlation peak) to a threshold (e.g. a threshold SNR) that is selected or set through API 501 by the API Programming software 510; in one embodiment, if the comparison shows the SNR of the measured correlation peak exceeds the threshold SNR, the operation 502 establishes that a candidate correlation peak has been found and will be used in operation 504.
3. Set the initial code advance parameter for Wide-BW TDC+SEA operation {504}; then perform the operation and approximately estimate the satellite frequency. In one embodiment, in operation 504 a GNSS receiver uses time domain correlators to correlate (in a time domain correlation process) a received GNSS signal against a local replica a GNSS of PRN code, beginning at the initial code advance for the local replica. In one embodiment, prior to the TDC process in operation 504, a frequency shifter shifts the received GNSS signal to provide a set of shifted, in frequency, signals to be used in the TDC process; the set of shifts in operation 504 is across a larger (wideband) set of possible frequencies (e.g. the bin spacing between the center points of each adjacent frequency bin in the set is 300 Hz so that across a channel group of 16 TDC HW channels, the TDC process can cover about 5K Hz of bandwidth). The TDC process in operation 504 can use, in one embodiment, the TDC hardware channel 603 in FIG. 8A and the frequency shifter used in operation 504 can be, in one embodiment, the frequency shifter 606 in FIG. 8A. After the TDC process in operation 504, a SEA array of TDC data is accumulated in memory (e.g., memory 612 in FIG. 8C); the correlation outputs from the TDC processes in a channel are magnitude squared and non-coherently integrated for every 1 millisecond of GNSS sample data and the NCI results are stored in the SEA array of data (e.g. memory 612 in FIG. 8C). The SEA array of TDC data is then processed by a peak processing and detection algorithm (e.g. peak processing and detection 616 in FIG. 8C) to determine whether a candidate peak exists. The detected candidate peak, from the peak processing and detection algorithm, is compared in one embodiment, to a threshold (e.g. a threshold set through API 501 for operation 504) to verify a candidate peak. If the candidate peak from operation 504 is not valid (e.g. the SNR of the candidate peak is less than threshold SNR) then processing returns to the software that receives calls through API 501 (e.g., firmware executing in microcontroller 718 in FIG. 9B or the firmware executing in the hardware instantiation of IP core 129) to select the next procedure from a list, e.g., search and acquire another GNSS SV or another GNSS signal from the SV. If the candidate peak is valid (e.g., the SNR of the candidate peak is greater than the threshold SNR), then processing can proceed to operation 505. The frequency shift used in the TDC correlation process for the detected candidate peak provides the better frequency estimate for the GNSS signal, (as shown in FIGS. 7A & 7B) to the operation 505 in FIG. 7B.
4. Set the nominal frequency shift and initial code advance parameters for SPC+SEA detection operation {505}; then perform the operation 505, determine the secondary code index (wherein the index indicates or points to a measured secondary code phase), and refine the primary code phase estimate. In one embodiment, operation 505 can use the secondary-primary code detection operation 617 show in FIG. 8B to acquire the secondary PRN code phase and to refine the primary PRN code phase estimate. In one embodiment, operation 505 can use the TDC correlation results stored in correlation array in 608 in FIG. 8B. If no secondary PRN code phase is found in operation 505 in one embodiment, then processing reverts to the software (e.g. firmware executing in microcontroller 718 in FIG. 9B or the firmware executing in the hardware instantiation of IP core 129) that receives calls through API 501 to, for example, search and acquire another SV or another GNSS signals from the SV. Operation 505 can compare a parameter of the measured secondary code correlation peak to a threshold (e.g. a threshold SNR) that is selected or set through API 501 by the API Programming software 510 to determine if a candidate secondary PRN code phase correlation peak has been detected. If operation 505 detects a valid secondary PRN code phase correlation peak (e.g. based upon a comparison of the SNR of the measured secondary code correlation peak to a threshold SNR), then a primary PRN code phase and a secondary PRN code phase can be determined (e.g. a primary code phase index and secondary code phase index can be determined from operation 505) and processing can proceed to operation 506. Once the secondary PRN code phase is determined in operation 505, the knowledge of that secondary code phase (also referred to as a measured secondary degree code index) can be, in one embodiment using techniques known in the art, used to wipe or remove the secondary code overlaid on the primary code PRN to remove the known data reversal which occurs on the received code so that integration of successive TDC process outputs can be longer than the 1 millisecond epoch of the primary PRN code in the L5 GNSS signal.
5. Set the nominal frequency shift, initial code advance, secondary code index, SEA first bin frequency, and step frequency parameters for Acq-BW TDC+SEA operation {506}; then perform the operation 506 and precisely estimate the satellite frequency. In one embodiment, in operation 506 the GNSS receiver can use the estimated primary PRN code phase (e.g. a primary code index) and the estimated secondary PRN code phase (e.g. a secondary code index) to confirm the frequency of the received GNSS signal in the channel using an acquisition bandwidth TDC process with longer non-coherent integration and SEA processing. Operation 506 can also refine the primary PRN code phase and the secondary PRN code phase measurements. Operation 506 can use an acquisition bandwidth, used in the search over the frequency domain, that has a smaller frequency bin spacing (also referred to as a step frequency parameter between the frequency bins) than the wide bandwidth acquisition process in operation 504; in one embodiment, the acquisition bandwidth in operation 506 can have a frequency bin spacing of 15 Hz which is smaller than the frequency bin spacing of 300 Hz used (in one embodiment) in operation 504 but larger than a frequency bin spacing of 5 Hz used (in one embodiment) in operation 507. It will be appreciated that these specific frequency bin spacing values are examples, and other values may be used in one or more different embodiments. The TDC process in operation 506 can use, in one embodiment, the TDC correlators 607 in the TDC hardware channel 603 in FIG. 8A. After the TDC process in operation 506 (which can produce, in one embodiment, the correlation array 608 in FIG. 8B), the result of the TDC process for each 1 millisecond sample of received GNSS data (e.g. TDC results stored in correlation array 608) are transformed using DFTs (e.g. in operation 609 in FIG. 8B) and the output of the DFTs are stored in, for example, array 610 in FIG. 8B. The output of the DFTs (for each millisecond epoch of received signal) are magnitude squared and then non-coherently integrated over multiple milliseconds (e.g. in operation 611 in FIG. 8B) to produce data (e.g. data in a SEA array 612 in FIG. 8C) that can be processed by a peak processing and detection algorithm (e.g. peak processing and detection 616 in FIG. 8C) to determine whether a candidate code phase peak (and its associated frequency) has been found or determined. In one embodiment, a parameter of a candidate peak (e.g. its SNR) is compared to a threshold (e.g. a threshold SNR) in operation 506 to determine whether the candidate peak is valid. If the candidate peak from operation 506 is not valid (e.g. the SNR of the candidate peak is less than the SNR threshold) then processing returns to the software that receives calls through API 501 (e.g. firmware executing on microcontroller 718 in FIG. 9B or the firmware executing in the hardware instantiation of IP core 129) to select the next procedure from a list, e.g. search and acquire another SV or another GNSS signal from the SV. If the candidate peak from operation 506 is valid (e.g. the SNR of the candidate peak exceeds the SNR threshold) then processing can proceed to operation 507 to track the acquired GNSS signal at the frequency confirmed in operation 506. The outputs from operation 506, such as code phase measurement, one or correlation vectors, a confirmed frequency (and Doppler shift) can be used in operations 508 and 509 as shown in FIGS. 7A & 7B. Operation 508, in one embodiment, performs conventional data sub-channel demodulation to provide soft decision symbols that can be used by the API programming SW 510 when deciding what path (e.g., through FIGS. 7A & 7B) to select for acquisition of another SV's GNSS signals; operation 508 can be implemented using demodulation operation 622 in FIG. 8C as described further below. Operation 509 can be used, in one embodiment, to provide correlation vectors that can be used by machine learning (ML) techniques (e.g. trained neural networks) to correct or improve or otherwise derive one or more of position or velocity or time data. Correlation vectors can be derived from the output of correlation operations (e.g. TDC or FDC operations) from a set of correlators or correlation operations, and these correlation vectors can show how multipath(s) in the signal propagation can affect the correlation output by showing how the output of a correlation process varies over different code phase hypotheses (e.g. a code phase index or code index). A correlation vector can be derived from an output of a correlation process over a single code epoch (e.g. 1 millisecond in case of L5 primary code PRN in the case of the Galileo L5 GNSS signals), and the correlation vectors can be used, for example, in the machine learning techniques described in published US patent applications US 2023/0050047 and US 2023/0126547, both of which are hereby incorporated herein by reference. Operation 509 can, in one embodiment, use operation 620 in FIG. 8C to pass the correlation vectors in memory 619 (in FIG. 8C) to one or more ML systems (e.g. ML systems that use one or more trained neural networks to create corrections to pseudorange measurements and velocity measurements, etc.).
6. Adjust the settings of nominal frequency shift, initial code advance, secondary code index, SEA first bin frequency, and step frequency parameters for the continuous tracking TDC+SEA operation {507} and begin continuous tracking in operation 507. Operation 507, in an embodiment shown in FIG. 7B, is a continuous tracking operation which can include both TDC and SEA operations. Operation 507 uses the estimated code phase and frequency measurements from operation 506 to begin the continuous tracking operation. Operation 507 can use, in one embodiment, a track or tracking bandwidth (e.g. a 5 Hz frequency bin spacing) that is smaller than the bandwidth used in operations 502, 504, and 506. In general, operation 507 is similar to operation 506 in terms of the processes included in operation 507. In particular, the processes included in operation 507 in one embodiment are: (1) a TDC process (using, in one embodiment, the TDC correlators 607 in the TDC hardware channel 603 in FIG. 8A); (2) a DFT transformation process on the results of the TDC process (using, in one embodiment, operation 609 in FIG. 8B and the results of the DFT transformation process can be stored in array 610 in FIG. 8B); (3) a magnitude squaring and integration process (e.g. using operation 611 in FIG. 8B) to produce data (e.g. data in an SEA array 612 in FIG. 8C); and (4) a peak processing and detection algorithm (e.g. peak processing and detection 616 in FIG. 8C which can be a conventional peak processing and detection algorithm in one embodiment). The output from operation 507, after peak processing and detection, can include SV code phase measurements (e.g., of the primary PRN code) and frequency measurements that are provided (e.g. through API 501) to a position solution algorithm (e.g. a conventional weighted least squares algorithm) in a position engine (which may be executing on a host system as described herein). If the peak processing and detection algorithm determines that the tracking operation 507 has host its lock on the GNSS signal, processing reverts back to the software (e.g., firmware executing in microcontroller 718, etc.) that receives calls through API 501 as described herein.

### Acquisition to Tracking Path 1B

The conditions for Path 1B of the single-satellite acquisition-to-tracking procedure are some frequency assistance and minimal or no time assistance. For example, in the case where SV orbits are known, the position is known, for example, within 10 km, and the time of day is known, for example, within 1 minute. The automatic procedure operations, in one embodiment, are:
1. The API Programming Software {510} programs the parameters for all the planned operations in the procedure through the API {501}; the operations are FDC+NCI {503}, SPC+SEA detection {505}, Acq-BW TDC+SEA {506}, and continuous tracking TDC+SEA {507}.
2. Perform the satellite PCA search with the FDC+NCI operation {503} described herein and find the code phase of a candidate peak. If a peak is not found above the threshold parameter, return to {501} for the next procedure on the list.
3. Set the nominal frequency shift and initial code advance parameters for SPC+SEA detection operation {505}, perform the operation 505 (described above), determine the secondary code index, and refine the primary code phase estimate.
4. Set the nominal frequency shift, initial code advance, secondary code index, SEA first bin frequency, and step frequency parameters for Acq-BW TDC+SEA operation {506}, perform the operation 506 (described above), and precisely estimate the satellite frequency.
5. Adjust the settings of nominal frequency shift, initial code advance, secondary code index, SEA first bin frequency, and step frequency parameters for the continuous tracking TDC+SEA operation {507} and begin continuous tracking in operation 507 (described above).

### Acquisition to Tracking Path 2A

The conditions for Path 2A of the single-satellite acquisition-to-tracking procedure, in one embodiment, are small uncertainty in the secondary code index with more precise time and frequency assistance. An example of these conditions can be the case where SV orbits are known, the position is known, for example, within 10 km, and the time of day is known, for example, within 2 ms (which may be considered a fine time level of time assistance data). The automatic procedure operations in path 2A, in one embodiment, are:
1. The API Programming Software {510} programs the parameters for all the planned operations in the procedure through the API {501}; the operations are Acq-BW TDC+SEA {502} with shorter NCI, SPC+SEA detection {505}, Acq-BW TDC+SEA {506} with longer NCI, and continuous tracking TDC+SEA {507}.
2. Perform the satellite PCA search with the TDC+SEA operation {502} and find the code phase of a candidate peak. If a peak is not found above the threshold parameter, return to {501} for the next procedure on the list. The Acq-BW (acquisition bandwidth) TDC and SEA operation 502 is a combination of TDC and SEA operations over a frequency range (defined by a set of frequency bins that cover the frequency range as described further below) using an acquisition bandwidth set of frequency steps or bins; the acquisition bandwidth may in one embodiment have steps or bins of 15 Hertz (Hz). In one embodiment, the acquisition bandwidth is smaller than the wideband (WB) bandwidth (which may be 30 Hz steps or bins in one embodiment) and larger than the tracking bandwidth (which may be 5 Hz steps or bins in one embodiment). In one embodiment, the SEA operations compute DFTs of the results of the TDC operation as shown in the flow, in FIGS. 8A & 8B, from operations 607 and 609 in FIGS. 8A & 8B. Operation 502, in an embodiment shown in FIG. 7A, is an acquisition process using TDC and SEA methods with an acquisition bandwidth, used in the search over the frequency domain, (e.g. a frequency bin spacing of 15 Hz between frequency bins which is a wider bandwidth than the tracking bandwidth used in operation 507 and a narrower bandwidth than the wideband bandwidth used in operation 504). It will be appreciated that operation 502 can use the same frequency bandwidth, used in the search over the frequency domain, as operation 506 in one embodiment. In one embodiment, each of the frequency bandwidths (used in the search over the frequency domain) in operations 502-507 can be set by the host software (e.g. host software executing on host system 135 in FIG. 3B) through the API 501. Operation 502 can begin an acquisition of GNSS signals by performing TDC (for each millisecond of GNSS sample data) using, in one embodiment, the TDC correlators 607 in the TDC hardware channel 603 in FIG. 8A. The TDC process in operation 502, produces, in one embodiment, TDC outputs stored in the correlation array 608, and these TDC outputs in array 608 are then transformed using DFTs (e.g., in operation 609 in FIG. 8B) and the outputs of the DFTs are stored in, for example, array 610 in FIG. 8B. The output of the DFTs (for each 1 millisecond epoch of GNSS sample data) are magnitude squared and then non-coherently integrated over multiple milliseconds (e.g., in operation 611 in FIG. 8B) to produce data (e.g. data in a SEA array 612 in FIG. 8C) that can be processed by a peak processing and detection algorithm (e.g. peak processing and detection 616 in FIG. 8C) to determine whether a candidate code phase peak (and its associated frequency) has been found or determined. In one embodiment a parameter of a candidate peak (e.g. its SNR) is compared to a threshold (e.g. a threshold SNR) in operation 502 to determine whether the candidate peak from operation 502 is valid. If the candidate peak from operation 502 is not valid (e.g. the SNR of the candidate peak is less than the SNR threshold) then processing returns to the software that receives calls through API 501 (e.g., firmware executing in microcontroller 718 or the firmware executing in a hardware instantiation of IP core 129) to select the next procedure from a list (e.g., search and acquire another SV or another GNSS signal from the SV). If the candidate peak from operation 502 is valid (e.g. the SNR of the candidate peak exceeds the SNR threshold) then processing can proceed to operation 505.
3. Set the nominal frequency shift and initial code advance parameters for SPC+SEA detection operation {505}(described above), perform the operation 505, determine the secondary code index, and refine the primary code phase estimate.
4. Set the nominal frequency shift, initial code advance, secondary code index, SEA first bin frequency, and step frequency parameters for Acq-BW TDC+SEA operation {506}, perform the operation 506 (described above), and precisely estimate the satellite frequency.
5. Adjust the settings of nominal frequency shift, initial code advance, secondary code index, SEA first bin frequency, and step frequency parameters for the continuous tracking TDC+SEA operation {507} and begin continuous tracking in operation 507 (described above).

### Acquisition to Tracking Path 2B

The conditions, in one embodiment, for Path 2B of the single-satellite acquisition-to-tracking procedure are known secondary code index with more precise time and frequency assistance. An example, in one embodiment, of these conditions is the case where SV orbits are known, the position is known, for example, within 5 km, and the time is known, for example, within 1.0 ms (which may be considered fine time assistance data). The automatic procedure operations, in one embodiment, are:
1. The API Programming Software {510} programs the parameters for all the planned operations in the procedure through the API {501}; the operations are Acq-BW TDC+SEA {502} with shorter NCI, Acq-BW TDC+SEA {506} with longer NCI, and continuous tracking TDC+SEA {507}.
2. Set the secondary code index, perform the satellite PCA search with the TDC+SEA operation {502}(described above), and find the code phase of a candidate peak. If a peak is not found above the threshold parameter, return to {501} for the next procedure on the list.
3. Set the nominal frequency shift, initial code advance, SEA first bin frequency, and step frequency parameters for Acq-BW TDC+SEA operation {506}, perform the operation 506 (described above), and precisely estimate the satellite frequency.
4. Adjust the settings of nominal frequency shift, initial code advance, secondary code index, SEA first bin frequency, and step frequency parameters for the continuous tracking TDC+SEA operation {507} and begin continuous tracking in operation 507 (described above).

### Acquisition to Tracking Path 2C

The condition, in one embodiment, for Path 2C of the single-satellite acquisition-to-tracking procedure is precise assistance is provided, such that the frequency and secondary code index should be confirmed during the primary code acquisition operation {502} with sufficient accuracy to proceed directly to continuous tracking. The operations, in one embodiment, along path 2C are:
1. The API Programming Software {510} programs the parameters for all the planned operations in the procedure through the API {501}; the operations are Acq-BW TDC+SEA {502} and continuous tracking TDC+SEA {507}.
2. Set the secondary code index, perform the satellite PCA search with the TDC+SEA operation {502}(described above), and find the code phase of a candidate peak. If a peak is not found above the threshold parameter, return to {501} for the next procedure on the list.
3. Adjust the settings of nominal frequency shift, initial code advance, secondary code index, SEA first bin frequency, and step frequency parameters for the continuous tracking TDC+SEA operation {507} and begin continuous tracking in operation 507 (described above).

In the example shown in FIGS. 7A & 7B, a GNSS receiver can use thresholds (in the embodiment shown in FIGS. 7A & 7B) that are set through an API that can allow each threshold to be set independently of each of the other thresholds used in the embodiment in FIGS. 7A & 7B; hence, different operations or processes can used different thresholds that are set through the API, and the host processing system can set these different thresholds through the API. Similarly, other embodiments can use an API to set and adjust the different thresholds in the other methods and systems described herein. The thresholds can be set and changed on a per channel basis for each GNSS SV's signal (e.g., one threshold for FDC detection (e.g., in operation 503) of a candidate peak for an E5A signal from a first Galileo GNSS SV and another (different) threshold for TDC acquisition of a candidate peak (e.g., in operation 502) for an E5A signal from a second Galileo GNSS SV). In other embodiments, the different thresholds may be set and changed directly without using an API on a per channel basis.

In one embodiment, an API firmware library in source code can be delivered to a licensee of the FDC correlator 19 from the developer of the FDC correlator to allow the licensee to create a design than augments the correlator 17 so that the GNSS receiver has two different acquisition engines with one of those acquisition engines (FDC) being used through the API. This source code in one embodiment can be cross compiled with the licensee's software (e.g., firmware in GNSS processing system 23) to implement the API. In one embodiment, the API calls to set up and use the Receiver Core functionality are blocking operations, which return to the caller context after the register and memory content are set. The acquisition requests are (in one embodiment) non-blocking, meaning that the results of a requested operation can be obtained by polling or delivered back to the MSW asynchronously. In one embodiment, most Receiver Core API operations execute with a specific delay (e.g., 40 ms), after which the results are available. The API includes polling functions to read operation results once they are complete. Alternatively, asynchronous communication with the MSW is available using inter-process communication (IPC) calls. The API source code, in one embodiment, can include a header file with declarations of callback functions which are called after the requested Receiver Core operation concludes.

### Example of a GNSS Receiver

FIGS. 9A & 9B show another example of a GNSS receiver according to one or more embodiments described herein. This GNSS receiver in FIGS. 9A and 9B may be used with one or more of the methods described herein, such as the one or more methods shown in FIGS. 7A & 7B, FIG. 4A, or FIG. 4B; moreover, the GNSS receiver in FIGS. 9A and 9B can include an embodiment of the API described herein. Furthermore, the GNSS receiver in FIGS. 9A and 9B can also represent a more detailed example of the GNSS receiver shown in FIG. 3B or FIG. 3A. For example, in one embodiment, the GNSS receiver in FIGS. 9A and 9B can be an embodiment of an instantiation of IP core 129 in FIG. 3B. Furthermore, in one embodiment, the GNSS receiver in FIGS. 9A and 9B can include the TDC/SEA implementation (and other operations) shown in FIGS. 8A-8C.

In one embodiment, a complete GNSS receiver device, as shown in FIGS. 9A & 9B, from antenna input to measurement output (e.g., pseudorange measurements and frequency measurements and range/rate measurements, etc.), may be assembled within a low-cost (e.g., $0.50), small form-factor (e.g., 5×5 mm), system-in-package (SiP), and the SiP may include (1) RF frontend circuitry 702 mounted on the SiP substrate that connects to an external L5-band antenna 701, (2) an analog-mixed-signal (AMS) application specific integrated circuit (ASIC) silicon die 720, (3) a temperature sensing crystal (TSX) composed of a piezo-electric crystal 708 and thermistor sensor 709, and (4) miscellaneous inductor and capacitor components 705, mounted on the SiP substrate, that are used for conditioning the two power supply inputs used in this embodiment. In this embodiment, the inputs are the antenna feed and two power supplies, and the primary digital inputs/outputs are a 4-wire serial peripheral interface (SPI) for the software API, which is a very low bandwidth interface (e.g., 1k-10k bytes/second) for receiver configuration and control inputs and GNSS satellite signal measurements outputs. In one embodiment, the GNSS receiver in FIGS. 9A & 9B may include a position engine (implemented in a processing system) which uses the GNSS satellite signal measurement outputs to compute position and other data, and the position engine can use one or more position solution methods (e.g., a weighted least squares method with or without a Kalman filter method that can use outputs from the weighted least squares method) to compute position and velocity data as outputs from the GNSS receiver. The GNSS receiver shown in FIGS. 9A & 9B can have the following components in one embodiment.

### Block 701—Antenna

The GNSS receiver device requires an antenna 701, preferably optimized to the L5-band center frequency of 1191.795 MHz and bandwidth of 51.5 MHz.
In this embodiment, the antenna is an external device outside the SiP. However, in a second embodiment, the antenna may be fabricated as a thin package cover for the SiP to save substantial area on the printed circuit board (PCB) that contains the GNSS receiver device.
There are several variations of shared and dedicated antennas, for example:
   The antenna may be shared with a 2.4 or 5 GHz Bluetooth transceiver, a 2.4 or 5 GHz WiFi transceiver, a 3G, 4G, or 5G cellular phone or wide-area network (WAN) transceivers, or any combinations of the mentioned Bluetooth, WiFi, and cellular transceivers.
   For a shared antenna configuration, the GNSS receiver device and other transceivers may be isolated by a diplexer or triplexer filter device at the antenna feed to provide sufficient rejection of out-of-band signals into the GNSS receiver from any coexisting adjacent transmitters.
   The GNSS Receiver, in one embodiment, can support all the commonly available antenna configurations and types used in the industry, such as Laser Direct Structuring (LDS), Printed Circuit Board (PCB), Flexible Printed Circuit (FPC), ring, chip, patch, stamped metal, whip, dome, shark fin, and module.

### Block 702—RF Frontend

The radio frequency frontend circuitry 702 (RFFE) includes, in one embodiment, a low noise amplifier and one or more filters, and the RFFE 702 is more commonly not integrated on an AMS ASIC 720 primarily due to concerns of electromagnetic compatibility with (1) adjacent transmitters that are not in the L5-band that coexist on the same device application and (2) high-power digital circuits on the ASIC that may radiate or conduct into the RF input.
Constructing the RFFE on the SiP saves PCB area and integration costs for a complete solution.
There are other important reasons why the RFFE is not integrated into an ASIC but instead constructed of discrete components off-chip, such as
   The discrete device implementation of a low noise amplifier (LNA) often has a better noise figure.
   The primary RF filter, typically a surface acoustic wave (SAW) device, has a far better out-of-band rejection when it's a discrete SAW or chip inductors and capacitors, and acoustic devices are generally unavailable for practical ASIC implementation.
   The inductors and capacitors for RF matching networks require large areas on an ASIC, which is a major cost driver.
   Therefore, the RFFE is often better implemented as off-chip discrete components.
The GNSS E5ab-band signal of interest is a BOC(15,10) modulated signal with an A and B sideband frequency band from −25.575 MHz to +25.575 MHz (primary lobes) around the carrier center frequency of 1191.795 MHz. The RF filter and matching network circuitry can be designed specifically for the signal of interest and provide rejection of out-of-band signals from any coexisting wireless communications transmitters that may be adjacent to the GNSS Receiver.

### Block 703—RF Module

The RF Module 703, in one embodiment, includes an additional RF amplifier, filtering, and a direct conversion quadrature mixer. These components are generally more optimum to place on the ASIC die because they tightly interface with other AMS (analog mixed signal) circuitry 706 and 707.
In one embodiment, a direct conversion quadrature mixer may downconvert the 1191.795 MHz E5ab signal center with a local oscillator (LO) of frequency 1192.0 MHz, and the resulting baseband signal may be at −205 kHz center frequency.
The post-mixer amplifier circuitry may include an AC coupling capacitor to substantially remove the DC component on the signal that is a common effect with direct conversion mixer devices, such that the downstream baseband amplifiers 706 and ADC 711 do need to amplify and quantize the signal DC component, which is of no importance to GNSS signal processing. This method may simplify the design and reduce power consumption for the baseband amplifiers and ADC.

### Block 704—Voltage Regulators

In one embodiment, the GNSS Receiver has two separate power supply inputs from two off-chip DC-DC switching power supplies, and there may be additional inductors and capacitors 705 on the SiP for conditioning the two power supply inputs. The first power input may be a higher voltage (e.g., 1.2 volts) and supply a group of low dropout (LDO) regulators to reduce the switching noise for sensitive linear circuits, such as the off-chip LNA 702, on-chip RF amplifiers 703, baseband amplifier 706, frequency synthesizer 707, and the analog portion of the ADC 711. The second power supply input is higher power and is used during the acquisition search procedure; therefore, it is more energy efficient to start with a lower voltage (e.g., 0.5 volts) and go directly to, without an LDO, the GNSS Receiver Core 721, which contains non-sensitive digital modules 712-718, and thus eliminate the power dissipation and cost for an extra on-chip high-power LDO regulator.
One advantage of integrating the multiple LDO regulators on the ASIC is the LDO for each circuit (702, 703, 706, 707, and 711) can be independently controlled, in one embodiment, by ASAP 716 and/or microcontroller 718 for a power savings versus performance tradeoff during low-power GNSS signal tracking.

### Block 705—Voltage Inputs and Regulator(s)

Block 705 represents a set of voltage regulators, and has been described above.

### Block 706—Baseband Module

In one embodiment, the analog baseband processing 706, prior to ADC 711, includes active filters and amplifiers, where the amplifier gain may be 40 dB and have the capability of multiple 3 dB steps controlled by firmware running on ASAP 716 and microcontroller 718. The 3 dB gain steps allow the ADC 711 input signal level, which is mostly noise based on the LNA 702 noise figure, to be more precisely set for optimum ADC loading while gracefully handling strong pulsed interference signals in some environments.

### Block 707—Frequency Synthesizer

In one embodiment, the frequency synthesizer 707 may be a phase lock loop (PLL) type of synthesizer with an integer reference divider and feedback divider, a digital phase-frequency detector that controls a charge pump circuit, and an 1192 MHz voltage-controlled oscillator (VCO), and an off-chip crystal 708 is connected to an on-chip oscillator circuit to generate the reference frequency for the PLL.
The integer feedback divider, in one embodiment, for the 1192 MHz VCO is composed of divide-by-2 logic for the generation of the 596 MHz main clock, used by the Receiver Core 721, and a further divide-by-8 logic for the generation of the 74.5 Msps ADC sampling clock, thereby producing the main digital and ADC clocks with near-perfect 50% duty cycles for an optimum digital circuit timing constraint.
The feedback division, in one embodiment, is extended with a programmable integer divider, the oscillator reference has a programmable integer divider, and the two integer dividers may be programmed by microcontroller 718 (MCM 718) such that the inputs to the digital phase-frequency detector are the same frequency.
In this embodiment, all the digital clocks within Receiver Core 721 are derived from integer divisions of the 596 MHz main clock, which is divided by 2 from the 1192 MHz local oscillator. Therefore, if any harmonic signals from any of the derived digital clocks are conducted or radiated into the L5-band RF circuitry (702 and 703), the interference signals that are in the L5-band will have a frequency of 1192 MHz, and the mixer circuit will translate these signals to 0 Hz, and the AC coupling circuit will eliminate them from the baseband signal. Thus, by design, the frequency plan defined in this embodiment is highly tolerant of self-interference and its potential for GNSS signal processing degradation.

### Block 708, 709—Crystal and Thermistor

The crystal 708 and thermistor 709 on the SiP are thermally connected in one embodiment and, together, form a temperature-sensing crystal (TSX) for the on-chip oscillator circuit 707. An uncompensated crystal may have a large frequency offset (e.g., ˜10 ppm) due to temperature variation compared to a temperature-compensated crystal oscillator (TCXO) with typically ˜1 ppm error, but the TSX is less expensive, so it is often used in low-cost applications.
Furthermore, the power consumption of a standalone TCXO, which is typically outside the GNSS receiver, can be substantial relative to the power consumption of the whole GNSS receiver during low-power tracking with phase coherency, while the on-chip oscillator and frequency synthesizer circuitry that relies on a crystal can be optimized for lower power and can always stay active for phase coherency during low-power tracking.
Hence, when compared to conventional GNSS TCXO solutions, the solution of TSX with an on-chip oscillator circuit has the benefits of better tracking performance, reduced cost, and reduced tracking power consumption.
Unlike most other receivers, the advantage of a GNSS Receiver with position software is that it can measure the frequency error on all received tracked signals relative to the predicted frequency offset due to the range rate Doppler shift; then, it can estimate the common frequency offset among all the received tracked signals due to the error of the oscillator frequency. The oscillator frequency error may be supplied through the API by the position software application, and the Microcontroller 718 can realign the DSP Receiver 712 to compensate for the frequency error such that it has no impact on the receiver operations.
This frequency compensation method is only available when the GNSS receiver is tracking satellites. Before the acquisition search and continuous tracking procedures, the receiver may rely only on the temperature sensor to estimate oscillator frequency error. The Microcontroller 718 periodically measures, in one embodiment, the relationship between crystal 708 frequency and thermistor 709 resistance with the sensor ADC 710. Whenever the position software application provides the oscillator frequency error through the API, which is typically done at the continuous tracking rate (e.g., 1 Hz), the GNSS receiver records the frequency-vs-resistance characteristics, and the receiver continues to refine the characteristics due to crystal aging over the life of the device.
This GNSS measurement method allows a receiver with a TSX to have comparable frequency accuracy to a TCXO while saving cost and power consumption.

### Block 710—Sensor ADC

The sensor ADC can be used to measure the relationship between crystal 708 frequency and thermistor 709 resistance, and this measured relationship can be used by microcontroller 718 to improve, as described above, the estimate of the oscillator frequency error in the outputs of the frequency synthesizer 707.

### Block 711—ADC Module

In one embodiment, the analog to digital converter 711 resolution is 6 bits per in-phase and quadrature path at the sample rate of 74.5 MHz, which is derived from an integer divide of the frequency synthesizer 707 output. This frequency plan has about a 3× oversampling of the 25.575 MHz analog baseband signal of interest, which provides an adequate sample rate margin for a low-cost, low-power analog baseband filter amplifier.
In one embodiment, the ADC voltage reference is designed for an additional input range of effectively 3 to 4 bits beyond 6 bits to handle strong pulsed interference signals without saturating the ADC analog input. The ADC data output has a 6-bit range in one embodiment; however, the digital sample values from analog signals that exceed this range, such as during pulsed interference, are saturated to the highest or lowest value in the 6-bit range. The downstream DSP operation, in one embodiment, will detect and effectively ignore any saturated ADC samples from the GNSS signal processing. Therefore, the ADC has an effective 9-10 bit range with reasonable fidelity to suppress pulsed interference, but the power consumption and cost are not 8 to 16 times more for 3 or 4 bits more ADC precision.

### Block 712—DSP Receiver Module

The following is a summary of features and capabilities of one embodiment of DSP Receiver Module 712 which processes the digital output from the ADC module 711 to create digital samples of the received GNSS signals at baseband for storage in the sample array memories 715 which is coupled to the DSP receiver module 712. Other embodiments can have different features and capabilities of the DSP Receiver Module 712.
ADC Interface—programmable for offset binary or signed data type and serial or parallel I&Q ADC interface.
DC Compensator—automatic compensation of residual DC offset from the RF receiver quadrature down-conversion circuit.
Signal Limiter—performs interference mitigation by suppression of signals that are statistically far above the typical noise level established by the LNA. The selection of blanking, threshold limiting, or hard limiting is automatically controlled, in one embodiment, by the interference classification firmware, and the status is accessible through the API receiver control section.
Gain Steps—programmable gain steps in digital processing with 24 dB range for optimum signal levels through the DSP Receiver. Configurable for a wide variety of RF receivers and antennas.
I and Q balance—provides independent fine adjustment of the in-phase and quadrature DSP signal paths to minimize in-balance due to the RF mixer, analog baseband amplifiers, RF and analog filters, and ADC, thereby improving spectrum image rejection and GNSS performance.
Out-of-band (OoB) Rejection Filter—suppresses out-of-band signals so they do not fall into the band of interest and degrade GNSS performance.
Zero IF Downconverter—translates the received signal from low IF frequency (e.g., a few MHz) to zero IF frequency (e.g., a few Hz) with automatic alignment to oscillator drift.
Notch Filters—automatic detection and suppression of continuous-wave (CW) interference with up to 4 notch filters in one embodiment.
Equalizer—compensates for amplitude, phase, and group delay variation of RF filters over the full E5a/b frequency band with a programmable complex finite impulse response.
Sideband Downconverter—separates and translates the A and B sideband signals from −15.345 MHz and +15.345 MHz to 0 Hz baseband.
Fractional Rate Decimator—filtering and down-sampling from the programmable IF sample rate (e.g., 60-80 Msps) to the precise 20.48 Msps and 20.46 Msps required for the FDC and TDC operations.
Sample Quantizer—final quantization to a symmetrical 16-level data type (4 bits) for storage into the sample memories and later processing by the FDC and TDC operations.
Signal Estimator—estimates the mean, RMS, and probability density at multiple points in the DSP Receiver for automatic amplitude and DC-offset alignment and interference detection and classification.

### Block 713—Support Modules

The support modules 713 include the (1) top-level clock dividers for all clocks in the Receiver Core, (2) the Receiver Timebase, which maintains the receiver reference time with the resolution of the IF sample period (clock cycle count), millisecond, and second, (3) memory controllers for all internal memory cores, and (4) AHB bridge to all internal command and status registers and memory cores.

### Block 714—Generator of Local Replica of PRN Code and Shifters

The code generator module 714 contains (1) the code sample generator and array memory for the FDC operation and (2) the code bit and frequency shifter phase generators for the TDC operation. The generators in module 714, in one embodiment, reproduce the primary code bits (primary PRN code) and secondary code bits (secondary PRN code) or samples every millisecond before or during an FDC or TDC operation. In other words, in one embodiment, the primary code bits or samples for all possible satellites are not permanently saved into FDC or TDC operation memory, and thus, there are substantial savings in on-chip memory costs and great reductions in bus bandwidth to move these bits or samples around within the receiver. U.S. Pat. No. 11,686,855 provides an example of an embodiment of such a code generator (see, e.g., FIGS. 9A-9D and associated text in U.S. Pat. No. 11,686,855.

### Block 715—Sample Array Memories

In one embodiment, the sample array memories 715 are separated into A and B sideband baseband samples for both the FDC and TDC operation, and the FDC array is 512 rows by 40 columns at 20.48 Msps sample rate, and the TDC array is 5115 rows by 4 columns at 20.46 Msps sample rate. Both arrays contain, in one embodiment, exactly a 1 ms period of samples. The memories are implemented, in one embodiment, within 1.25 ms circular buffers, where the previous 1 ms segment in the arrays is accessed by FDC and TDC operations, while the other 0.25 ms segment is overwritten with new samples. The sample array memories have an output coupled in one embodiment to the GNSS ASAP 716.

### Block 716—GNSS Processing System (ASAP)

The primary purpose of the GNSS Application Specific Array Processor (ASAP) 716 is to perform the vector and array operations for the very fast frequency domain correlation, FDC, NCI, TDC, SEA, WB-SEA, SPC, and Maxima (e.g., peak detection) algorithms, which are described in other sections of this document. In one embodiment, the GNSS ASAP 716 is coupled to the sample array memories 715 to receive GNSS sample data for FDC and TDC processing operations in the GNSS ASAP 716, and the GNSS ASAP 716 is coupled to the code generator module 714 to control the module 714 and to receive the generated (and optionally shifted) local replica of the PRN codes for processing in correlation operations in the GNSS ASAP 716. The GNSS ASAP 716 is also coupled to the correlation integration memory 717 to store the integrated correlation results from the correlation operations performed by GNSS ASAP 716.
The ASAP 716 also performs, in one embodiment, several receiver control functions, such as receiver calibration and periodic alignment, adaptive power management for the entire GNSS Receiver, memory sleep state control, interference detection and mitigation, digital frequency and sample phase compensation due to oscillator frequency error, and DC offset correction of ADC samples. In one embodiment, the GNSS ASAP 716 can perform these receiver control functions in response to one or more requests from the microcontroller 718 to perform these functions.
The ASAP 716 includes, in one embodiment, memories for the program, variables, constants, A and B sideband spectrums after an FFT of the sample memory, and the operation command and status memory for the internal hardware-firmware interface.

### Block 717—Correlation Integration Memory

The Correlation Integration Memory (CIM) 717 is, in one embodiment, the only hardware scaled by the hardware configuration compile option as described herein, which allows for a choice in the maximum number of concurrent FDC+NCI and TDC+SEA operations built into the Receiver Core 721 when fabricated. In one embodiment, FDC and TDC correlation operations can be concurrent in time (e.g., one portion of the GNSS ASAP 716 performs FDC operations for one or more GNSS SVs and another portion of the GNSS ASAP 716 performs TDC operations for one or more GNSS SVs such that these FDC operations and TDC operations can be simultaneously performed; typically, the position solution engine or the microcontroller 718 can select TDC or FDC for a particular GNSS SV based on the selection methods described herein and these selections may be made through an embodiment of the API described herein).
Larger memories, such as the CIM 717, have proportionally greater leakage currents and thus are divided into smaller physical memory cores on the ASIC. Each of these memory cores in one embodiment has a deep sleep state control. The ASAP 716 firmware actively controls the CIM 717 and all other memory cores within Receiver Core 712 at the instruction cycle level to greatly reduce the leakage currents when the memory is not being used (i.e., a memory core is brought out of sleep only while the memory core contents are needed, and then it's put back to sleep).

### Block 718—Microcontroller

The Microcontroller 718 can execute firmware that performs, in one embodiment, several high-level functions that are characterized as irregular control flow and conventional integer and scaler operations but have very low processing requirements. These firmware functions are more suitable for a higher-level language such as C-code, not assembly code, which is used for ASAP 716 firmware.
The Microcontroller 718 hardware includes, in one embodiment, the SPI interface for the API, which were previously described in this document. In one embodiment, the microcontroller 718 in FIG. 9B (and the rest of GNSS receiver core 721) can be part of a hardware instantiation of IP core 129 in FIG. 3B, and the firmware executing in microcontroller 718 can be the software that receives calls through API 131 in FIG. 3B from software executing on a host system (e.g. host system 135 in FIG. 3B). The firmware (or other forms of software) executing in the microcontroller 718 can configure or set up operations or processing in the GNSS receiver core 721 in response to one or more calls, requests or instructions from software executing on a host system through the API (e.g. API 501 or API 131) that acts as an interface between the firmware and the software executing on the host system (e.g., host system 135, etc.). For example, the firmware executing in microcontroller 718 can receive calls (e.g., through the API 131) from a host program (e.g., software executing on host system 135 or host system 141 in FIG. 3B) to perform one or more acquisition procedures or processes (e.g., one or more procedures or processes as shown in FIGS. 7A & 7B); in this case, the host program can be considered the API Programming software 510. The firmware executing in microcontroller 718 can translate each call (through the API) into commands/instructions for the ASAP 716 to execute as a set of one or more acquisition and/or tracking operations. The microcontroller 718 can, in one embodiment, include both a measurement engine (ME) that determines GNSS measurements (e.g. code phases that specify pseudoranges and range rate (Doppler shift) data) and a position engine (PE) that computes a position and velocity solution based on the GNSS measurements (e.g. using, for example, a weighted least squares algorithm to compute position based on pseudoranges to SVs and ephemeris data for those SVs). In those embodiments in which the microcontroller 718 includes a PE, the outputs from the GNSS receiver Core 721 include position, velocity, and time data. In those embodiments in which a PE does not exist (or is not used) in microcontroller 718, the output from the GNSS Receiver Core 721 include the GNSS measurements (e.g. code phase measurements and range rate measurements) that are used by a PE executing on a host system to compute a position solution and other data using techniques known in the art. In one embodiment, microcontroller 718 is coupled to the GNSS ASAP 716 to program and control the operation of ASAP 716 and is coupled to the support modules 713 to control the operation of support modules 713 and is coupled to DSP module 712 to control the operation of DSP module 712. In one embodiment, power management can be performed by one or both of the microcontroller 718 and ASAP 716, and this power management can use techniques known in the art to reduce power consumed in one or more of: RF module 703, baseband module 706, ADC module 711 and portions of the GNSS Receiver core 721 (including, for example, the CIM 717, the sample array memories 715, the code generation modules 714, the DSP receiver modules 712 and portions of the ASAP 716).
   Time Domain Correlation with Signal Energy Estimation Array Operations

### Overview

One version or embodiment of the Application Specific Array Processor (716) can perform the 4 stage operations for the Very Fast Fourier Transform (VFFT) algorithm, the 7 stage operations for the Frequency Domain Correlation (FDC) with Non-Coherent Integration (NCI) algorithm, and the Time Domain Correlation (TDC) algorithm, which is effectively a 1 stage operation. Another version of ASAP (716) incorporates three more stage operations for the Signal Energy Estimation Array (SEA) algorithm, which completes the TDC+SEA processing as a cascade of 4 stage operations (note, in general, a “stage” in one embodiment maps to a repeat loop of vector instructions in ASAP assembly code).
Embodiments of VFFT and FDC were previously described in U.S. Pat. No. 11,686,855.
The processing flow diagram in one embodiment (for example, see FIGS. 8A-8C) for the TDC and SEA vector and array operations shows all the processing performed on the baseband sample array inputs (e.g., E5-band A and B sideband signals), which are from the DSP Receiver (712), up to the satellite measurements outputs (e.g., code phase and frequency). The green color blocks {601, 608, 610, 612, 613, 615, 618, 619, 621} define the array or vector configuration data types that are saved in memory. The blue color blocks {602-607, 609, 611, 614, 616, 617, 620, 622} are for the operations performed on the arrays or vectors, where the operations may be implemented with a combination of (1) vector, scaler, integer, block floating-point, and pointer arithmetic operations defined in hardware definition language (HDL), (2) microcode, which may be described as “hard-wired firmware”, as it is implemented with instruction decoder logic (HDL), and it defines and coordinates the parallel and pipelined hardware resources (HDL) for the ASAP compound vector instructions, (3) the ASAP (716) firmware as assembly code, and/or (4) the MCU (718) firmware as C-code. The embodiment shown in FIGS. 8A, 8B, & 8C can be used for each of the TDC+SEA operations in FIGS. 7A & 7B (e.g., operations 502, 504, 505, 506, and 507 in FIGS. 7A & 7B), and the embodiment shown in FIGS. 8A, 8B, & 8C can be used after an FDC operation such as operation 503 in FIG. 7A. The embodiment shown in FIGS. 8A, 8B & 8C can be used in an implementation of the method shown in FIGS. 7A & 7B, so processing can begin with FDC operations and then proceed to the TDC operations and other operations shown in FIGS. 8A-8C. The hardware and software/firmware that performs each of these operations for a channel can be reused over time for each of these operations in FIGS. 7A & 7B so that, for the channel there is one instance of the hardware and its software/firmware rather than potentially up to five instances of the hardware. This results in reduced power consumption so that energy consumed per fix is lowered by this approach.
The 4 stage operations of the TDC+SEA process algorithm are defined as
   Stage 1 is the TDC operation, which is composed of sub-operations in blocks {601:607}.
   Stage 2 has a primary path for the Discrete Fourier Transform (DFT) operation (609) or a second path option for the Secondary-Primary Code (SPC) operation (617).
   Stage 3 is the Non-Coherent Integration (NCI) operation (611) with optional path inputs from either the DFT Array (610), SPC Array (618), or Correlation Array (608)
   Stage 4 is the Maxima operation (614)

### Block 601

Block 601 is a memory that stores at least 1 millisecond (ms) of received GNSS signals. In one embodiment, the TDC operation processes 20460 complex samples per 1 ms length correlation operation at a sample rate of 20.46 Msps or effectively two samples per chip period (2 spc). The TDC operation (in correlators 607) correlates, in one embodiment, a 1 ms length of received GNSS signals that were stored in memory in block 601.
The baseband samples, in one embodiment, are the result of GNSS L5 signal processing from the antenna, RF Receiver, ADC, and DSP Receiver, and the samples are continuously saved into a 1.25 ms length circular buffer memory (601).
In one embodiment, there are separate baseband sample arrays for the E5 A and B sidebands, each with complex elements and dimensions of 5115 rows by 4 columns, which contains precisely the 1 ms length sample set for the TDC operation.
The TDC operations are scheduled, in one embodiment, across the four quarters of the 1 ms correlation period such that the 0.25 ms buffer segment that is currently being updated is not within the 1 ms buffer segment required for the next TDC operation.

### Block 602

Block 602 can be a sideband selector and sample interpolator in one embodiment. One TDC operation parameter, specified in the API in one embodiment, is used to select the A or B sideband sample array that is used during the next group of TDC operations, collectively known as a TDC Channel Group. In one embodiment, GNSS sample data (from the received GNSS signals) from both the A and B sidebands are correlated in TDC operations (in correlators 607) and the outputs of the TDC operations may be, in one embodiment, integrated into a single memory location for each code phase hypothesis (as described in U.S. Pat. No. 11,686,855).
Every concurrent group of TDC operations has an independent control of the A or B selection (i.e., the entire group must process the same array) in one embodiment.
The sample interpolation operation (in block 602) can be performed while the sample array is read from memory during the 5115 row-access cycles, and the results are applied to the group of TDC operations.
The sample interpolation operation (in block 602), in one embodiment, calculates eight unique sampling phases and presents all 8 sample streams to the group of TDC operations. The sampling phases are separated, in one embodiment, by ⅛^{th} of a sample period or, equivalently, 1/16^{th} of a chip period.

### Block 603—TDC Hardware Channel

Each TDC Hardware Channel (603), in one embodiment, is composed of a phase and code generator module (604), the 1-of-8 sample phase selector (605), frequency shifter (606), and TDC X1 correlator set (correlators 607).
In one embodiment, the hardware instruction for the TDC Channel Group is partitioned into 16 separate hardware channels (603), where each may have a unique parameter set specified in the API, and each may independently process the same sample set from a sample array (601).
The TDC Channel Group hardware instruction may be resource-shared many times during the 1 ms correlation processing interval (e.g., 32 times per ms with 320 correlations each for a total of 10,240 L5 time-domain correlators, times 20 frequency-domain bins per correlator bin for a total of 204,800 time-by-frequency-domain correlator bins in the GNSS Receiver)

### Block 604—Phase & Code Generator

The phase and code generator module (604) is configured, in one embodiment, by the TDC operation parameters; some parameters are directly specified through the API, and others are calculated every millisecond based on API parameters.
There are TDC operation parameters, in one embodiment, for the satellite constellation and number, the initial phase of the frequency shifter, the frequency shift amount, the 1-of-8 sampling phase selection, primary code initial advance, delta code advance per ms (range rate compensation), secondary code initial index, the correlator set X-expansion number, and either the pilot or data subchannel selection for an A or B sideband selection.
The generated phase shift values and primary-secondary code bit values are applied to the frequency shifter (606) and correlator (607) during every cycle of the 5115 row-access cycles from sample memory (601) in one embodiment.

### Block 605—Sample Phase Selector

The sample phase selector (605) routes 1-of-8 available sample streams to the frequency shifter (606).
The sampling phase is constant for the duration of the correlation interval in one embodiment.
The sampling phase is updated, in one embodiment, at the start of the correlation interval, based on the continuous accumulation of the delta code advance parameter every millisecond; this method compensates for a known satellite range rate, which may be specified with an operation parameter in the API.

### Block 606—Frequency Shifter

The frequency shifter (606), in one embodiment, performs frequency translation of the GNSS signal to baseband (0 Hz) for the case of a known Doppler frequency shift in tracking, or it translates to a desired fixed offset frequency for further processing with the DFT (609) and SPC (617) downstream operations.
The frequency shift is performed, in one embodiment, before the correlator (607) because both the Doppler frequency shift for a 900 m/s range rate and the wideband-SEA operation require about +/−4 kHz programmable range; this is too great of a range to process with the SEA-DFT operation (609), which typically works for less than one-tenth of this bandwidth.
For a wideband-SEA operation in one embodiment, a set of TDC X1 hardware channels (607) are configured for different frequency shift amounts to cover a wider bandwidth than is possible with a single channel. The frequency shift for the first channel is set to the first bin frequency parameter specified in the API for the WB-SEA operation. The frequency shifts for the second through the last channel are separated by multiples of the step frequency parameter.

### Block 607—TDC Correlators

In one embodiment, the TDC X1 hardware channel (607) may contain a set of 20 correlators for an L5 signal (Nₖ=20, where k=0 to Nₖ−1), the TDC Channel Group may include 16 of these X1 correlator sets, and the X1 sets may be grouped and expanded into X2, X4, X8, or X16 sets for 40, 80, 160, or 320 correlator super-sets for one L5 signal. Each correlator in a set of 20 correlators performs time domain correlation of the received GNSS signal against one code phase hypothesis (e.g., a particular code phase index) so that the set of 20 correlators can cover a range of code phase hypotheses (e.g., a 10 chip range of code phase hypotheses at one-half chip resolution). A set of 20 correlators can be referred to as a bank of correlators. A set of 20 correlators (in one bank) is configured, in one embodiment, to correlate/search in a particular frequency bin so that a TDC channel group of 16 banks of correlators (each of the 16 banks including 20 correlators) can correlate/search over a desired frequency search range (e.g., using a 15 Hz range in each bin of the 16 frequency bins, the 16 banks will search a 16×15 (=240 Hz) frequency range). The TDC correlators in the TDC hardware channel 607 are configured to correlate, in one embodiment, a primary PRN code (by correlating a received GNSS signal's primary PRN code against a local replica of that primary PRN code). The results of the TDC correlators in the TDC hardware channel 607 are stored, in one embodiment, in memory in an array (referred to as a C(m,k) correlation array) for further processing as shown in FIGS. 8B & 8C.
The expanded correlator set capability allows for broader time uncertainty searching during primary code acquisition (PCA) and fast re-acquisition of signals that move out of a smaller correlator-set window during tracking.
Further correlator set expansion beyond X16 can be handled through the API as multiple independent TDC+SEA operations in a user-defined acquisition procedure for larger uncertainty.

### Block 608—Correlation Array of Correlation Results

The C(m,k) correlation array (608), in one embodiment, is a complex value array with Nₘ rows, one row per millisecond index m, and Nₖ columns for the correlation results k=0 to Nₖ−1 from a TDC operation. In one embodiment, each column in the Nₖ columns includes the correlation results from a time series of multiple correlation outputs (e.g., over several (m) milliseconds) for a particular TDC correlator (which correlates a 1 ms sample of received GNSS signal against a particular code phase hypothesis m times) in the set of Nₖ correlators (e.g., a set of 20 correlators). In one embodiment, Nₖ=20 and Nₘ can be a multiple of 20 (e.g., 20 or 40 or 60, etc.); k is the index for the particular correlator in the set of correlators (and hence the index for the code phase hypothesis), and m is the index for the particular 1 millisecond sample (of received GNSS signal data) in the set of Nₘ milliseconds of correlated TDC outputs. For example, if Nₘ=20, then the correlation array 608 contains the 20 outputs of the 20 TDC correlations of 20 1-millisecond samples of received GNSS signal data.
The C(m,k) correlation array in one embodiment can be a virtual array because the elements are saved as row vectors every millisecond in TDC result registers, and none of the elements are normally saved in physical memory. Instead, the TDC result register elements are immediately processed every millisecond by downstream operations 609, 611, 617, and 621; hence, there is no need to save them for a longer duration in memory (i.e., there is no increase in memory area and cost for the correlation arrays in this embodiment). In an alternative embodiment, the C(m,k) correlation array can be a complete set of correlated TDC outputs for Nₘ milliseconds of received GNSS signal and be stored as the complete set of correlated TDC output data in physical memory for use by the next operation, such as an alternative embodiment of the discrete Fourier transform operation 609, which processes the complete set of data.

### Block 609—DFT on Correlation Results

The discrete Fourier transform (DFT) operation 609 in FIG. 8B is used, in one embodiment, to create a signal energy estimation array (such as SEA 612 in FIG. 8C) that can be searched (for maximum values as explained below) to derive an estimated code phase and an estimated frequency of the received GNSS signal. The SEA can be used, in one embodiment, as a tracking engine so that the GNSS receiver does not need a conventional tracking loop (e.g., a conventional tracking loop implemented by a delay lock loop and a phase lock loop); in other words, the SEA as shown in FIG. 8C can replace the conventional tracking loop and provide better performance than the conventional tracking loop (especially when there are abrupt changes in the received GNSS signals). The SEA is created, in one embodiment, by a set of DFTs, in operation 609, on the C(m,k) correlation array 608. The set of DFTs can be performed using the virtual memory array approach (e.g., correlation array 608) or using a complete set of correlated TDC output data (e.g., a complete set of Nₘ milliseconds of correlated TDC outputs computed from sampled GNSS digital signal data containing Nₘ sets of 1 millisecond of sampled GNSS signal data) stored in physical memory. The DFT operation 609, when operating on a complete set of data (instead of the virtual array approach), can compute the set of DFTs by processing each column of a physical correlation array 608 with one DFT in the set of DFTs; for example, if each column (for a particular code phase hypothesis) contains 20 outputs of 20 TDC correlations of a sequence of 20 one millisecond digitized samples of received GNSS signal data, then the DFT for one of the columns (in the physical correlation array 608 memory) will be a 20 point DFT that produces a DFT output of 20 values to be stored as one column in the DFT array D(b,k) in memory 610. Each DFT of one of the columns in physical correlation array 608 uses a column of input data in that array 608 to compute a column of output data in the memory 610. If there are 20 columns in the array 608, then there will be 20 DFTs in the set of DFTs for a particular frequency bin. Typically, there can be multiple frequency bins to cover a frequency range of possible received GNSS signals and there can be one array 608 for each frequency bin. If there are, for example, 16 frequency bins, then an embodiment can use hardware to compute, in parallel and concurrently in time (rather than serially over time), 16 sets of DFTs (one set of DFTs for each of the 16 frequency bins) and each set of DFTs includes k DFTs (k being the number of columns in array 608 and the index for code phase hypotheses). The data entries in each column of array 608 may be phase shifted by the amount calculated for the frequency specified for the frequency bin for the particular set of DFTs. The Discrete Fourier Transform (DFT) operation (609) performs, in an embodiment that uses a virtual array 608 (instead of a physical memory array), the following operations: (1) every millisecond, read the partial DFT results of one frequency bin from a row vector of size Nₖ within the DFT array, D(b,k), in memory (610), (2) phase shift all elements, k=0 to Nₖ−1, of the TDC correlation results vector (607) by the amount calculated for the frequency specified for the frequency bin, (3) perform complex vector addition of the D(b,k) row vector (frequency bin) of size Nₖ and the phase-shifted correlation results of size Nₖ, (4) save the complex vector integration results back into the row vector (frequency bin) in the DFT array, D(b,k), in memory (610) for the next millisecond of partial processing, (5) repeat the above procedure for all frequency bins, b=0 to N_{b}-1, and (6) repeat the above partial processing procedure for all milliseconds, m=0 to Nₘ−1, over the DFT length.
The phase shifting and integration process of the DFT operation can be continued for the DFT length in milliseconds, which is a parameter in the API. The other related DFT operation parameters in the API are the number of frequency bins, N_{b}, the base frequency for the first frequency bin, and the step frequency between the frequency bins.

### Block 610

For all DFT operations, the complex element DFT array, D(b,k), is saved into memory (610). The resource manager (RM), in one embodiment, determines the optimal overall memory map for all DFT operation arrays and the specific location in memory (610) for each DFT operation array.
In one embodiment, a block floating-point data type may be used to save memory space for the DFT Arrays; this permits performing more DFT operations and saving more arrays in the same sized physical memory cores, thereby increasing (e.g., doubling) the correlation capacity of the GNSS Receiver.

### Block 611

Block 611, in one embodiment, represents a non-coherent integration operation. After the Discrete Fourier Transform (DFT) operation (609) has completed all partial DFTs over the DFT length, the Non-Coherent Integration (NCI) operation (611) performs the following operations, in one embodiment: (1) after every DFT length (in m milliseconds), read the final DFT results of one frequency bin from a row vector of size Nₖ within the DFT array, D(b,k), in memory (610), (2) read the energy integration results of one frequency bin from a row vector of size Nₖ within the Signal Energy Estimation Array, E(b,k), in memory (612), (3) calculate the magnitude-squared values for all elements, k=0 to Nₖ−1, of the DFT results vector, (4) perform complex vector addition of the DFT magnitude-squared row vector of size Nₖ and the Energy Array, E(b,k), row vector of size Nₖ, (4) save the magnitude-squared integration results back into the row vector (frequency bin) in the Energy Array, E(b,k), in memory (612) for the next non-coherent integration iteration, and (5) repeat the above procedure for all frequency bins, b=0 to N_{b}−1.
For the wideband-SEA operation in one embodiment, the DFT operation (609) is bypassed, and every millisecond, the TDC results registers (607) are directly routed to the Non-Coherent Integration (NCI) operation (611), where the magnitude-squared values are immediately calculated, and then summed into an Energy Array, E(b,k), in memory (612).
   Recall for WB-SEA that the TDC X1 channels (in one embodiment) are at different frequency shifts and in consecutive order, so the Energy Array for the WB-SEA operation will look similar to the DFT NB-SEA, except over a much wider bandwidth due to the wider frequency bin spacing setup in the TDC operation used in wideband SEA.
The Non-Coherent Integration (NCI) operation (611) may also process the results in the Secondary-Primary Code Estimation Array, S(i, k), saved in memory (618).
   The NCI processing for an SPC operation (617) is similar to the standard SEA, although the S(i,k) rows are secondary code index estimation bins instead of frequency bins.
In one embodiment, while the NCI operation (611) is processing the Energy Array, E(b,k), in memory (612), the NCI operation also calculates the sum of all Nₖ elements in each frequency bin row vector.
   In a later post-processing operation, the sum is normalized by Nₖ to determine the mean value in each frequency bin row vector of the Energy Array, E(b,k).
   The mean values are saved into the Frequency Bin Mean, M(b,1), column vector in memory (613) for later use in the Maxima operation (614) and for continuous-wave interference detection (status in the Receiver Control section of the API).

### Block 612—SEA Data Array

In one embodiment, a signal energy estimation array (SEA) contains the results (in the form of magnitude squared “energy” values) of time domain correlations over a range of code phase hypotheses (also referred to as different PRN code delays or different PRN code advances depending on the embodiment) and also over a range of different possible frequencies; thus, the data in the array can be used to search over two variables or dimensions (code phase hypotheses and frequency) to find GNSS PRN signals and their Dopplers. The data can be collected and one or more maxima detection algorithms can be used to conduct the search to determine a code phase and frequency based upon the results in the array. In the SEA 612 in FIG. 8C, N_{b} represents the frequency domain dimension and Nₖ represents the code phase dimension. In one embodiment, for all NCI-SEA operations, the SEA magnitude-squared data-type Energy Array, E(b,k), is saved into memory (612). The resource manager (RM), in one embodiment, determines the optimal overall memory map for all operation arrays and the specific location in memory (610) for each operation array.
In one embodiment, the SEA operation has a parameter from the API for an option to linearly combine the pilot subchannels for the A and B sidebands (e.g., for SVs in the Galileo GNSS constellation, the E5AQ and E5BQ SEA energy data values are combined into a single data array rather than two separate arrays; see U.S. Pat. No. 11,686,855 for more information about combining results from correlation operations into a single hypothesis memory). The RM configures, in one embodiment, this capability by specifying the same location in memory (612) for both of the pilot channels, and thus, both channel SEA results are summed into the same E(b,k) array in memory (612).
In one embodiment, a block floating-point data type may be used to save memory space for the Energy Arrays; this permits performing more SEA operations and saving more arrays in the same sized physical memory cores, thereby increasing the correlation capacity of the GNSS Receiver.

### Block 613

The mean values are saved into the Frequency Bin Mean Array, M(b,1), which is defined as a column vector data type in memory (613), in one embodiment.

### Block 614

The Maxima operation (614) is performed, in one embodiment, after the NCI operation (611) stage as a separate and last stage of the 4-stage TDC+SEA process.
The Maxima operation (614) performs, in one embodiment, the following operations: (1) read the energy integration results of one frequency bin from a row vector of size Nₖ within the Energy Array, E(b,k), in memory (612), (2) read the mean value for one frequency bin from the Frequency Bin Mean, M(b,1), column vector in memory (613), (3) perform subtraction, with an underflow limiting operation (positive value results), of the bins' mean value from all elements of the frequency bin row vector to produce the deviation-above-mean row vector, (4) for each element of the deviation row vector, test and record when the element deviation value is within the top two values of the Energy Array correlation bin column vector fir the current frequency bin, (5) repeat the above procedure for all frequency bins, b=0 to N_{b}−1, of the Energy Array, and (6) save the top two deviation values in each correlation bin column vector, k=0 to Nₖ−1, into the Maxima Array, X(2, Nₖ), in memory (615).

### Block 615—Maxima Array of Data

The maxima (determined in operation 614) are saved into the Maxima Array, X(2,k), in memory (615).

### Block 616—Peak Processing and Detection

The peak processing and detection operation (616) is implemented, in one embodiment, in C-Code on the MCM (718).
The operation scans, in one embodiment, through the Maxima Array, X(2,k), in memory (615) to search for three types of peak signals: (1) the largest overall peak within the SEA that exceeds the detection threshold specified in the API, (2) the largest early arrival peak within the SEA that exceeds the detection threshold specified in the API, and (3) the largest peak near or within the specified SEA track point correlator-frequency bin.
The peak processing operation (616) may access the 3-by-3 element subarray around each of the candidate peaks to perform 2-dimensional interpolation to achieve finer precision on the code phase and frequency measurements.

### Block 617

The Secondary-Primary Code (SPC) detection operation (617) can be similar to an embodiment of the DFT operation (609) in that it can perform the operation as partial steps of correlator results processing over some length of milliseconds, but the array row dimension is the secondary-code-index bin, not frequency bin as in the DFT operation.
The operation 617 can use, in one embodiment, conventional time domain correlation to correlate different code phase hypotheses of local replicas of GNSS secondary codes against the received GNSS signals containing GNSS secondary codes in order to determine one or more code phases of one or more secondary codes in received GNSS signals. Operation 617 may be tailored to use more hardware resources or fewer hardware resources depending on the implementation. The TDC correlations in operation 617 may use all of a received epoch of a secondary code to perform a secondary code time domain correlation or a 1 millisecond portion (or some other portion) of the received epoch (which can use less hardware resources than using a full secondary code epoch). Further, the TDC correlations in operation 617 may use only a subset of possible secondary code phase hypotheses instead of all possible secondary code phase hypotheses. The subset of possible secondary code phase hypotheses may be selected based on acquisition information from estimating or acquiring one or more code phases of one or more primary GNSS codes (e.g., from prior FDC operations on the primary GNSS code or prior TDC operations on the primary GNSS code) from received GNSS signals. For example, operation 617 may use estimates of one or more primary code phases (e.g., from one or more acquired primary GNSS PRN codes from a prior FDC operation on such primary GNSS PRN codes or a prior TDC operation on such primary GNSS PRN codes) to select the subset of possible secondary code phase hypotheses for use in a TDC correlation in operation 617; further, operation 617 may select a subset of possible secondary codes based on SVs determined to be in view from prior correlation and processing operations on primary code signals received from those SVs. The prior TDC operation can be, for example, the TDC operations performed by the TDC hardware channel 607. Operation 617 can use conventional techniques to accumulate and integrate the results of the correlation of the secondary codes to determine one or more secondary code phases from one or more of the received GNSS secondary codes. In other embodiments, other methods may be used to correlate a secondary PRN code and determine a code phase measurement of the secondary PRN code, such as one or more of the methods described in U.S. Pat. Nos. 11,821,993 and 12,085,652, both of which are incorporated herein by reference.

### Block 618 SPC Estimation Array

For all SPC operations, the complex element SPC Array, S(si,k), is saved into memory (618). The resource manager (RM), in one embodiment, determines the optimal overall memory map for all SPC operation arrays and the specific location in memory (618) for each SPC operation array.

### Block 619, 620

After a DFT operation (610) of a specified length is completed for a pilot sub-channel (e.g., one of the E5AQ or E5BQ GNSS signals), there is an option to save the row vector of the specified zero Hertz frequency bin of DFT Array, D(b,k). In one embodiment, the specified zero Hz frequency bin is the middle frequency (mid-point) of the bin in the middle of the frequency range specified by the set of frequency bins used in operation 506 in FIGS. 7A & 7B. This vector is referred to as a Correlation Vector. It may be saved into memory (619), where the post-processing operation (620) may be performed using (in one embodiment) machine learning algorithms such as the machine learning methods described in US published patent applications US 2023/0050047 and US 2023/0126547. The results may be transferred through the API to an external application processor that performs the machine learning position software algorithms (e.g., in operation 509 in FIG. 7B). Alternative embodiments can use or extract other types of data to use as inputs to machine learning methods.

### Block 621, 622

After a pilot and data subchannel TDC operation (603), there is an option for the demodulation operation (622), every millisecond, to save one correlation result (from the k=0 to Nₖ−1 set) for the pilot and data subchannels into column vectors of size Nₘ. After Nₘ milliseconds, as specified in the API, the data symbols may be demodulated from the pilot and data column vectors and saved into API memory as soft-decision values. An external application processor software may read these values through the API and perform the deinterleaving and convolutional decoding of the soft-decision values to produce the satellite navigation message information. These are shown as operation 508 in FIG. 7B.

In one embodiment, a GNSS receiver can be programmable so that a designer (or programmer or user) of the GNSS receiver can configure the operations of the receiver based upon the goals and beliefs of how to best operate the receiver for a given set of one or more uses. The word “designer” is meant to be generic and can include, for example, an architect of the receiver or programmer who writes software for execution in the GNSS receiver or a user of the receiver. For example, a designer of a GNSS receiver can configure how one or more of: an RF receiver portion, an acquisition engine, a measurement engine, a tracking engine and a position engine operate for a given expected use of the GNSS receiver. At least portions of this configuration, in one embodiment, can be static in that once it is selected by a designer it is programmed/written into the software which calls an API to implement the selected configuration and this configuration does not change during usage of the device containing the receiver. The GNSS receiver can alternatively be, in one embodiment, dynamically programmable in that its configuration can be changed during usage (e.g., after the one or more ICs containing the receiver have been manufactured and installed into a device such as a smartphone or smart watch or other wearable device or an object tracker, etc.) as a result of, for example, changes in the operating environment, etc. For example, the GNSS receiver may have a first set of configuration parameters selected as a default configuration (e.g., a factory setting) or first configuration, and this default configuration can be installed on first boot up of the software, and then during usage of the device containing the receiver, the software can select a second set of configuration parameters to install a second configuration. The switch between configurations can be based on one or more of: operating environment, or expected usage of the device, or battery power levels (e.g., fully charged versus nearly depleted) of a battery that is providing power in the device, or desired power consumption levels, or signal environment conditions (e.g., the RF channel environment, device specific RF conditions based on RF transmitters in the device, detection of jamming from non-GNSS SV sources, or country or region specific RF signal conditions), or other criteria. The operating environment can include aspects such as: receiver motion dynamics (e.g., high or low motion dynamics), crystal oscillator force dynamics (e.g., the receiver is repeatedly bouncing up and down thereby effecting the output from the crystal oscillator), extreme ambient temperature or temperature of device containing the receiver, etc. The RF channel environment can include aspects such as: dynamically detected signal degradations such as multipath, signal blockage/attenuation, interference of A or B sidebands, effects from adjacent RF transmitters in the device, etc. Changes in the configuration, through the API, of the receiver can also occur during the process of the search for correlation peaks; for example, the progress of a peak search process can influence the later search strategy. When a new peak or first peak is found, the search space for peaks for other GNSS signals can often be reduced because there is greatly reduced uncertainty in the peak search process; moreover, a peak that is found can be programmed to go directly to tracking and data subchannel demodulation. This programmability can be achieved through the use of software executing on a GNSS processing system (e.g., host GNSS processing system), which software uses or makes calls to an API, such as embodiments of the API described herein.

The API can provide a platform for a designer (e.g., programmer) of a GNSS receiver to configure or tailor the design of a GNSS receiver based on the designer's beliefs in how to configure the receiver for its expected one or more use cases; different designers may have different theories or hypotheses about how to configure a GNSS receiver for a given expected use case of the GNSS receiver. Thus, one designer can use the API to develop a GNSS receiver using a first configuration that uses a long dwell time and longer integration time periods for infrequent position fixes (e.g., when the GNSS receiver is used in an object tracker), while another designer can use the API to develop a GNSS receiver using a second configuration that uses short dwell times and other parameters when a GNSS receiver is used in a wearable device such as a smartwatch or glasses. The one or more acquisition search strategies used in a GNSS can be programmed through the API in one embodiment, and the search strategy can be dynamically changed during the progress of searching for and acquiring a plurality of GNSS signals from a plurality of GNSS SVs. Moreover, the API can allow a designer (working for a first entity), who uses an “IP core” (licensed from a second entity that developed the IP core and the API) to program an instantiation of the IP core in a GNSS receiver designed by the designer (working for the first entity). Such a use of software and an API to configure or tailor a design of a GNSS receiver, based on the IP core, can be used in any of the embodiments described herein, including the embodiments described relative to any one of FIGS. 1-5 and 7A-9B. The IP core can specify the hardware design of the entire GNSS receiver (e.g., from antenna input to outputs of position/time/velocity data) or one or more portions of the GNSS receiver (e.g., the FDC portion in the case of an L1/L5 hybrid receiver as shown in FIG. 1), and the API can be designed to operate with the hardware design specified by the IP core. The hardware design in the IP core can be specified, in one embodiment, using a hardware description language (HDL) such as Verilog or other HDLs which can be synthesized using conventional tools known in the art; in alternative embodiments, the hardware design can be specified in a netlist format (or other formats known in the art such as an RTL (register transfer level) format or a circuit schematic) for one or more known fabrication processes used by a semiconductor foundry. An intellectual property (IP) license (from the entity that developed the IP core and the API to another entity that develops a GNSS receiver based on the IP core and the API) can include a transfer of information about the IP core, and this information can include the hardware design (either in HDL or netlist form or other forms) along with information about the API (and any related software that operates with or instantiates the API) and also software that can be used in the software developed by the licensee to use the API. The licensee can then develop their implementation of a GNSS receiver (using the licensed IP core and the API) and create software that programs or configures, through the API, the IP core according to the licensee's beliefs about how to configure and operate the GNSS receiver for one or more expected uses. In one embodiment, a designer can select one instantiation for the hardware from a set of possible instantiations of the hardware (e.g., 3 or 5 possible instantiations); each of these possible instantiations can have different amounts of memory which in effect determines the amount of processing that can be performed. For example, a “lite” instantiation can have the smallest amount of memory which limits the number of simultaneous FDC acquisition channels; a medium instantiation can have a medium amount of memory that is more than the smallest amount of memory but less than an amount of memory available in a “pro” instantiation. The medium hardware instantiation can use more FDC acquisition channels than the lite hardware instantiation but fewer FDC acquisition channels than the pro hardware instantiation. In one embodiment, the selection of the hardware instantiation can be through an HDL compile option (when compiling the HDL that represents the IP core) that selects the amount of memory in a hardware instantiation of the IP core. When the IP core is delivered in HDL format, the HDL is compiled, based on the selected options, to create the instantiation in hardware from the IP core. The software can be written to make calls to the API to thereby program the instantiation of the IP core in the hardware designed by the licensee. Selection of various parameters and settings through the API can select one or more configurations for the GNSS receiver that contains the licensed IP core.

As noted above, API calls with different parameters can achieve different desired goals for an implementation of a GNSS receiver containing the licensed IP core and API. For example, a designer of a low cost Internet-of-things (IoT) device such as an object tracker may configure the device (which does not get precise time from a source such as a network) to use a lite/reduced size instantiation of the IP core (which has a smaller memory than a medium size instantiation of the IP core) and select the fewest number of FDC correlation operations in the selected hardware instantiation. A designer of a smart phone that can receive precise or fine time from a network can use a higher hardware instantiation (e.g., a “pro” hardware instantiation) and can configure, through the API, the receiver for an acquisition process that uses time domain correlation with a frequency dimension through SEA. Selecting a higher hardware instantiation does not require the use of all available resources (24 FDC correlation channels in the “pro” hardware instantiation) in the higher hardware instantiation—a designer can, through the API, select when and how to use all available resources, choosing in some cases to use less than all available resources (e.g., using only 8 or 16 FDC correlation channels in the “pro” hardware instantiation) to reduce power consumption (while potentially increasing TTFF). If a designer prefers lower power consumption while willing to tolerate longer time to first fixes when receiving GNSS signals in the L5 band, a designer may configure the GNSS receiver to use time domain correlators in most cases instead of frequency domain correlators; this can be configured through one or more calls through an API in one embodiment. The API in one embodiment can be used to configure the power consumption goals of a GNSS receiver. Moreover, the API can be used to balance performance against power consumption and can also be used to achieve particular receiver sensitivity objectives and time to first fix (TTFF) objectives. Other aspects that can be controlled through the API include: receiver dynamics, oscillator frequency offset range, and interference and multipath mitigation.

FIG. 3B shows an example of a device containing a GNSS receiver created by a licensee from the IP core and API licensed by a licensor which developed the IP core and the API. The device may a wearable or a smartphone or an IoT device or part of a vehicle such as an automobile; the host system 141 is coupled to the GNSS host system 135, and the host system 141 contains the hardware and software that implements the functions of the device such as a smartphone. The host system 141 can request the GNSS receiver to provide one or more of position or time or velocity data and receive a response with such data from the GNSS receiver. In some embodiments (e.g., the device is a smartphone), the host system 141 can provide GNSS assistance data to the GNSS receiver as described herein; this assistance data can come from one or both of internal sources (e.g., a barometric sensor) and external sources (e.g., a server coupled to a network). In one embodiment such as a low cost IoT device, the GNSS host system 135 may be part of the host system 141 (so there is no separate microcontroller to control and run the GNSS receiver). The GNSS receiver includes one or more antennas 125 to receive GNSS signals from GNSS SVs, a hardware instantiation 129 of the licensed IP core, an API 131, and the GNSS host system 135. The hardware instantiation 129 may be one of the different levels of hardware (e.g., lite or medium or pro instantiation levels) selected by the designer of the GNSS receiver; the designer, working for the licensee, can select the hardware level as an HDL compile option when compiling the HDL to create the instantiation of the IP core 129. The designer can also decide how much of the IP core to use in one embodiment. In one embodiment, the IP core may be used to create all the GNSS receiver, while in another embodiment, the designer or licensee may use only portions of the IP core (such as, referring to FIG. 3A, memory 107, FDC & TDC 109, hypothesis memory 111, functionality for a measurement engine and functionality for a tracking engine, and the firmware for controlling these components and for receiving the calls through the API and responding to those calls). In the case of the use of only portions of the IP core, the designer or license can use their own components, such as an RF front end and ADC and a position engine (e.g., a position engine executing in the software in host system 135 in FIG. 3B), and couple them to the hardware instantiation of the IP core. Many potential licensees may want to use their own, proprietary position engines that will execute, for example, on the GNSS host system 135; in alternative embodiments, the position engine may be part of the firmware in an instantiation of the IP core 129. The software in the GNSS host system can interact with the host system 141 to receive requests for position data and to respond with position data as well as other data such as time and velocity. The software in the GNSS host system 135 can configure and control the operation of the instantiation of IP core 129 by using the API 131 to make calls, through the API 131, to the firmware in IP core 129; the use of an API is known in the art. The firmware in IP core 129 can be stored in non-volatile memory that is re-programmable so that the firmware can be updated (e.g., the firmware can be updated to include an updated API, such as an updated API that improves resistance to jamming or spoofing of GNSS signals). The API 131 can be all of the API described herein (e.g., all of the API tables herein) or a portion of that API described herein. The software in GNSS host system 135 can be created by a programmer working for the licensee and can execute on the processing system (e.g., a microcontroller) in the GNSS host system 135. As shown by arrow 137, the software in GNSS host system 135 can make calls for procedures (e.g., search and acquisition, tracking, etc. to be performed by the instantiation of IP core 129) and make calls to allocate resources as described herein. The instantiation of IP core 129 can respond, as shown by arrow 139 with GNSS measurements, such as code phase measurements of the acquired GNSS signals and frequency and velocity measurements and optionally correlation vectors (which may be used in machine learning algorithms in the GNSS host system 135). The host system 141 can be in a drone and include an inertial navigation system, and the antenna 125 can be a controlled reception pattern antenna, and the API can be used to mitigate against jamming of GNSS signals in one embodiment. The drone may further include a second GNSS receiver to receive GNSS signals in the L1 band; such a drone would require an adversary to jam both L1 and L5 signals in order to impact the navigation of the drone which can use GNSS signals in both the L1 and L5 bands. The system shown in FIG. 3B can implement any one of the methods described and shown herein; for example, the system in FIG. 3B can perform one of the methods shown in FIG. 4A or 4B or 7A & 7B. In this example, the instantiation of IP core 129 can perform one or more operations shown in these FIG. 4A or 4B or 7A or 7B, and the GNSS host system 135 may also perform some of those operations which are done by a host system as described herein. Together, the instantiation of IP core 129 and the GNSS host system 135 can perform all of the operations in an implementation of one of the methods shown in FIG. 4A, 4B or 7A & 7B. An embodiment of the instantiation of IP core 129 can be part of an embodiment of the system shown in FIGS. 9A & 9B; for example, the instantiation of IP core 129 can include all or parts of the various modules shown in FIGS. 9A & 9B, including the RF module 703, voltage regulators 704, the modules/components of the analog mixed-signal section, and the GNSS receiver core 721. When the instantiation of IP core 129 (in FIG. 3B) includes the GNSS receiver core 721 (in FIG. 9B), the microcontroller 718 can interface with a host system through the API 131 (in FIG. 3B). The system shown in FIG. 3B can also be included in an embodiment of the system 401 shown in FIG. 5; for example, the instantiation of IP core 129 can be part of GNSS processing system 405 which can also include a GNSS host processing system 135, and the host processing system 141 can be part of the one or more application processors 407.

Another embodiment in which an L5 only FDC correlator is used to augment a hybrid L1 & L5 TDC correlator can use an interface that is not an API; this embodiment may arise from the same company developing both the hybrid L1 & L5 TDC correlator and the L5 only FDC correlator, so there is no need for an API to act as an interface. In this embodiment, the interface may be a conventional hardware bus or interconnects that couple the GNSS processing system to the L5 only FDC correlator (without an API). In this embodiment, the GNSS receiver can use the L5 only FDC acquisition engine when needed due to L1 interference or other problems that prevent the use of the hybrid L1 & L5 TDC correlator from acquiring GNSS signals. FIG. 2B shows a method for operating a GNSS receiver where the interface is not an API. In another embodiment, the method shown in FIG. 2B can be used to operate a GNSS receiver which does use an API such as an embodiment of the API described herein. In operation 71, a GNSS receiver (e.g., the receiver shown in FIG. 1) can attempt to acquire L1 GNSS signals using the hybrid L1/L5 TDC acquisition engine (e.g., L1 & L5 TDC correlator 17 in FIG. 1). In operation 73, the GNSS receiver uses the hybrid L1/L5 TDC acquisition engine to acquire L5 GNSS signals; in one embodiment operation 73 may be dependent upon successful acquisition of at least one L1 GNSS signal. In an alternative embodiment, operation 73 may be concurrent with and simultaneous with operation 71 when assistance data is good enough that it limits the TDC search space for acquiring L5 signals with the hybrid L1/L5 TDC acquisition engine. Examples of when assistance data is good enough are provided below; for example, when the GNSS receiver has fine time assistance data and fine position assistance data and GNSS SV ephemeris assistance data, the search space is reduced for a TDC correlation of L5 GNSS signals in the hybrid L1/L5 TDC acquisition engine. When such assistance data is available, the hybrid L1/L5 TDC acquisition engine can concurrently acquire both L1 and L5 GNSS signals (so, in this situation, acquisition of L5 GNSS signals is not dependent on first acquiring L1 GNSS signals). In one embodiment, when such assistance data is available the TDC acquisition engine can be used to acquire L5 GNSS signals and also be used to independently acquire L1 GNSS signals at the same time (assuming the TDC acquisition engine has a sufficient number of TDC correlators to simultaneously acquire both L1 and L5 GNSS signals). On the other hand, if such assistance data is not available and if L1 GNSS signals cannot be acquired by the hybrid L1/L5 TDC acquisition engine, then the GNSS receiver switches, in operation 75, to using the L5 only FDC acquisition engine (e.g., L5 only FDC correlator 19 in FIG. 1) to acquire L5 GNSS signals. Operation 75 may occur while the GNSS receiver intermittently attempts to acquire L1 GNSS signals (in operation 71); these intermittent attempts may reveal it is possible to resume use of the hybrid L1/L5 TDC acquisition and discontinue use of the L5 only FDC acquisition engine when the hybrid L1/L5 TDC acquisition engine can be used. In one embodiment, switching between acquisition engines can occur dynamically over time depending upon the existing signal conditions (e.g., interference, spoofing) and current assistance data. In operation 77, the L5 only FDC acquisition engine, if used, provides GNSS measurement data (such as code phase measurements, frequency measurements, correlation vectors, etc.) obtained from the FDC correlation operations to a GNSS processing system (e.g., GNSS processing system 23 in FIG. 1) to allow the GNSS processing system (in operation 79) to compute one or more position solutions. The L5 only FDC acquisition engine may also include time domain correlators that are enhanced with a frequency domain component using the TDC/SEA techniques described herein. The GNSS processing system can also compute one or more position solutions from measurement data from the hybrid L1/L5 TDC acquisition engine when the hybrid L1/L5 TDC acquisition engine is used to acquire GNSS signals. The method shown in FIG. 2B is normally repeated over time as the GNSS receiver is used to determine the position of the GNSS receiver.

Another aspect of this disclosure is how a GNSS receiver which has two different acquisition engines, such as the GNSS receiver shown in FIG. 3A, selects between the two different acquisition engines during its operation. In one embodiment, the GNSS receiver shown in FIG. 3A can be an L5 only receiver that processes only L5 GNSS signals and does not use or acquire L1 GNSS signals. This GNSS receiver includes an antenna 103 configured to receive GNSS signals from GNSS SVs; the antenna 103 is coupled to a GNSS RF front end and ADC 105. The GNSS RF front end and ADC can include one or more low noise amplifiers and one or more RF filters to amplify and filter the received GNSS signals. The received signals (after being amplified and optionally filtered) are then converted into digital representations of the received signals by one or more ADCs. The resulting digital representations are stored in memory 107 for processing by the acquisition system 109 which includes two different acquisition engines: an FDC acquisition engine and a TDC acquisition engine. In another embodiment, the GNSS receiver shown in FIG. 3A can be a hybrid L1/L5 GNSS receiver that includes L1 and L5 RF receiving sections which can operate at the same time (or in series over time) to acquire and process both L1 and L5 GNSS signals; in this alternative embodiment, the GNSS receiver can include two GNSS antennas to receive both L1 and L5 GNSS signals, and these received GNSS signals can be amplified and filtered in the GNSS RF front end 105, and the ADC (in 105) can convert the received GNSS signals into digital representations for storage in memory 107 and these stored representations can be processed (in parallel or in series) in the acquisition system 109.

The FDC acquisition engine in the acquisition system 109 can be similar to the L5 only FDC correlator 19 in FIG. 1; the FDC acquisition engine in the acquisition system 109 can use a set of DFTs as described in U.S. Pat. No. 11,686,855 to acquire L5 GNSS signals. For example, the FDC acquisition engine in acquisition system 109 can be implemented as described in U.S. Pat. No. 11,686,855 (see, for example FIGS. 5A-8C and related descriptions in the patent) to compute DFTs of the samples stored in memory 107 and also compute the other DFTs described in that patent (e.g., DFTs of the local replica code and inverse DFTs of the product of the result of DFT of the received GNSS samples and result of DFT of the replica code) to produce correlation outputs that indicate correlation peaks for the received L5 GNSS signals.

The TDC acquisition engine in acquisition system 109 performs correlation, in the time domain, of the received GNSS samples from memory 107 against local replicas of the PRN codes in the GNSS signals (at various different hypothesized code phases) in order to find a correlation peak that specifies a code phase measurement that is used in deriving pseudoranges to GNSS satellites (SVs). In one embodiment, the TDC acquisition engine in system 109 can search for different code phases and also different SVs (with different primary PRN codes) in a set of correlation channels as is known in the art; further, in one embodiment, the TDC acquisition engine in system 109 can also search for different frequencies or frequency offsets. In one embodiment, the TDC acquisition engine performs the search for different frequencies using a signal energy estimation array (SEA) operation on the correlation results from the time domain correlators in the TDC acquisition engine in system 109.

In one embodiment, the SEA operation can be performed on the correlation results from the TDC acquisition by using DFTs as described herein.

The correlation outputs from the selected acquisition engine are stored, during the acquisition process, in hypothesis memory 111 which is coupled to the acquisition system 109 and also coupled to the GNSS processing system 115 as shown in FIG. 3A. The hypothesis memory accumulates each correlation result in each correlation output in a series of correlation results, where each correlation result is for a 1 millisecond of sampled digital GNSS signals; this accumulation is non-coherent in this form of accumulation for the 1 millisecond of primary PRN code data in each sample of digital GNSS signals. The measurement engine (ME) in the GNSS processing system 115 uses the correlation outputs stored in the hypothesis memory to detect a correlation peak that specifies a code phase measurement that can be used to determine a pseudorange to a GNSS SV. The initial code phase measurement for an acquired signal can then be tracked. Once a GNSS signal from a GNSS SV is acquired, it can be tracked in a tracking engine 113, which can be a conventional tracking engine that uses a delay lock loop (or other techniques known in the art to implement a GNSS tracking function or other techniques such as an improved signal energy grid (e.g., signal energy estimation array techniques) that accounts for time domain code phase and frequency domain shifts) to track the code phase for a GNSS signal. The tracking engine 113 is coupled to the GNSS processing system 115 to allow the processing system 115 to receive the output of the tracking engine which provides the current detected value of the code phase for each tracked GNSS signal. In one embodiment, the tracking engine in the GNSS receiver can be implemented with hardware (and any associated firmware) which is in addition to the hardware (and any associated firmware) that implements the one or more acquisition engines; in another embodiment, the hardware for the tracking engine can be shared with the hardware with the one or more acquisition engines so that the shared hardware is used to provide the acquisition and tracking functions at different times (e.g., acquire first with the hardware configured to acquire a GNSS signal and then track with the hardware configured to track the acquired GNSS signal). This sharing of the hardware can be used in the embodiments shown in FIGS. 7A-9B; for example, the TDC hardware may be shared for both acquisition and tracking as described here. The GNSS processing system 115 also can include a position solution engine (PE) that can compute a position solution using algorithms that are known in the art. The GNSS processing system 115 controls the operation of the GNSS receiver, which includes control of the GNSS RF front end 105, the memory 107, the acquisition system 109, the hypothesis memory 111, and tracking engine 113. The GNSS processing system 115 is coupled to a host processing system 117 to receive requests (e.g., a request for a position or time or velocity) from the host processing system 117 and respond to those requests; the GNSS processing system 115 may also request assistance data, such as assistance data 119, which may be from internal sources (e.g., time data, position data from an inertia navigation system, or altitude data from a barometric sensor system, etc.) or external sources (e.g., an approximate position derived from measurement data from cellular telephone signals or WiFi signals, time data from a network, ephemeris data or almanac data from a network, etc.). This assistance data can be used as described herein to select between the acquisition engines in the acquisition system 109. In particular, the GNSS processing system 115 can determine the current state of the assistance data and, based on that current state, select one of the acquisition engines in the acquisition system 109.

FIG. 4A shows an example of a method that can be used by GNSS processing system 115 to select between the acquisition engines in the acquisition system 109. In operation 201 in FIG. 4A, the GNSS processing system 115 can determine the current state of the assistance data that is currently available to the GNSS receiver. At least some of this data can be expressed in terms of uncertainty levels such as standard deviation values (e.g., sigma values); for example, the current state of the estimated position and estimated time can be expressed as a level of uncertainty (where a higher uncertainty is a higher sigma value and hence not as accurate as a data with a low uncertainty value). For example, coarse position data has a higher uncertainty than fine position data and coarse time data has a higher uncertainty than fine time data. Other data can be expressed as present or not present (e.g., the GNSS receiver has valid and current ephemeris data, etc). In operation 203, the GNSS processing system 115 can, based on the current state of the assistance data select an acquisition engine or acquisition mode. If the first acquisition mode is selected (operation 205), then the GNSS processing system 115 causes the FDC acquisition engine to be used to acquire GNSS signals (and the TDC acquisition engine is not used to acquire GNSS signals) for the current receiving period of time. Processing reverts back from operation 205 to operation 201 to repeat the process. If the second acquisition mode is selected (operation 207), then the GNSS processing system 115 causes the TDC acquisition engine to be used to acquire GNSS signals (and the FDC acquisition engine is not used to acquire GNSS signals) for the current receiving period of time. Processing reverts back from operation 207 to operation 201 to repeat the process; thus overtime, the processing system 115 will repeatedly perform the method shown in FIG. 4A so it may be dynamically switching many times between acquisition engines over time based upon the current state of assistance data. In the embodiment shown in FIG. 4A, the TDC acquisition engine can also use a signal energy estimation array as described in conjunction with FIGS. 8A-8C to search in both time and frequency bins during the acquisition procedure or process which searches for a correlation peak.

FIG. 4B shows an example of the selection logic that can be used in operation 203 of FIG. 4A. In this example in FIG. 4B, coarse position is defined as an estimated position that has an uncertainty (which can be defined by standard deviation [sigma] of estimated position values) of more than, for example, 5 kilometers (km) and less than, for example, 75 km (in other words, position is known at least with an accuracy of 75 km from the true position but not more than an accuracy of 5 km). Smaller standard deviation values indicate smaller estimated errors in position, which is a lower uncertainty in position. Fine position is defined, in this example, as an estimated position where the estimated position uncertainty is less than, for example, 5 km (so the estimated error in position is less than 5 km). Coarse time is defined, in this example in FIG. 4B, as an estimated error in time (relative to GNSS time) that is greater than, for example, 1 millisecond (ms). In an alternative embodiment, the definition for coarse time can be an estimated error in time (relative to GNSS time) that is greater than, for example, 1 second; in yet another alternative embodiment the definition for coarse time can be an estimated error in time (relative to GNSS time) that is greater than, for example, 10 microseconds. The particular embodiment of the definitions or values used for these position and time parameters that are used can depend upon the hardware or processing capabilities to perform search in the code phase and frequency spaces; greater hardware or processing capabilities (e.g., more correlators in the TDC acquisition engine) allow for larger numbers for coarse time (e.g., coarse time has an estimated error in time of greater than, for example, 1 second) and coarse position (e.g., coarse position has an estimated error in position of greater than, for example, 75 km or 150 km or even 300 km). Normally, the definition for coarse time also defines fine time (for example, if coarse time is more than 1 ms, then fine time is less than 1 ms). The particular values selected as the upper and lower limits of coarse position (e.g., 75 km for the upper limit in one example) can vary within a range of numbers such as a range defined by, for example, 25% of the values described herein; for example, the value of 75 km may be varied by an increase of up to 25% of 75 km or a decrease of 25% of 75 km. The same variation of the upper and lower limits for coarse time can also be used in some embodiments.

In the example in FIG. 4B, processing can begin in operation 301. In the embodiment shown in FIG. 4B, the TDC acquisition engine can also use a signal energy estimation array as described in conjunction with FIGS. 8A-8C to search in both time and frequency bins during the acquisition procedure or process which searches for a correlation peak (e.g., the TDC operations in each of operations 303, 307, 311, 315, 319, 323, and 327 can use TDC with a signal energy estimation array). Each of the operations 301, 305, 309, 313, 317, 321, and 325 determine the current state of assistance data in the GNSS receiver. A GNSS processing system can use a state machine or other processing logic to perform the method shown in FIG. 4B. A GNSS processing system, such as GNSS processing system 115, can determine, in operation 301, whether or not the GNSS receiver is in a “cold start” mode; a cold start mode can be defined as a mode in which the GNSS receiver has no ephemeris data, no almanac data, and no position assistance data (or very uncertain position assistance data, such as an estimated error in position of more than, for example, 300 km). A cold start mode often happens when the device (e.g., a smartphone) containing the GNSS receiver has been turned off for many days and has not saved a prior position data (e.g., the GNSS receiver has not been previously used in the device). If the GNSS receiver is in a cold start mode, then (in operation 303), the GNSS processing system selects the FDC acquisition engine to acquire all GNSS SVs (e.g., the FDC acquisition engine acquires at least one sideband [A or B or both A & B] of L5 GNSS signals from at least 4 GNSS SVs). After the GNSS receiver acquires a sufficient number of GNSS signals in operation 303 and one or more position solutions have been successfully computed and almanac data has been received, then the GNSS processing system switches to use of the TDC acquisition engine during the current operating session. If the GNSS processing system determines (in operation 301) that the GNSS receiver is not in the cold start mode, then the GNSS processing system determines, in operation 305, whether the current state of the assistance data is: have almanac but no ephemeris data and no position assistance data (which may be referred to as state 305); if the current state is state 305, then in operation 307 the GNSS processing system selects the FDC acquisition engine to acquire all GNSS SVs (e.g., the FDC acquisition engine acquires at least one sideband [A or B or both A & B] of L5 GNSS signals from at least 4 GNSS SVs). After the GNSS receiver acquires a sufficient number of GNSS signals in operation 307 and one or more position solutions have been successfully computed, then the GNSS processing system switches to use of the TDC acquisition engine during the current operating session.

If the GNSS processing system determines (in operation 305) that the GNSS receiver is not in state 305, then the GNSS processing system determines, in operation 309, whether the current state of the assistance data is: have almanac and have coarse time but no ephemeris data and position assistance data which has an uncertainty of greater than, for example, 75 km (which may be referred to as state 309); if the current state is state 309, then in operation 311 the GNSS processing system selects the FDC acquisition engine to acquire all GNSS SVs (e.g., the FDC acquisition engine acquires at least one sideband [A or B or both A & B] of L5 GNSS signals from at least 4 GNSS SVs). After the GNSS receiver acquires a sufficient number of GNSS signals in operation 311 and one or more position solutions have been successfully computed, then the GNSS processing system switches to use of the TDC acquisition engine during the current operating session.

If the GNSS processing system determines (in operation 309) that the GNSS receiver is not in state 309, then the GNSS processing system determines, in operation 313, whether the current state of the assistance data is: have coarse time and have ephemeris data and position assistance data which has an uncertainty of greater than, for example, 75 km (which may be referred to as state 313); if the current state is state 313, then in operation 315 the GNSS processing system selects the FDC acquisition engine to acquire all GNSS SVs (e.g., the FDC acquisition engine acquires at least one sideband [A or B or both A & B] of L5 GNSS signals from at least 4 GNSS SVs). After the GNSS receiver acquires a sufficient number of GNSS signals in operation 315 and one or more position solutions have been successfully computed, then the GNSS processing system switches to use of the TDC acquisition engine during the current operating session.

If the GNSS processing system determines (in operation 313) that the GNSS receiver is not in state 313, then the GNSS processing system determines, in operation 317, whether the current state of the assistance data is: have coarse time and have ephemeris data and have coarse position assistance data which has an uncertainty of greater than, for example, 5 km but less than, for example, 75 km (which may be referred to as state 317); if the current state is state 317, then in operation 319 the GNSS processing system selects the FDC acquisition engine to acquire all GNSS SVs (e.g., the FDC acquisition engine acquires at least one sideband [A or B or both A & B] of L5 GNSS signals from at least 4 GNSS SVs). After the GNSS receiver acquires a sufficient number of GNSS signals in operation 319 and one or more position solutions have been successfully computed, then the GNSS processing system switches to use of the TDC acquisition engine during the current operating session.

If the GNSS processing system determines (in operation 317) that the GNSS receiver is not in state 317, then the GNSS processing system determines, in operation 321, whether the current state of the assistance data is: have coarse time and have ephemeris data and have fine position assistance data which has an uncertainty of less than, for example, 5 km (which may be referred to as state 321); if the current state is state 321, then in operation 323 the GNSS processing system selects the FDC acquisition engine to acquire a first (single) GNSS SVs (e.g., the FDC acquisition engine acquires at least one sideband [A or B or both A & B] of L5 GNSS signals from one GNSS SV). After the GNSS receiver acquires a GNSS signal from a GNSS SV using the FDC acquisition engine in operation 323, then the GNSS processing system switches to use of the TDC acquisition engine for remaining SVs during the current operating session and continues to use the TDC acquisition engine during the current operating session.

If the GNSS processing system determines (in operation 321) that the GNSS receiver is not in state 321, then the GNSS processing system determines, in operation 325, whether the current state of the assistance data is: have fine time (which can have an uncertainty of less than, for example, 1 ms or less than 10 microseconds [or other values] depending on the embodiment) and have ephemeris data and have fine position assistance data which has an uncertainty of less than 5 km (which may be referred to as state 325); if the current state is state 325, then in operation 327 the GNSS processing system selects the TDC acquisition engine to acquire all GNSS SVs (e.g., the TDC acquisition engine acquires at least one sideband [A or B or both A & B] of L5 GNSS signals from at least four GNSS SVs).

Each time operation 203 (in FIG. 4A) is performed, the selection logic shown in FIG. 4B can be used to make the selection of the acquisition engine for the current operating session of the GNSS receiver. The embodiment shown in FIG. 4B can be considered to have seven (7) different states or conditions that define the complete possible set of states or conditions for the assistance data; alternative embodiments may have fewer or more states or conditions. In some embodiments, the states may be limited to a cold start state, a warm state and a hot state; generally, the “temperature” of the state increases from the cold start state at the top of FIG. 4B to the “hot” state at the bottom of FIG. 4B (with the “warm” states in the middle in FIG. 4B). An alternative embodiment may use an approach that uses FDC when fine time assistance is provides time with an accuracy of less than 1 millisecond or 0.5 milliseconds; in this alternative embodiment, the GNSS processing system can use FDC (instead of TDC) when such use of FDC results in lower power consumption by the GNSS receiver (relative to the power consumption which would have occurred if TDC was used).

The one or more embodiments described herein can be used in a system with other components that are coupled to a GNSS receiver that includes the one or more embodiments. Examples of such systems include, for example, smartphones, smart watches, wearables (e.g., head mounted displays or fitness wearables), internet of things (IoT) devices, vehicles (e.g., an automobile or an unmanned aviation vehicle such as a military drone), inertial navigation systems (e.g., systems that include accelerometers or dead reckoning systems) and other devices that can include a GNSS receiver to provide position information, etc. FIG. 5 shows an example of such a system which may be a smartphone or a smartwatch or other devices. The system 401 in FIG. 5 includes GNSS RF components 403 and a GNSS antenna 402 coupled to the GNSS RF components 403; the GNSS RF components 403 can include one or more low noise amplifier(s) and one or more bandpass filters and one or more downconverters and one or more analog to digital (ADC) converters. In some embodiments, the system 401 can include an additional GNSS antenna (e.g., if the system includes a hybrid L1/L5 GNSS receiver that receives and processes GNSS signals from both of the L1 and L5 radio frequency bands), and in some embodiments, an antenna may be shared with other systems (e.g., Bluetooth transceivers or WiFi transceivers). These GNSS RF components 403 can receive GNSS signals from GNSS SVs, through antenna 402, and amplify and create digital representations of the received GNSS signals and store them in one or more data sample memories that are accessed by the GNSS processing system 405. The GNSS processing system 405 can include all of the hardware and software used to acquire and track GNSS signals using, for example, digital correlators and tracking loops; the GNSS processing system may also include memory to store the data samples of the received GNSS signals. The digital correlators may be hardware correlators (e.g., see for example, US 2009/0213006) or fast Fourier transform based processing logic that uses discrete Fourier transforms (DFT) to correlate the received GNSS signals with locally generated or stored PRN codes. Published US application number 2022/0137236 describes examples of the use of DFT processing to correlate received GNSS signals. In one embodiment the digital correlators may include a correlation system that includes two or more acquisition engines such as a TDC acquisition engine and an FDC acquisition engine. The GNSS processing system 405 can also include processing logic that implements a measurement engine that processes the correlation results to compute pseudorange measurements and range rate measurements, and the GNSS processing system can also include a position engine that computes positions (e.g., latitude and longitude data) using known methods, such as a weighted least squares algorithm with or without the use of filters such as Kalman filters or other known methods, to compute the position of the GNSS receiver from pseudorange measurements and SV ephemeris data. In an alternative embodiment described below, the position of the GNSS receiver can be computed by a remote server that is coupled to the GNSS receiver through one or more networks. The GNSS processing system 405 can also extract the ephemeris data (e.g., satellite navigation data) from the received GNSS signals. In one embodiment, the system 401 may receive the SV ephemeris data from one or more sources other than the SVs (e.g., from an assistance server as described herein). In one embodiment, the GNSS processing system can implement one of the methods described herein. In one embodiment, the GNSS processing system 405 can include one or more trained models (e.g., trained neural networks) that provide data used by one or both of the measurement engine or the position engine. For example, the GNSS processing system 405 can include a trained model to provide a selection of SVs as described in U.S. patent application Ser. No. 18/118,677 which was filed on Mar. 7, 2023 by Applicant oneNav, Inc and which is hereby incorporated herein by reference. The GNSS processing system 405 may also include a trained model that provides excess path length (EPL) corrections to correct pseudorange measurements to mitigate multipath effects; U.S. patent application Ser. No. 17/836,116, filed on Jun. 9, 2022 by applicant oneNav Inc., provides examples of such a trained model that provides EPL corrections and is incorporated herein by reference. The GNSS processing system 405 may also include a trained model that classifies GNSS signals as either line-of-sight signals or non-line-of-sight signals. The GNSS processing system 405 can provide computed positions (e.g., latitude and longitude data) of the GNSS receiver to other components of system 401, such as the one or more application processors 407.

The GNSS processing system 405 is coupled to the other components of system 401 through one or more buses, such as the bus 409. In one embodiment, the system 401 can include multiple buses that are coupled to each other through one or more bus interfaces as is known in the art. In one embodiment, the GNSS processing system 405 may be coupled to the one or more application processors 407 through a local bus 421 that is coupled to a shared memory 423 which can be shared between the GNSS processing system 405 and the one or more application processors 407. Published US application US 2022/0137236 provides an example of such a shared memory. In one embodiment, the GNSS processing system 405, the shared memory 423, and the one or more application processors 407 can be instantiated in a single integrated circuit which can be referred to as a system on a chip (SOC). The shared memory 423 may be used by the GNSS processing system 405 to store locally generated PRN codes for the correlation operations (if such codes are stored rather than being dynamically generated) and to store accumulation results of the correlation operations (such as accumulation results for code phase hypotheses and Doppler shift hypotheses). The one or more application processors 407 can be the main processors on system 401 that execute user programs and system programs (such as telephony applications and other communication applications, web browsers, messaging applications, maps and navigation applications, productivity applications, social media applications, etc.) on the system 401. The GNSS processing system 405 and the one or more application processors 407 can operate together to provide navigation services to the user of the system 401; furthermore, the one or more application processors or the GNSS processing system 405 can utilize other components in system 401 (such as one or more sensors 431, the cellular telephone modem 415, and/or the other RF components 433) to provide assistance data that can be combined with or fused with position data from the GNSS processing system. In one embodiment a GNSS antenna may be shared with other receiver systems (e.g., a WiFi system or a Bluetooth system, etc.).

The system 401 includes non-volatile memory 411 which may be any form of non-volatile memory, such as flash memory; the non-volatile memory can store system software (e.g., operating system software), system data and user applications and user data. The non-volatile memory 411 is coupled to the rest of the system 401 by bus 409. The system 401 includes DRAM 413 (dynamic random access memory) which can be consider the main memory of the system 401; it stores loaded and running user and system applications and stores system and user data as is known in the art. The DRAM 413 is coupled to the rest of the system 401 by bus 409. The system 401 also includes a cellular telephone implemented by cellular telephone modem and processor 415 and cellular telephone RF components 417 and antenna 419. The cellular telephone (or other RF components 433) can be used to request and receive GNSS assistance data (e.g., satellite almanac data, SV ephemeris data, approximate position data, approximate or fine time data, Doppler data, and correction data such as GNSS SV clock bias data, ionospheric corrections, etc.) from one or more assistance servers. The cellular telephone and/or other RF components may also be used by the user for communication, including phone calls, text messaging, social media applications, internet applications, etc.

The system 401 also includes one or more conventional input/output (I/O) controllers 427 that couple zero or more input devices and zero or more output devices to the rest of the system 401. The I/O controllers 427 can be conventional 1/O controllers used to interface an input or output device to the rest of the system 401. Some of the input devices may be sensors 431 that can provide assistance data that is used when computing or determining a position. This assistance data can be combined with or fused with a position solution from a GNSS position engine. For example, the sensors 431 may include a barometric pressure sensor that can be used to provide an estimate of the altitude of the system 401 as is known in the art. This altitude can be used by the position engine when computing a weighed least squares solution (e.g., the altitude from the barometric pressure sensor can provide the initial estimated altitude value in the weighted least squares algorithm). This altitude from the barometric pressure sensor may also be used to provide a measure of the reliability of the altitude computed from a position solution. In one embodiment, the barometric pressure sensor may be calibrated or corrected by data from an assistance service which can account for current weather and environmental conditions (using techniques known in the art) in the vicinity of the system 401 to provide a more accurate altitude. The sensors 431 may also include an inertial navigation system (INS) or dead reckoning system that can, once initialized with a correct position, provide position data about the location of the system 401 as it moves; the INS can include accelerometers and gyro devices that measure movement of the system 401 over time. Data from the INS can be combined with or fused with a position solution from a GNSS position engine using techniques known in the art. The I/O devices 429 can also include conventional input/output devices such as audio devices (e.g., speakers and microphone), a USB interface, and a touchscreen that receives touch inputs and displays images, etc. The I/O output devices may also include other RF systems 433 with one or more antennas 435; these other RF systems may include one or more of conventional WiFi (or other wireless local area networks), Bluetooth or NFC (near field communication) RF transceivers and may share an antenna with a GNSS receiver. These other RF systems may also be used in some embodiments to deliver assistance data to the GNSS processing system or the application processors to determine a position of the system 401. For example, the WiFi transceiver may deliver assistance data (e.g., SV almanac data) to the GNSS processing system 405 and may also supply an approximate location to the GNSS processing system 405 and/or the one or more application processors (e.g., using the name (e.g., SSID) of the WiFi access point to look up the approximate location of the WiFi access point from one or more databases that are known in the art).

The embodiments (e.g., one or more GNSS receivers) described herein can receive and process GNSS signals from GNSS SVs that are part of one or more GNSS constellations deployed or developed by one or more governments (such as the United States GPS (Global Positioning System) system, the European Galileo system, the Chinese Beidou system, the Japanese QZSS system, the Russian GLONASS system and other such governmental systems, including regional systems, now or in the future), and the embodiments described herein can also be used with other satellite systems (e.g., low earth orbiting [LEO] satellites or other SVs which may not be deployed by or developed by a government and may be privately owned) or pseudolite systems (e.g., terrestrial systems including cellular telephone towers and other ground based transmitters) that transmit navigation signals that include ranging codes (e.g., PRN codes) and/or other data that can be used to determine a position in a receiver based upon the transmitted signals that are received by the GNSS receiver. Thus, the term GNSS SV (or GNSS satellite) is intended to include all such satellites systems and pseudolite systems, now or in the future, and the term GNSS receiver is intended to include a receiver that can receive and acquire and process transmitted signals from a subset of or all of such satellite systems and pseudolite systems to determine a position of the GNSS receiver. Moreover, the term GNSS signals is intended to include such transmitted signals from a subset of or all of such satellite systems and pseudolite systems. In other words, a GNSS SV is any transmitter/source of signals, such as GNSS signals, that can be received by and used in a GNSS receiver to determine the receiver's position (e.g., latitude and longitude) from the received GNSS signals. Hence, for example, the embodiments described herein can be used with navigation systems based on low earth orbiting SVs or other SVs or ground based transmitters that transmit navigation signals that can be used by a GNSS receiver to determine its position.

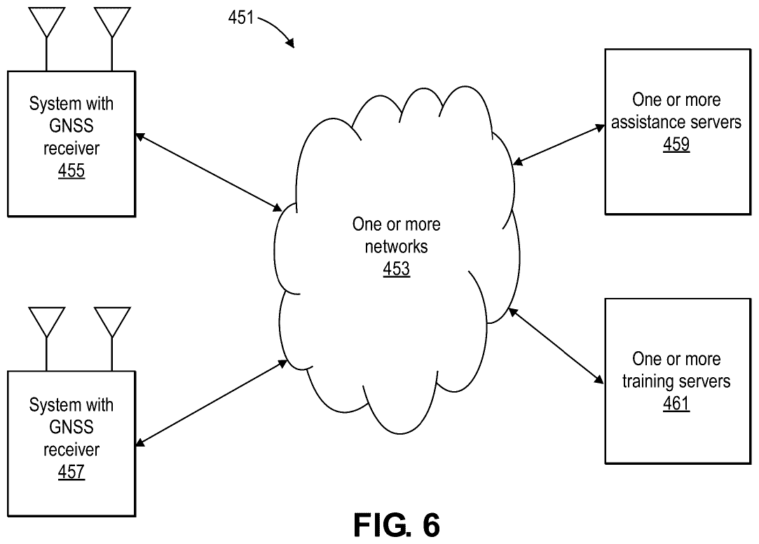

FIG. 6 shows an example of a system 451 for delivering assistance data to one or more systems 455 and 457 that each contain a GNSS receiver. The system 451 can use one or more networks 453 to deliver assistance data and provide assistance services to the systems 455 and 457. The one or more networks 453 can include one or more cellular telephone networks, one or more wired telephone networks, one or more wired Ethernet networks, one or more optical fiber networks, one or more WiFi networks, the internet, satellite communication networks, and one or more other networks and communication media known in the art. The one or more networks 453 can couple the systems 455 and 457 to the one or more assistance servers 459 and one or more training servers 461. The systems 455 and 457 represent two of potentially many (e.g., hundreds of millions) systems, each containing a GNSS receiver and one or more RF transceivers; each of the systems 455 and 457 can be an instantiation of an embodiment of the system 401 shown in FIG. 5. For example, system 455 may be a smartphone or an IoT device, and system 457 may be a smartwatch or other wearable device or a component in a vehicle (e.g., an automobile). The one or more RF transceivers in each of systems 455 and 457 can communicate, through the one or more networks 453, with the one or more assistance servers 459 and the one or more training servers 461 to receive assistance data and assistance services from these servers 459 and 461. The one or more assistance servers 459 can provide a variety of assistance services and data depending on the embodiment. For example, the one or more assistance servers 459 can provide one or more of: SV almanac data, SV ephemeris data, Doppler data for SVs in view of a GNSS receiver, approximate position data, time assistance data (e.g., network time), ionospheric correction data, clock bias or error data for SVs, barometric pressure sensor calibration or correction data, and WiFi position look up data based upon the name of the WiFi access point. In one embodiment, a system (e.g., system 455) can request one or more assistance data from the one or more assistance servers 459 and receive the assistance data (e.g., assistance data based upon an approximate location provided by the system to the one or more assistance servers). The system (e.g., system 455) can then use the assistance data to acquire GNSS signals or to produce a position solution or both. In one embodiment, the systems 455 and 457 can also use assistance services from the one or more training servers 461 to obtain, for example, updated or new trained models for use in the GNSS processing system contained within each system (e.g., system 455 or 457). U.S. patent application Ser. No. 17/806,110, filed on Jun. 9, 2022 by applicant oneNav Inc., provides examples of such training servers that can provide updated or new trained models for use with a GNSS processing system, such as GNSS processing system 305, and this patent application is hereby incorporated herein by reference. In one embodiment, the one or more assistance servers (e.g., servers 459) may be used to compute a position for the GNSS receiver using techniques known in the art; in this embodiment, the GNSS receiver transmits its pseudorange measurements, identifiers of the acquired SVs used to compute the pseudorange measurements and a time stamp of when those measurements were made to an assistance server which then computes the position of the GNSS receiver using the pseudorange measurements and time stamp and GNSS SV ephemeris data which is available to the assistance server. The assistance server can then send the compute position to the GNSS receiver and/or to other destinations such as another server that provides a service of tracking the GNSS receiver.

The following text presents numbered embodiments in claim like format, and it will be understood that these embodiments may be presented as claims in one or more future filings, such as one or more continuation or divisional applications. Although separate embodiments are described in detail below, however, it is appreciated that these embodiments may be combined or modified, in part or in whole. At least some of these numbered embodiments were presented as claims in a prior provisional application.

Embodiment 1. A method of operating a global navigation satellite system (GNSS) receiver that includes a first acquisition engine that is a hybrid L1 and L5 GNSS acquisition engine and a second acquisition engine that is an L5 only GNSS acquisition engine, the method comprising:
acquiring, with the first acquisition engine during a first time period, GNSS signals in the L1 radio frequency (RF) band and then acquiring, using data acquired from the acquisition of GNSS signals in the L1 band, GNSS signals in the L5 band;
computing one or more positions of the GNSS receiver based on measurements from the first acquisition engine when GNSS signals in the L1 band are available;
determining, during a second time period, that GNSS signals in the L1 band cannot be acquired by the first acquisition engine and in response to this determination, requesting the second acquisition engine to directly acquire GNSS signals in the L5 band.

Embodiment 2. The method as in embodiment 1, wherein the requesting is performed through an application programming interface (API), and wherein the second acquisition engine provides GNSS measurements to the GNSS receiver through the API, and wherein the second acquisition engine directly acquires GNSS signals in the L5 band by acquiring them without an aid from acquisition of GNSS signals in the L1 band.

Embodiment 3. The method as in embodiment 2, wherein the second acquisition engine uses frequency domain correlation through a set of discrete Fourier transforms (DFTs) to acquire the GNSS signals in the L5 band.

Embodiment 4. The method as in embodiment 3, wherein the first acquisition engine uses a set of time domain correlators to acquire GNSS signals in the L1 band and to acquire GNSS signals in the L5 band.

Embodiment 5. The method as in embodiment 2, wherein the second acquisition engine uses, in a first mode, frequency domain correlation through a set of discrete Fourier transforms to acquire the GNSS signals in the L5 band and the second acquisition engine uses, in a second mode, a first set of time domain correlators to acquire GNSS signals in the L5 band, and wherein the first acquisition engine uses a second set of time domain correlators to acquire GNSS signals in the L1 band and to acquire GNSS signals in the L5 band.

Embodiment 6. The method as in embodiment 4, wherein the first acquisition engine is coupled to a first antenna to receive GNSS signals in the L1 band and is coupled to a second antenna to receive GNSS signals in the L5 band, and the second acquisition engine is coupled to the second antenna.

Embodiment 7. The method as in embodiment 2, wherein the GNSS measurements comprise one or more of: (1) pseudoranges to GNSS SVs that transmit GNSS signals in the L5 band; (2) code phase measurements from acquired GNSS signals in the L5 band; or (3) range rate measurements.

Embodiment 8. The method as in embodiment 7, wherein the GNSS receiver computes a position based on the GNSS measurements received from the second acquisition engine.

Embodiment 9. The method as in embodiment 8, wherein the second acquisition engine acquires GNSS signals in the L5 band but does not contain a position solution engine and does not compute positions of the GNSS receiver.

Embodiment 10. The method as in embodiment 9, wherein the second acquisition engine uses frequency domain correlation through a set of discrete Fourier transforms to acquire the GNSS signals in the L5 band, and wherein the second acquisition engine accumulates code phase hypotheses for two components of GNSS signals in a single sideband of GNSS signals from a single GNSS SV in a single hypothesis memory such that for a particular code phase hypothesis, the correlation results over successive 1 millisecond intervals of sampled GNSS signal data from the two components are accumulated together in a single memory location for the particular code hypothesis.

Embodiment 11. The method as in embodiment 9, wherein the API comprises one or more of the following: (1) a parameter to set a receiver processing interval; (2) one or more parameters that specify detection of interference and a classification of the detected interference; (3) a parameter that specifies a selection of a sideband; (4) a parameter that specifies combining of sideband signals; (5) a parameter that specifies a correlation peak detection threshold; (6) a parameter that indicates a correlation peak has been detected; (7) a parameter that indicates a value of a detected correlation peak; or (8) a parameter that indicates a detected correlation peak to noise ratio.

Embodiment 12. A global navigation satellite system (GNSS) receiver comprising: a first acquisition engine that is a hybrid L1 and L5 acquisition engine that is configured to acquire GNSS signals in an L1 radiofrequency (RF) band and acquire GNSS signals in an L5 RF band, the first acquisition engine to acquire, during a first time period, GNSS signals in the L1 RF band and then acquire, using data acquired from the acquisition of GNSS signals in the L1 band, GNSS signals in the L5 band, the GNSS receiver to determine one or more positions of the GNSS receiver using measurements from the first acquisition engine when GNSS signals in the L1 band are available; a second acquisition engine that directly acquires GNSS signals in the L5 band during a second time period when the GNSS receiver determines that GNSS signals in the L1 band cannot be acquired by the first acquisition engine and in response to this determination, the second acquisition engine is requested to directly acquire GNSS signals in the L5 band.

Embodiment 13. The GNSS receiver as in embodiment 12, further comprising: a first memory storing an application programming interface (API) between the GNSS receiver and the second acquisition engine, the second acquisition engine to provide GNSS measurements to the GNSS receiver through the API in response to the request to directly acquire GNSS signals in the L5 band.

Embodiment 14. The GNSS receiver as in embodiment 13, wherein the second acquisition engine directly acquires GNSS signals in the L5 band by acquiring them without an aid from acquisition of GNSS signals in the L1 band, and wherein the second acquisition engine uses frequency domain correlation through a set of discrete Fourier transforms (DFTs) to acquire the GNSS signals in the L5 band.

Embodiment 15. The GNSS receiver as in embodiment 14, wherein the first acquisition engine uses a set of time domain correlators to acquire GNSS signals in the L1 band and to acquire GNSS signals in the L5 band.

Embodiment 16. The GNSS receiver as in embodiment 13, wherein the second acquisition engine uses, in a first mode, frequency domain correlation through a set of discrete Fourier transforms to acquire the GNSS signals in the L5 band and the second acquisition engine uses, in a second mode, a first set of time domain correlators to acquire GNSS signals in the L5 band, and wherein the first acquisition engine uses a second set of time domain correlators to acquire GNSS signals in the L1 band and to acquire GNSS signals in the L5 band.

Embodiment 17. The GNSS receiver as in embodiment 15, wherein the first acquisition engine is coupled to a first antenna to receive GNSS signals in the L1 band and is coupled to a second antenna to receive GNSS signals in the L5 band, and the second acquisition engine is coupled to the second antenna.

Embodiment 18. The GNSS receiver as in embodiment 15, wherein the GNSS measurements comprise one or more of: (1) pseudoranges to GNSS SVs that transmit GNSS signals in the L5 band; (2) code phase measurements from acquired GNSS signals in the L5 band; or (3) range rate measurements.

Embodiment 19. The GNSS receiver as in embodiment 18, wherein the GNSS receiver computes a position based on the GNSS measurements received from the second acquisition engine.

Embodiment 20. The GNSS receiver as in embodiment 19, wherein the second acquisition engine acquires GNSS signals in the L5 band but does not contain a position solution engine and does not compute positions of the GNSS receiver.

Embodiment 21. The GNSS receiver as in embodiment 20, wherein the second acquisition engine uses frequency domain correlation through a set of discrete Fourier transforms to acquire the GNSS signals in the L5 band, and wherein the second acquisition engine accumulates code phase hypotheses for two components of GNSS signals in a single sideband of GNSS signals in a single hypothesis memory such that for a particular code phase hypothesis, the correlation results over a plurality of successive 1 millisecond intervals of sampled GNSS signal data from the two components are accumulated together in a single memory location for the particular code hypothesis.

Embodiment 22. The GNSS receiver as in embodiment 21, wherein the API comprises one or more of the following: (1) a parameter to set a receiver processing interval; (2) one or more parameters that specify detection of interference and a classification of the detected interference; (3) a parameter that specifies a selection of a sideband; (4) a parameter that specifies combining of sideband signals; (5) a parameter that specifies a correlation peak detection threshold; (6) a parameter that indicates a correlation peak has been detected; (7) a parameter that indicates a value of a detected correlation peak; or (8) a parameter that indicates a detected correlation peak to noise ratio.

Embodiment 23. A method of operating a global navigation satellite system (GNSS) receiver that includes a first GNSS acquisition engine and a second acquisition engine, the method comprising:
determining, based on availability of assistance data, whether to operate in (1) a first acquisition mode to directly acquire GNSS signals in an L5 band using the first GNSS acquisition engine or (2) a second acquisition mode to directly acquire GNSS signals in the L5 band using the second acquisition engine;
acquiring, by the first acquisition engine when in the first acquisition mode, GNSS signals in the L5 band, the first acquisition engine computing discrete Fourier transforms (DFTs) of received samples of GNSS signals and computing DFTs of local replica code of pseudorandom number (PRN) primary code in the GNSS signals to generate code phase measurements for a plurality of code phase hypotheses;
acquiring, by the second acquisition engine when in the second acquisition mode, GNSS signals in the L5 band using time domain correlators that determine code phase measurements by correlating received samples of GNSS signals against local replica code of the PRN primary code in the GNSS signals.

Embodiment 24. The method as in embodiment 23, wherein the GNSS receiver directly acquires GNSS signals in the L5 band by acquiring them without an aid from acquisition of GNSS signals in the L1 band.

Embodiment 25. The method as in embodiment 23, wherein the time domain correlators in the second acquisition mode do not use DFTs to correlate the received sample against the local replica code.

Embodiment 26. The method as in embodiment 25, wherein the time domain correlators search for both code phase hypotheses and frequency shift hypotheses.

Embodiment 27. The method as in embodiment 26, wherein when the assistance data includes time assistance data that reduces time uncertainty, in a clock in the GNSS receiver, to less than 1 millisecond, then the GNSS receiver uses the second acquisition mode to acquire GNSS signals and the first acquisition engine is placed in a low power mode and does not acquire GNSS signals while in the low power mode.

Embodiment 28. The method as in embodiment 26, wherein when the assistance data includes data derived from an acquisition of a secondary PRN code phase, then the GNSS receiver uses the second acquisition mode to acquire GNSS signals and the first acquisition engine is placed in a low power mode and does not acquire GNSS signals while in the low power mode.

Embodiment 29. The method as in embodiment 26, wherein when the GNSS receiver is in a cold start mode, the GNSS receiver uses the first acquisition mode to acquire GNSS signals and the second acquisition engine is placed in a low power mode and does not acquire GNSS signals while in the low power mode.

Embodiment 30. The method as in embodiment 26, wherein the first acquisition engine and the second acquisition engine share a same allocated memory space such that during the first acquisition mode, the first acquisition engine uses the same allocated memory space and the second acquisition engine does not use the same allocated memory space and during the second acquisition mode, the second acquisition engine uses the same allocated memory space and the first acquisition engine does not use the same allocated memory space, and wherein code phase hypotheses are stored in the same allocated memory space during acquisition of GNSS signals.

Embodiment 31. The method as in embodiment 30, wherein the GNSS receiver, in both the first acquisition mode and the second acquisition mode, accumulates code phase hypotheses for two components of GNSS signals in a single sideband of GNSS signals from a single GNSS SV in a single hypothesis memory such that for a particular code phase hypothesis, the correlation results over a plurality of successive 1 millisecond intervals of sampled GNSS signal data from the two components are accumulated together in a single memory location for the particular code hypothesis; and wherein the first acquisition engine computes a first set of DFTs in parallel and concurrently on the received samples to produce a first set of results and then computes a second set of DFTs using the first set of results as an input to the second set of DFTs, and wherein the first set of DFTs is N1 DFTs and the second set of DFTs is N2 DFTs and N1 is greater than N2.

Embodiment 32. A global navigation satellite system (GNSS) receiver comprising: an antenna to receive GNSS signals from a set of GNSS SVs;
a radio frequency (RF) front end coupled to the antenna to amplify the GNSS signals;
an analog to digital converter (ADC) coupled to the RF front end to generate a digital representation of received GNSS signals;
a memory coupled to the ADC to store the digital representation;
a GNSS processing system coupled to the memory to process the received GNSS signals, the GNSS processing system including a first acquisition engine and a second acquisition engine and processing logic to select between using the first acquisition engine, in a first acquisition mode, and the second acquisition engine, in a second acquisition mode, based on an availability of assistance data; and wherein the first acquisition engine when in the first acquisition mode, acquires GNSS signals in the L5 band, the first acquisition engine computing discrete Fourier transforms (DFTs) of received samples of GNSS signals and computing DFTs of local replica code of pseudorandom number (PRN) primary code in the GNSS signals to generate code phase measurements for a plurality of code phase hypotheses; and wherein the second acquisition engine when in the second acquisition mode, acquires GNSS signals in the L5 band using time domain correlators that determine code phase measurements by correlating received samples of GNSS signals against local replica code of the PRN primary code in the GNSS signals.

Embodiment 33. A GNSS receiver as in embodiment 32, wherein the GNSS receiver directly acquires GNSS signals in the L5 band by acquiring them without an aid from acquisition of GNSS signals in the L1 band, and wherein the time domain correlators in the second acquisition mode do not use DFTs to correlate the received sample against the local replica code, and wherein the time domain correlators search for both code phase hypotheses and frequency shift hypotheses.

Embodiment 34. A global navigation satellite system (GNSS) receiver comprising: one or more antennas to receive GNSS signals from a set of GNSS SVs;
one or more radio frequency (RF) front ends coupled to the one or more antennas to amplify the GNSS signals;
one or more analog to digital converters (ADC) coupled to the one or more RF front ends to generate a digital representation of received GNSS signals;
a memory coupled to the one or more ADCs to store the digital representation;
a GNSS processing system coupled to the memory to process the received GNSS signals, the GNSS processing system coupled to a first acquisition engine and a second acquisition engine and processing logic to select when to use the first acquisition engine; and wherein the first acquisition engine, when used, acquires GNSS signals in the L5 band by computing discrete Fourier transforms (DFTs) of received samples of GNSS signals and computing DFTs of local replica code of pseudorandom number (PRN) primary code in the GNSS signals to generate code phase measurements for a plurality of code phase hypotheses; and wherein the second acquisition engine acquires GNSS signals in the L1 band using time domain correlators that determine code phase measurements by correlating received samples of GNSS signals against local replica code of the PRN primary code in the GNSS signals; and wherein the second acquisition engine, when the first acquisition engine is not used, acquires GNSS signals in the L5 band using time domain correlators that determine code phase measurements by correlating received samples of GNSS signals against local replica code of the PRN primary code in the GNSS signals.

Embodiment 35. The GNSS receiver as in embodiment 34, wherein when assistance data is available to reduce time and position uncertainties in the GNSS processing system, then the first acquisition engine is not used to acquire GNSS signals in the L5 band and the second acquisition engine is used to directly acquire GNSS signals in the L5 band.

Embodiment 36. The GNSS receiver as in embodiment 34, wherein when the second acquisition engine is able to acquire GNSS signals in the L1 band, then the first acquisition engine is not used to acquire GNSS signals in the L5 band and the second acquisition engine is used to acquire GNSS signals in the L5 band.

Embodiment 37. The GNSS receiver as in embodiment 35, wherein the second acquisition engine concurrently and simultaneously acquires GNSS signals in the L1 and L5 bands when the assistance data is available.

Embodiment 38. The GNSS receiver as in embodiment 34, wherein when the second acquisition engine is not able to acquire GNSS signals in the L1 band, then the first acquisition engine is used to acquire GNSS signals in the L5 band.

Embodiment 39. A GNSS receiver comprising:
one or more antennas to receive GNSS signals;
a memory coupled to the one or more antennas, the memory to store a digital representation of received GNSS signals;
one or more portions of the GNSS receiver containing first circuitry from an intellectual property (IP) core licensed to a developer of the GNSS receiver;
software stored in memory in the GNSS receiver, the software to set one or more programmable parameters through an application programming interface (API) stored in the first circuitry, the parameters, once set, specifying a configuration of the GNSS receiver.

Embodiment 40. The GNSS receiver as in embodiment 39, wherein the software is developed by or for the developer, the software to execute on a processing system in the GNSS receiver, and the software to make calls to the API for processing by firmware that executes in the first circuitry.

Embodiment 41. The GNSS receiver as in embodiment 39, wherein the IP core specifies the first circuitry in an HDL (hardware description language) or netlist format or a schematic format.

Embodiment 42. The GNSS receiver as in embodiment 40, wherein the API and IP core are developed by a licensor that created and licensed the IP core and API.

Embodiment 43. The GNSS receiver as in embodiment 42, wherein the IP core includes data that represents: a frequency domain correlation acquisition engine and a time domain correlation acquisition engine and a measurement engine.

Embodiment 44. The GNSS receiver as in embodiment 42, wherein the API and the IP core allow the developer to select a hardware configuration of the GNSS receiver from three or more possible configurations.

Embodiment 45. The GNSS receiver as in embodiment 43, wherein the API includes one or more settable parameters, including one or more of: (a) dwell time; (b) criteria for selecting between FDC and TDC acquisition engines; (c) one or more thresholds used for detecting correlation peaks; (d) parameters for selecting one or both A and B sidebands in the Galileo L5 GNSS signals; (e) a parameter for selecting whether to combine or not combine, during acquisition, the A and B sidebands in the Galileo L5 GNSS signals; (f) an integration time period for FDC acquisition; (g) an integration time period for TDC acquisition; (h) parameters for the number of signal energy estimation array (SEA) frequency bins and correlator bins; (i) parameters for the SEA DFT length, frequency step size and range; or (j) parameters for the secondary-primary code array (SPC-SEA), including number of secondary code indices by number of correlator indices, coherent integration length and non-coherent integration length.

Embodiment 46. The GNSS receiver as in embodiment 45, wherein the API is used to change a search strategy during acquisition of GNSS signals after detecting a first correlation peak in measurements from the first circuitry.

Embodiment 47. The GNSS receiver as in embodiment 46, wherein the API includes (a) one or more call interfaces for resource configuration of the first circuitry; and (b) one or more call interfaces to specify parameters for acquisition search operations; and (c) one or more call interfaces to specify parameters for tracking operations.

Embodiment 48. The GNSS receiver as in embodiment 47, wherein the first circuitry comprises an array processor that performs vector operations on an array of data contained in the digital representation of the received GNSS signals, and the array of data being at baseband for a 1 millisecond sample of received GNSS signals, and wherein an input of the memory is coupled to an output of a digital signal processing system in the first circuitry that is coupled to the one or more antennas.

Embodiment 49. The GNSS receiver as in embodiment 48, wherein the memory comprises a first portion, a second portion, a third portion, and a fourth portion, wherein the first portion stores a 1 millisecond sample of data from a GNSS A sideband for frequency domain correlation operations, the second portion stores a 1 millisecond sample of data from the GNSS A sideband for time domain correlation operations, the third portion stores a 1 millisecond sample of data from a GNSS B sideband for frequency domain correlation operations, and the fourth portion stores a 1 millisecond sample of data from the GNSS B sideband for time domain correlation operations.

Embodiment 50. A method for processing GNSS (Global Navigation Satellite System) signals in a GNSS receiver, the method comprising:
receiving, through an application programming interface (API), one or more of parameters or instructions for processing GNSS signals for a first GNSS satellite (SV), the one or more parameters or instructions (for processing GNSS signals from the first GNSS SV) used, in the GNSS receiver, to select a first GNSS signal processing flow through a set of possible operations in logic or memory in the GNSS receiver, wherein the first GNSS signal processing flow comprises GNSS signal acquisition and GNSS signal tracking, and wherein the set of possible operations comprises: (a) frequency domain correlation to acquire a GNSS signal, (b) time domain correlation at a first frequency bin spacing, and (c) time domain correlation at a second frequency bin spacing.

Embodiment 51. The method as in embodiment 50, wherein the method further comprises:
receiving, through the API, one or more parameters or instructions for processing GNSS signals for a second GNSS SV, the one or more parameters or instructions (for processing the GNSS signals for the second GNSS SV) being used in the GNSS receiver to select a second GNSS signal processing flow through the set of possible operations in logic or memory in the GNSS receiver, wherein the second GNSS signal processing flow comprises GNSS signal acquisition and GNSS signal tracking, and wherein the second GNSS signal processing flow is independent of and concurrent in time with the first GNSS signal processing flow.

Embodiment 52. The method as in embodiment 51, wherein the time domain correlation at the first frequency bin spacing is a correlation to acquire GNSS signals, and the time domain correlation at the second frequency bin spacing is a correlation to acquire GNSS signals, and the second frequency bin spacing is smaller than the first frequency bin spacing.

Embodiment 53. The method as in embodiment 52, wherein the set of possible operations further comprises: (d) time domain correlation to track GNSS signals using a third frequency bin spacing.

Embodiment 54. The method as in embodiment 53, wherein the first GNSS processing flow and the second GNSS processing flow are different.

Embodiment 55. The method as in embodiment 52, wherein a processing system, coupled to the GNSS receiver, receives data about available GNSS assistance data and determines the one or more parameters or instructions for processing GNSS signals for a first GNSS satellite (SV) based on the available GNSS assistance data.

Embodiment 56. The method as in embodiment 55, wherein the first GNSS processing flow comprises frequency domain correlation to acquire a GNSS signal, and the second GNSS processing flow comprises a time domain correlation to acquire a GNSS signal and does not comprise frequency domain correlation.

Embodiment 57. The method as in embodiment 56, wherein the set of possible operations comprises a secondary code acquisition operation to acquire one or more secondary codes of one or more GNSS signals.

Embodiment 58. The method as in embodiment 55, wherein the API includes one or more settable parameters, including one or more of: (a) dwell time; (b) criteria for selecting between FDC and TDC acquisition engines; (c) one or more thresholds used for detecting correlation peaks; (d) parameters for selecting one or both A and B sidebands in the Galileo L5 GNSS signals; (e) a parameter for selecting whether to combine or not combine, during acquisition, the A and B sidebands in the Galileo L5 GNSS signals; (f) an integration time period for FDC acquisition; (g) an integration time period for TDC acquisition; (h) parameters for the number of signal energy estimation array (SEA) frequency bins and correlator bins; (i) parameters for the SEA DFT length, frequency step size and range; or (j) parameters for a secondary-primary code array (SPC-SEA), including a number of secondary code indices by number of correlator indices, coherent integration length and non-coherent integration length.

Embodiment 59. The method as in embodiment 58, wherein the API is used to change a search strategy during acquisition of GNSS signals after detecting a first correlation peak in measurements from the GNSS receiver.

Embodiment 60. The method as in embodiment 59, wherein the API includes (a) one or more call interfaces for resource configuration of the GNSS receiver; and (b) one or more call interfaces to specify parameters for acquisition search operations in the GNSS receiver; and (c) one or more call interfaces to specify parameters for tracking operations in the GNSS receiver.

Embodiment 61. The method as in embodiment 51, wherein the GNSS receiver comprises an array processor that performs vector operations on an array of data contained in digitized representations of received GNSS signals, and the array of data being at baseband for a 1 millisecond sample of received GNSS signals, and wherein the received GNSS signals are in an L5 radio frequency band.

Embodiment 62. The method as in embodiment 50, wherein the first frequency bin spacing defines a first difference in frequency between center points in adjacent frequency bins, and the second frequency bin spacing defines a second difference in frequency between center points in adjacent frequency bins.

Embodiment 63. A method for processing GNSS signals in a GNSS receiver, the method comprising:
receiving GNSS signals and storing first digitized GNSS samples of the received GNSS signals; frequency shifting, in a frequency shifter, one or more of the first digitized GNSS samples;
performing, after the frequency shifting, a first time domain correlation on the first digitized GNSS samples which include frequency shifted GNSS samples, the first time domain correlation performed at a first frequency bin spacing;
determining, from results of the first time domain correlation, an estimated frequency of received GNSS signals;
receiving further GNSS signals and storing second digitized GNSS samples of the further GNSS signals after performing the first time domain correlation;
performing a second time domain correlation at a second frequency bin spacing on the second digitized GNSS samples, the second frequency bin spacing being smaller than the first frequency bin spacing;
computing a set of discrete Fourier transformations (DFT) on results of the second time domain correlation to derive a data array having a frequency dimension and a code phase dimension.

Embodiment 64. The method as in embodiment 63, wherein the method further comprises: searching for one or more maxima in the data array to determine a code phase for the received GNSS signals, the determined code phase being used to compute a pseudorange to a GNSS SV that transmitted the received GNSS signals.

Embodiment 65. The method as in embodiment 64, wherein the data in the data array represents a signal energy of the received GNSS signals in different frequency bins and at different code phase hypotheses.

Embodiment 66. The method as in embodiment 65, wherein the second frequency bin spacing is in a range from 5 Hz to 50 Hz.

Embodiment 67. The method as in embodiment 65, wherein the first frequency bin spacing defines a first difference in frequency between center points in adjacent frequency bins, and the second frequency bin spacing defines a second difference in frequency between center points in adjacent frequency bins, and wherein the first difference and the second difference are different.

Embodiment 68. The method as in embodiment 65, wherein the method further comprises: initiating tracking of received GNSS signals based on the determined code phase and wherein the received GNSS signals are in an L5 radio frequency band.

Embodiment 69. The method as in embodiment 65, wherein the method further comprises: storing a selected set of data from the data array, the selected set of data comprising a correlation vector containing the one or more maxima in a particular frequency bin, the correlation vector being used as an input to a trained machine learning model to derive one or more excess path length corrections of the pseudorange, and wherein the selected set of data is a row or column of data in the data array.

Embodiment 70. The method as in embodiment 65, wherein the method further comprises: performing a frequency domain correlation before performing the first time domain correlation on the first digitized GNSS samples.

Embodiment 71. The method as in embodiment 70, wherein the GNSS receiver includes an array processor that performs operations on vectors of data in digitized representations of received GNSS signals, and wherein the array processor performs at least portions of the frequency domain correlation operation.

Embodiment 72. The method as in embodiment 71, wherein the array processor computes values, based on inputs from a plurality of vectors in the digitized representations of received GNSS signals, concurrently in an atomic operation in response to a single instruction to the array processor.

Embodiment 73. The method as in embodiment 63, wherein the computing of the set of DFTs comprises computing a first plurality of DFTs for a first frequency bin in a range of frequencies and computing a second plurality of DFTs for a second frequency bin (which is different the first frequency bin) in the range of frequencies, wherein the set of DFTs are computed in hardware in parallel and concurrently in time.

Embodiment 74. The method as in embodiment 67, wherein the computing of the set of DFTs comprises computing a first plurality of DFTs for a first frequency bin in a range of frequencies and computing a second plurality of DFTs for a second frequency bin (which is different the first frequency bin) in the range of frequencies, wherein the set of DFTs are computed in hardware in parallel and concurrently in time.

Embodiment 75. The method as in embodiment 70, wherein the computing of the set of DFTs comprises computing a first plurality of DFTs for a first frequency bin in a range of frequencies and computing a second plurality of DFTs for a second frequency bin (which is different the first frequency bin) in the range of frequencies, wherein the set of DFTs are computed in hardware in parallel and concurrently in time.

Embodiment 76. The method as in embodiment 50, wherein the API comprises one or more parameters or instructions for use in mitigating one or both of jamming or spoofing.

Embodiment 77. The method as in embodiment 76, wherein the API includes one or more parameters or instructions to select between A and B sidebands in the Galileo L5 GNSS signals in response to detecting jamming or spoofing in one of the A and B sidebands, such that when jamming or spoofing is detected in one of the A and B sidebands but not the other, the API is used to select the sideband that is not corrupted by jamming or spoofing.

Embodiment 78. The method as in embodiment 76, wherein the GNSS receiver includes: (1) a first GNSS measurement engine to determine a first set of one or more pseudoranges from a first set of received GNSS signals in an L1 radio frequency band and (2) a second GNSS measurement engine to determine a second set of one or more pseudoranges from a second set of received GNSS signals in an L5 radio frequency band.

Embodiment 79. The method as in embodiment 78, wherein the second GNSS measurement engine augments the first GNSS measurement engine when jamming of L1 signals corrupts outputs from the first GNSS measurement engine, and wherein the API allows control and configuration of at least the second GNSS measurement engine.

Embodiment 80. A system for processing GNSS signals, the system comprising: one or more GNSS antennas;
one or more GNSS measurement engines coupled to the one or more GNSS antennas, the one or more GNSS measurement engines to correlate and process received GNSS signals in an L5 radio frequency band;
one or more processing systems coupled to a first memory which stores an application programming interface (API) which includes one or more of parameters or instructions for processing GNSS signals, the one or more processing systems using the API to control operation of the one or more GNSS measurement engines.

Embodiment 81. The system as in embodiment 80, wherein the one or more GNSS measurement engines comprises a (1) first GNSS measurement engine which correlates GNSS signals in one or more of an L1 or L2 radio frequency bands to produce a first set of one or more pseudoranges from received GNSS signals in the one or more of the L1 or L2 bands and (2) a second GNSS measurement engine which correlates GNSS signals in an L5 radio frequency band to produce a second set of one or more pseudoranges from received GNSS signals in the L5 band.

Embodiment 82. The system as in embodiment 81, wherein the second GNSS measurement engine operates without aid from processing of GNSS signals in the L1 band.

Embodiment 83. The system as in embodiment 82, wherein the one or more antennas comprises a controlled reception pattern antenna.

Embodiment 84. The system as in embodiment 82, wherein the API includes one or more parameters or instructions to mitigate against jamming of GNSS signals.

Embodiment 85. The system as in embodiment 84, wherein the API includes one or more parameters or instructions to spatially null signals in a direction of a jamming source.

Embodiment 86. The system as in embodiment 82, wherein the first and second GNSS measurement engines operate concurrently.

Embodiment 87. The system as in embodiment 86, wherein the first GNSS measurement engine correlates received GNSS signals which include encrypted PRN codes.

Embodiment 88. The system as in embodiment 86, wherein the second GNSS measurement engine correlates received GNSS signals which include PRN codes that are not encrypted.

Embodiment 89. The system as in embodiment 86, the system further comprising: an inertial navigation system that comprises one or more inertial navigation sensors, the inertial navigation system coupled to the one or more processing systems to receive position outputs from one or more position solution engines that are coupled to the first and second measurement engines.

Embodiment 90. The system as in embodiment 89, wherein the system is contained in a drone which includes a propulsion system to move the drone, and wherein the inertial navigation system is coupled to the propulsion system.

Embodiment 91. The system as in embodiment 90, wherein the first memory is non-volatile memory that is electrically re-programmable, and the first memory stores firmware for controlling the operation of at least the second GNSS measurement engine, and the firmware receives calls through the API to configure operation of the second GNSS measurement engine and the firmware is re-programmable.

Embodiment 92. The system as in embodiment 91, wherein an updated firmware, updated when the first memory is re-programmed, includes an updated API.

Embodiment 93. The system as in embodiment 90, wherein the API is used to select among different processing paths that are available for use in the second GNSS measurement engine.

Embodiment 94. The system as in embodiment 80, wherein the one or more GNSS measurement engines comprises a GNSS measurement engine that acquires and determines pseudoranges from received GNSS signals in the L5 band without aid from processing or receipt of GNSS signals in the L1 band, and wherein the system includes an inertial navigation system that comprises one or more inertial navigation sensors, the inertial navigation system coupled to the one or more processing systems to receive position outputs from one or more position solution engines that are coupled to the first and second measurement engines, and wherein the system is contained in a drone which includes a propulsion system to move the drone, and wherein the inertial navigation system is coupled to the propulsion system.

Embodiment 95. A method of operating a GNSS receiver, the method comprising: receiving, through one or more GNSS antennas, GNSS signals from a set of GNSS SVs;
correlating, in one or more GNSS measurement engines, the received GNSS signals to produce a set of one or more pseudoranges, the one or more GNSS measurement engines comprising a first GNSS measurement engine that correlates received GNSS signals in an L5 band to produce pseudoranges from the received GNSS signals in the L5 band;
computing, in one or more processing systems, one or more positions of the GNSS receiver; controlling, through an application programming interface (API) which includes one or more of parameters or instructions for processing GNSS signals, operation of the first GNSS measurement engine.

Embodiment 96. The method as in embodiment 95, wherein the one or more processing systems comprises a first position solution engine, and wherein the one or more GNSS measurement engines comprise a second GNSS measurement engine to correlate received GNSS signals in an L1 band.

Embodiment 97. The method as in embodiment 96, wherein the method is performed in a drone which includes an inertial navigation system that is coupled to the first position solution engine.

Embodiment 98. The method as in embodiment 97, wherein at least a portion of the API and firmware that receives calls through the API is stored in non-volatile memory which is re-programmable to allow for updating of the firmware.

Embodiment 99. The method as in embodiment 98, wherein the API includes one or more parameters or instructions to mitigate the effects of jamming or spoofing.

Embodiment 100. The method as in embodiment 99, wherein the API is used by the first position solution engine to select among different processing paths that are available for use in the first GNSS measurement engine.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

What is claimed is:

1. A system for processing GNSS signals, the system comprising:
one or more GNSS antennas;
one or more GNSS measurement engines coupled to the one or more GNSS antennas, the one or more GNSS measurement engines to correlate and process received GNSS signals in an L5 radio frequency band;
one or more processing systems coupled to a first memory which stores an application programming interface (API) which includes one or more of parameters or instructions for processing GNSS signals, the one or more processing systems using the API to control operation of the one or more GNSS measurement engines.

2. The system as in claim 1, wherein the one or more GNSS measurement engines comprises a (1) first GNSS measurement engine which correlates GNSS signals in one or more of an L1 or L2 radio frequency bands to produce a first set of one or more pseudoranges from received GNSS signals in the one or more of the L1 or L2 bands and (2) a second GNSS measurement engine which correlates GNSS signals in an L5 radio frequency band to produce a second set of one or more pseudoranges from received GNSS signals in the L5 band.

3. The system as in claim 2, wherein the second GNSS measurement engine operates without aid from processing of GNSS signals in the L1 band.

4. The system as in claim 3, wherein the one or more antennas comprises a controlled reception pattern antenna.

5. The system as in claim 3, wherein the API includes one or more parameters or instructions to mitigate against jamming of GNSS signals.

6. The system as in claim 5, wherein the API includes one or more parameters or instructions to spatially null signals in a direction of a jamming source.

7. The system as in claim 3, wherein the first and second GNSS measurement engines operate concurrently.

8. The system as in claim 7, wherein the first GNSS measurement engine correlates received GNSS signals which include encrypted PRN codes.

9. The system as in claim 7, wherein the second GNSS measurement engine correlates received GNSS signals which include PRN codes that are not encrypted.

10. The system as in claim 7, the system further comprising:
an inertial navigation system that comprises one or more inertial navigation sensors, the inertial navigation system coupled to the one or more processing systems to receive position outputs from one or more position solution engines that are coupled to the first and second measurement engines.

11. The system as in claim 10, wherein the system is contained in a drone which includes a propulsion system to move the drone, and wherein the inertial navigation system is coupled to the propulsion system.

12. The system as in claim 11, wherein the first memory is non-volatile memory that is electrically re-programmable, and the first memory stores firmware for controlling the operation of at least the second GNSS measurement engine, and the firmware receives calls through the API to configure operation of the second GNSS measurement engine and the firmware is re-programmable.

13. The system as in claim 12, wherein an updated firmware, updated when the first memory is re-programmed, includes an updated API.

14. The system as in claim 1, wherein the API is used to select among different processing paths that are available for use in the second GNSS measurement engine.

15. The system as in claim 1, wherein the one or more GNSS measurement engines comprises a GNSS measurement engine that acquires and determines pseudoranges from received GNSS signals in the L5 band without aid from processing or receipt of GNSS signals in the L1 band, and wherein the system includes an inertial navigation system that comprises one or more inertial navigation sensors, the inertial navigation system coupled to the one or more processing systems to receive position outputs from one or more position solution engines that are coupled to the first and second measurement engines, and wherein the system is contained in a drone which includes a propulsion system to move the drone, and wherein the inertial navigation system is coupled to the propulsion system.

16. A method of operating a GNSS receiver, the method comprising:
receiving, through one or more GNSS antennas, GNSS signals from a set of GNSS SVs;
correlating, in one or more GNSS measurement engines, the received GNSS signals to produce a set of one or more pseudoranges, the one or more GNSS measurement engines comprising a first GNSS measurement engine that correlates received GNSS signals in an L5 band to produce pseudoranges from the received GNSS signals in the L5 band;
computing, in one or more processing systems, one or more positions of the GNSS receiver;
controlling, through an application programming interface (API) which includes one or more of parameters or instructions for processing GNSS signals, operation of the first GNSS measurement engine.

17. The method as in claim 16, wherein the one or more processing systems comprises a first position solution engine, and wherein the one or more GNSS measurement engines comprise a second GNSS measurement engine to correlate received GNSS signals in an L1 band.

18. The method as in claim 17, wherein the method is performed in a drone which includes an inertial navigation system that is coupled to the first position solution engine.

19. The method as in claim 18, wherein at least a portion of the API and firmware that receives calls through the API is stored in non-volatile memory which is re-programmable to allow for updating of the firmware.

20. The method as in claim 19, wherein the API includes one or more parameters or instructions to mitigate the effects of jamming or spoofing.

21. The method as in claim 20, wherein the API is used by the first position solution engine to select among different processing paths that are available for use in the first GNSS measurement engine.
